(19) United States
(12) Patent Application Publication
(10) Pub. No.: US 2019/0325532 A1
(43) Pub. Date: Oct. 24, 2019

(54) Professional Social Networking Services, Methods and Systems

(71) Applicant: Torre Technologies Co., San Francisco, CA (US)

(72) Inventors: Alex Henriquez Torrenegra, San Francisco, CA (US); Amaury Prieto, Bogota (CO); Daniela Avila Gomez, Bogota (CO); David Camargo, Bogota (CO); Manuel Montes, Bogota (CO); Ana Maria Diaz, Bogota (CO); David Montaño, Bogota (CO); Rodrigo Herrero, Armenia (CO)

(73) Assignee: Torre Technologies Co., San Francisco, CA (US)

(21) Appl. No.: 16/393,484

(22) Filed: Apr. 24, 2019

Related U.S. Application Data
(60) Provisional application No. 62/661,988, filed on Apr. 24, 2018.

(51) Int. Cl. G06Q 50/00; G06F 16/9536; G06F 16/9535; G06Q 10/10

(52) U.S. Cl. CPC G06Q 50/01; G06Q 10/1053; G06F 16/9535; G06F 16/9536

(57) ABSTRACT

Computer-implemented methods and systems are provided that generate and store data representing signals and recommendations between account holders of a professional social network. Each signal identifies interest of a first account holder in a second account holder. Characteristic signal weights and total recommendation weights can be calculated and stored for the account holders. Signal weight data of a given account holder can be displayed as part of the profile of the given account holder. Characteristic signal weights of a plurality of account holders that match a job opening or opportunity can be used to rank or filter the plurality of account holders in referring the plurality of account holders to a party associated with the job opening. Characteristic signal weights associated with a plurality of job openings or opportunities can be used to rank or filter the associated job openings or opportunities in notifying at least one account holder.

### CROSS-REFERENCE TO RELATED APPLICATION(S)

The present disclosure claims priority from U.S. Provisional Appl. No. 62/661,988, entitled “Decentralized Professional Reputation Network,” filed on Apr. 24, 2018, which is incorporated by reference herein in its entirety.

### BACKGROUND

### 1. Field

The present disclosure relates to professional social networking, and more specifically, to professional social network services, methods, and systems.

### 2. State of the Art

A professional social networking service is an online service, platform or site that allows users to build or reflect professional social networks or professional social relations among users of the service. Typically, users or members construct profiles, which may include personal information such as name, contact information, employment information, a profile photograph, personal messages, status information, and possibly links to web-related content, blogs, and so on. Typically, only a portion of a user's profile may be viewed by the general public and/or by other users of the service. The professional social networking service can allow users to establish a connection with his or her business contacts, including work colleagues, clients, customers, and so on. A connection is generally formed using an invitation process in which one user “invites” a second user. The second user then has the option of accepting or declining the invitation.

In the context of professional social networking services, users may often specify a list of their professional experiences as part of their member profiles. Such professional experiences can include past and/or present jobs, projects, educational degrees or certificates, interests, skills, and/or other experiences. Note that other users, businesses and advertisers can use these professional experiences to qualify a user or find users based on some target criteria.

User-submitted professional experiences are entirely subjective and prone to fraud. Thus, a user may present him or herself as having a professional experience that the user does not possess or that did not occur. Furthermore, even though a user may arguably possess a certain skill, there is no indication that the user is in fact proficient in that skill. Indeed, resumes are so unreliable that their legitimacy depends on accompanying background checks and recommendation letters. Platforms such as Amazon and Booking.com have proven the value of recommendation systems. While submitting recommendations for products, restaurants, or services is easier than ever, the same cannot be said for professionals. Writing recommendation letters takes time, and requesting recommendations often takes a measure of confidence that some people do not have.

Professional social networks, such as LinkedIn®, have collected hundreds of millions of resumes and made it easier for professionals to create profiles and find job opportunities and be found by prospective employers. Those networks have also collected large amounts of endorsements from users. Unfortunately, some people even find those user endorsements just as unreliable as the underlying resume and profile data.

Moreover, professional social networks, such as LinkedIn®, are proprietary such that a user's data is not portable to other networks and user's may not have full control of how their personal information is used by the network. Thus, a user who wishes to join another network may have to create another profile, which will not include any of the endorsements from the earlier network. Thus, user's professional reputations are being fragmented and siloed by such networks. Switching platforms can be time consuming and difficult. This reduces the socioeconomic mobility and freedom of people.

To add to the foregoing disincentive to switch platforms, some professional social networks vigorously attempt to guard against third parties trying to access user profile and resume data, even when network users have authorized the third parties to do so. Arguably, such professional social networks seek to protect the user data because the networks have a financial incentive to sell access to the data.

### SUMMARY

Computer-implemented methods and systems are provided that involves a plurality of account holders of a professional social network service or system, which includes interacting with the plurality of account holders to generate recommendations and signals. Each recommendation is made by a first account holder and recommends a second account holder. A signal is a way for one person (account holder) to tell another person (account holder) that he or she may be interested in working together or in doing business together or in learning from that person. Each signal is made by a first account holder and given to a second account holder to indicate the first account holder's interest in the second account holder. Recommendation weights corresponding to the recommendations and signal weights corresponding to the signals can be dynamically calculated by the system. Furthermore, total recommendation weights and/or characteristic signal weights corresponding to the plurality of account holders can be dynamically calculated by the system. Data representing the recommendation weights, the signal weights, the total recommendation weights and/or the characteristic signal weights can be stored in data storage.

In embodiments, data representing the recommendations and signals may be stored in a distributed ledger and calculations (such as the calculation of recommendation weights, signal weights, total recommendation weights, and/or characteristic signal weights) may be carried out by other processing systems, who can retrieve data stored in the distributed ledger, perform calculations, and provide the calculated information to users of the network service for specific purposes. Data representing the total recommendation weight and/or characteristic signal weight corresponding to a given account holder can be displayed in conjunction with the display of at least part of a profile of the given account holder.

In embodiments, the representation of a given recommendation and data representing the recommendation weight corresponding to the given recommendation can be displayed together (for example, in conjunction with displaying at least part of a profile of the account holder that provided or received the given recommendation). Additionally or alternatively, the representation of a given signal and data representing the signal weight corresponding to the given signal can be displayed together (for example, in conjunction with displaying at least part of a profile of the account holder that sent or received the given signal).

In embodiments, the recommendation weight for a given recommendation can be of the form:

$${w}_{r} ( X 1 , Y ) = \frac{t ( X 1 ) {L}_{X 1 , Y} {F}_{X 1 , Y} d}{{\sum }_{i = 0}^{n} {( {L}_{i} {F}_{i} )}_{X 1}}$$

where X1 denotes the account holder giving the given recommendation and Y denotes the account holder receiving the given recommendation,
t(X1) is the total recommendation weight of X1;
L_{X1,Y} is a longevity factor that depends on the time duration of the relation between X1 and Y;
F_{X1,Y} is a factor associated with the type of relation between X1 and Y;
d is a damping factor constant in the interval [0,1] (e.g., 0.9), which limits the extent to which the Account holder X1's total recommendation weight will be inherited by its recommendations; and
the summation Σᵢ₌₀ⁿ(LᵢFᵢ)_{X1} corresponds to the total number of recommendations made by X1, and more specifically adds the multiplication product of the longevity factors and relation type factors for all the recommendations given by X1.

In embodiments, the total recommendation weight for a given account holder can be calculated from the sum of the recommendation weights for all recommendations received by the given account holder.

In embodiments, the recommendation weights can be based on a PageRank-like link-analysis algorithm. The recommendation weights associated with the recommendations add trustworthiness and relevance to each account holder and their recommendations. In embodiment, the total recommendation weight for a given account holder can be of the form:

t(Y)=β(wᵣ(X1,Y)+ . . . wᵣ(Xn,Y))
where Y is the given account holder recommended by a number of other account holders denoted X1 . . . Xn;
β is a damping factor constant in the interval [0,1], which limits the extent in which the Account holder Y's total recommendation weight will be inherited by its recommendations; and
the sum wᵣ(X1, Y)+ . . . wᵣ(Xn, Y) represents the sum of all the recommendations weights for the recommendations that the given Account holder Y has received.

In embodiments, the recommendation weight corresponding to a given recommendation can provide a measure of trustworthiness of the given recommendation, and the total recommendation weight corresponding to a given account holder can provide a measure of trustworthiness of the given account holder.

In embodiments, the signal weight for a given signal can be of the form:

$${w}_{s} ( X 1 , Y ) = \frac{t ( X 1 ) {dF}_{X 1 , Y}}{{\sum }_{i = 0}^{n} {( {F}_{i} )}_{X 1}} ;$$

where X1 denotes the account holder giving the given signal and Y denotes the account holder receiving the given signal;
t(X1) is the characteristic signal weight of the signaler X1;
d is a damping factor;
F_{X1,Y} is a signal strength factor; and
the summation Σᵢ₌₀ⁿ(Fᵢ)_{X1} corresponds to the total number of signals made by X1, and more specifically adds the factors for all the signals given by X1.

In embodiments, the characteristic signal weight for a particular account holder can be calculated using one or more different formulaic expressions based on data representing one or more signal weights for the particular account holder corresponding to one or more signals directed to (or sent to) the particular account holder. For example, the characteristic signal weight for a particular account holder can be calculated by summing signal weights for the particular account holder which correspond to signals directed to the particular account holder that have not been retracted. In another example, the characteristic signal weight for a particular account holder can be calculated by averaging signal weights for the particular account holder which correspond to signals directed to the particular account holder that have not been retracted. In yet another example, the characteristic signal weight for a particular account holder can be calculated by selecting a highest signal weight from the signal weights for the particular account holder which correspond to signals directed to the particular account holder that have not been retracted. Other suitable numeric operations can also be used to calculate the characteristic signal weight for a particular account holder.

In embodiments, a signal can be associated with a signal strength attribute that is selected by the account holder that generates or sends the signal. The signal strength attribute can represent varying levels of interest of the sending account holder of the signal with the recipient account holder of the signal. For example, the signal strength attribute can be one of two values that represent a “regular” signal and a “super” signal. In this case, the signal strength attribute value of the “super” signal represents a higher or stronger level of interest of the sending account holder of the signal with the recipient account holder of the signal relative to the signal strength attribute value of the “regular” signal.

In embodiments, the signaler of a signal can be automatically notified of relevant opportunities posted by the signalee (person or organization) of the signal. Furthermore, when a signalee (or possibly an agent acting on behalf of a signalee) performs a search for talent to fill a job opportunity, the signalee (or possibly the agent acting on behalf of the signalee) can be automatically notified of the signal generated or sent by a signaler to the signalee.

In embodiments, a signal generated or sent by a signaler can be visible to a limited class of users, such as only to the signalee and possibly to an agent acting on behalf of the signalee. It is also possible for the signaler hat generated or sent a signal to share that signal to the others to help them find talent.

In embodiments, at least one computer processor can be configured to include modules that perform other parts of the method as described and claimed in the present disclosure.

In other aspects, parts or all of the methods as described and claimed in the present disclosure can be embodied in a machine or computer readable storage medium including instructed, which when executed on the machine or computer, cause the machine or computer to carry out such method steps.

In other aspects, the account holder profile data, including data representing connections, verifications, recommendations, and signals of an account holder, may be stored in a distributed ledger, such as a blockchain. In embodiments, such account holder profile data may be stored in the distributed ledger along with recommendation weights and/or signal weights. Alternatively, in embodiment, recommendation weights and/or signal weights may be calculated and stored by other processing systems, which can retrieve data stored in the distributed ledger, perform calculations, and provide the calculated information to users of the network service for specific purposes. Account holders or users can authorize third party applications (such as wallets) to add and read account holder data to and from the blockchain. Applications, in turn, can use this data to improve, automate, and speed up processes such as job matching (e.g., full-time, short-term, freelancing), recruiting, lead scoring, career advice, and professional networking.

According to at least one aspect of the disclosure, further details of which are described below, a decentralized professional social network is provided that enables account holders or users to build and use their professional profile and reputation (including curricula vitae, recommendations, and verifications) anywhere online.

This summary is intended to provide an overview of subject matter of the present disclosure. It is not intended to provide an exclusive or exhaustive explanation of the inventions described herein. The detailed description is included to provide further information about the present disclosure.

### BRIEF DESCRIPTION OF THE DRAWINGS

FIG. 1A is a schematic view of a professional social network and workflow in accordance with an aspect of this disclosure.

FIG. 1B is an example schema of data organization of data stored on the blockchain(s) shown in FIG. 1A.

FIG. 1C is a schematic illustration of connections between protocol network nodes of the professional social network of FIG. 1A.

FIG. 1D is a schematic illustration of the structure of the blockchain of FIG. 1A.

FIG. 2 is an embodiment of a workflow of an account creation process in accordance with an aspect of the disclosure.

FIG. 3 is an example of a workflow showing various transactions using the network and workflow of FIG. 1A.

FIG. 4 is an example of a screenshot displayed to an account holder populated with data in the schema of FIG. 1B.

FIG. 5 is a flowchart illustrating one example method of the present disclosure.

FIG. 6 is a schematic illustration of a recommendation and associated data.

FIGS. 7A and 7B, collectively, is a flowchart of one example method where one user (source user) verifies a target user and submits and possibly edits or deletes a recommendation for the target user and associated data.

FIG. 8A to 8D are graphs that illustrate example weight update methods.

FIG. 9 is a diagram of an example data schema for storing user profile data, data for recommendations and associated recommendation weights, and data for signals and associated signal weights.

FIGS. 10 to 19J are screen captures (e.g., display screens) of example user interfaces that can be presented for display on user computer systems and implement operations of the present disclosure.

FIGS. 20A and 20B are schematic illustrations of embodiments that extend the method of FIG. 5 for job recruiting applications.

FIG. 21 is a schematic view of a decentralized professional social network and workflow in accordance with an aspect of this disclosure.

FIG. 22A is a schematic view of an exemplary network of ledger nodes that can be part of the decentralized professional social network of FIG. 21.

FIG. 22B is a schematic view of an exemplary distributed ledger (blockchain) that can be maintained by the network of ledger nodes of FIG. 22A.

FIG. 23 is a schematic illustration of an example professional social network.

FIG. 24 is a schematic view of an example computer system.

### DETAILED DESCRIPTION OF THE PREFERRED EMBODIMENTS

In the following, a detailed description of examples will be given with references to the drawings. It should be understood that various modifications to the examples may be made. In particular, elements of one example may be combined and used in other examples to form new examples.

Many of the examples described herein are provided in the context of a business-oriented or professional social network system and method of use. However, the applicability of the inventive subject matter is not limited to professional social networking websites or services.

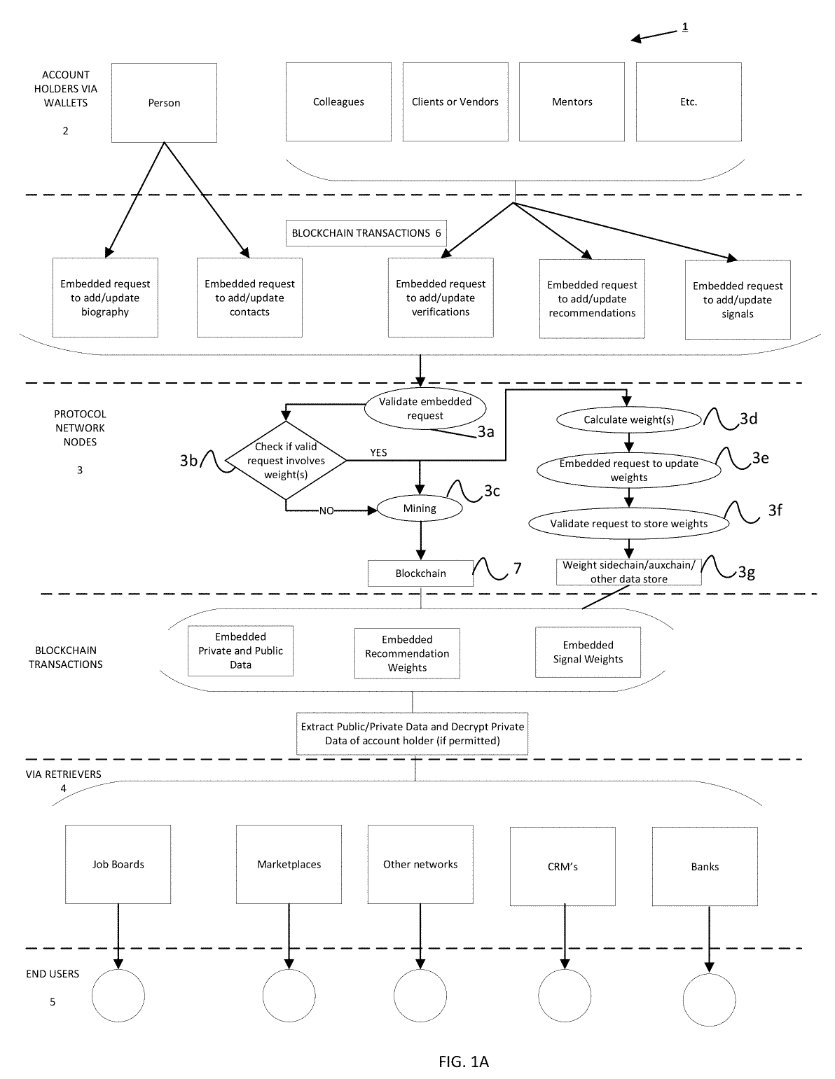

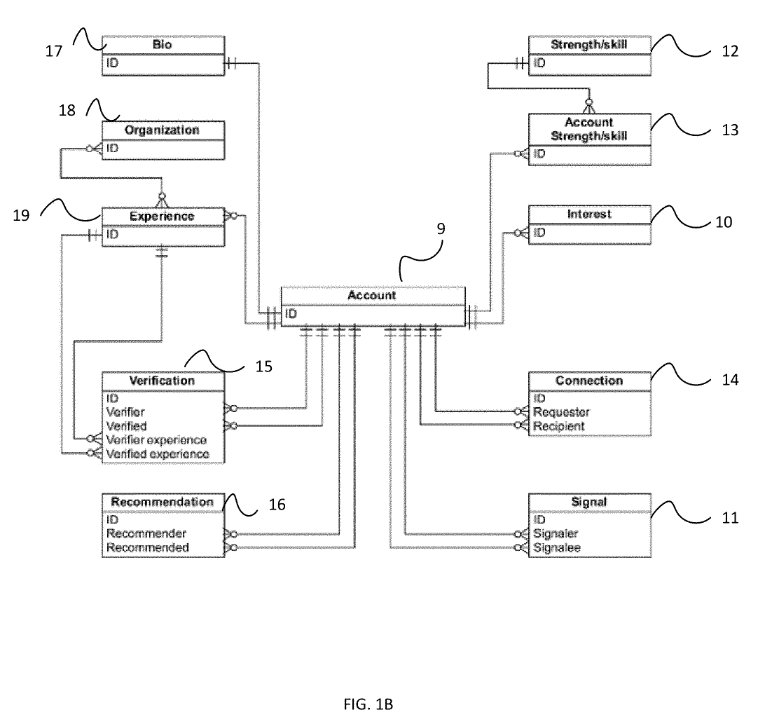

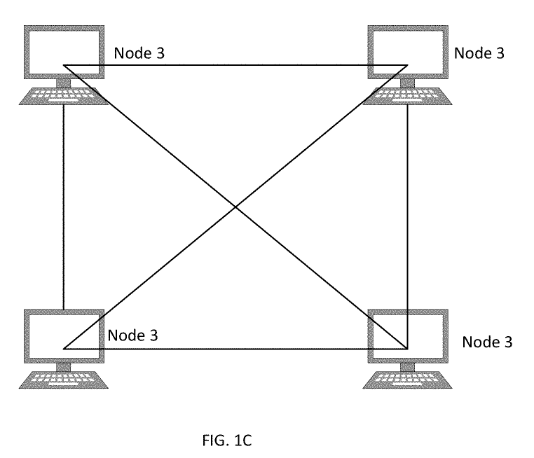

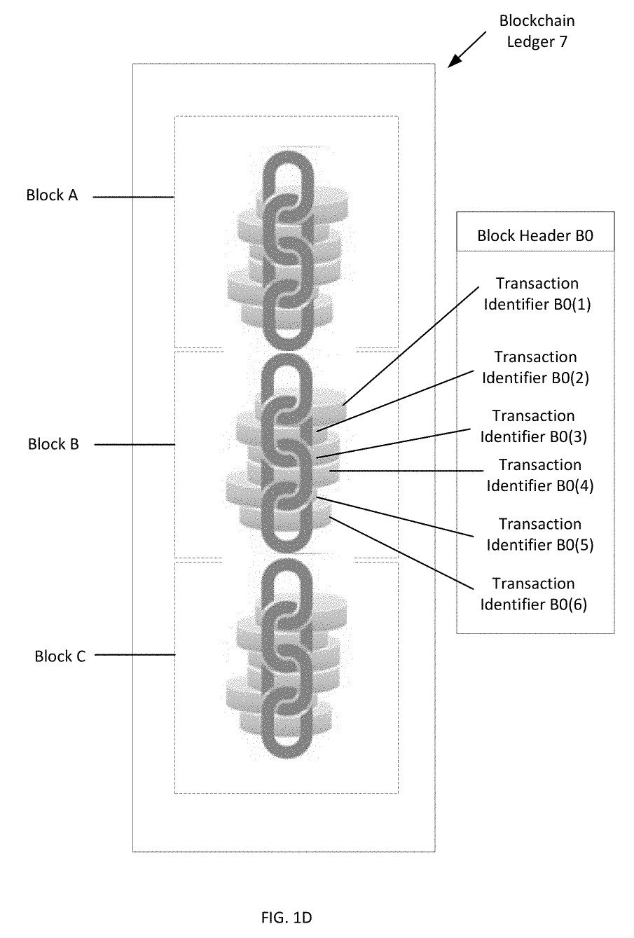

FIG. 1A shows an embodiment of participants in a blockchain enabled professional social network 1 in accordance with this disclosure. The participants of the network include account holders 2, protocol network nodes 3, retrievers 4, and end-users 5. Each participant will be described in further detail below.

First, it will be noted that account holders 2 can include various types of parties, including individuals, colleagues, clients or vendors, mentors, etc. All account holders 2 are associated with a network account and a unique account ID, which uniquely identifies each account on the network 1. The network 1 allows account holders 2 to connect to one another via transactions 6 and to add and update account profile data specific to each account holder, as described in greater detail below.

The account holder profile data may include one or more data structure types, including biographical information about the account holder, organizational information associated with the account holders past and present employers, experience(s) associated with the account holder, verifications associated with the account holder, recommendations associated with the account holder, signals associated with the account holder, connections associated with the account holder, interests associated with the account holder, account strengths and skills associated with the account holder, strengths and skills associated with the account holder, and account information associated with the account holder. Further details of a schema of the data structure types are provided hereinbelow. As a whole, in one embodiment, the profile data contained in the data structures can be used to construct an enhanced, structured curricula vitae of an account holder. In one embodiment, all of the data in the data structures are stored on a distributed ledger, such as the blockchain 7, and account holders 2 have control of access to any private data stored on the distributed ledger through the use of public key/private key encryption technologies, further details of which are described below. In some embodiments, some structured data, such as recommendation weights and signal weights may be not be stored on the distributed ledger with the other account holder profile data, but may instead be calculated on an as-needed basis from other structured data stored on the distributed ledger.

Each account ID can be linked to corresponding account holder profile data that is stored in the network, specifically in the blockchain 7. As used herein, a blockchain is a continuously growing list of records, called blocks, which are linked and secured using cryptography. Each block typically contains a cryptographic hash of the previous block, a timestamp and transaction data. A blockchain is an open, distributed ledger that can record transactions between a plurality of parties efficiently and in a verifiable and permanent way. For use as a distributed ledger, a blockchain is typically managed by a peer-to-peer network collectively adhering to a protocol for inter-node communication and validating new blocks, which is hereinafter termed “mining” blocks of the blockchain. By design, a blockchain is inherently resistant to modification of the data. Once recorded, the data in any given block cannot be altered retroactively without the alteration of all subsequent blocks, which requires collusion of the network majority.

Blockchains are secure by design and exemplify a distributed computing system with high Byzantine fault tolerance. Decentralized consensus has therefore been achieved with a blockchain. This makes blockchains potentially suitable for the recording of events and records, such as transaction processing.

In embodiments where the distributed ledger includes the blockchain 7, each participant of the network 1 may be referred to as a “node” that can access the blockchain 7 via transaction requests 6. As shown in FIG. 1A, each account holder 2 may be considered a node and may interface with the other nodes of the network 1 through a “wallet”. As used herein “wallet” means any interface between an account holder 2 and the blockchain 7. Wallets can validate the transaction requests 6 of the account holder and send them for processing by protocol network nodes 3 in accordance with steps 3a-3g, further details of which are described below. Wallets can include a command line wallet as well as a graphical user interface. Wallets also can store public and private encryption keys or other passwords used to digitally sign request transactions issued by the account holder to view, add, or modify data stored on the blockchain 7, as will described in greater detail below.

Protocol network nodes 3 are responsible for writing to the blockchain 7 in accordance with a predetermined network protocol of the network 1. A network of protocol network nodes 3 is shown in FIG. 1C, where each of the protocol network nodes 3 is connected to each other. The connections between the nodes 3 can include the internet. The protocol network nodes 3 can perform one or more of the following functions: receive transaction requests, validate or re-validate transaction requests, and process transaction requests from the wallets 2. The protocol network nodes 3 can thus add and update the structured data of the account holder's profile on the blockchain 7. The protocol network nodes 3 may also perform calculations required by the network protocol as a precondition of the task of adding and/or updating the structured data. An example of such calculations can include calculating recommendation and signal weights, which will be described in detail below. In addition, the protocol network nodes 3 can create new blocks (i.e., mining) on the blockchain 7, which entitles the protocol network nodes 3 to a tokenized reward as an incentive to perform their functions on the network 1. Further details of the processes of the protocol network nodes 3 shown in FIG. 1A will be described in detail below.

As noted above, in addition to account holders 2 and protocol network nodes 3, other participants of the network include retriever nodes 4 and end-user nodes 5, hereinafter referred to respectively as “retrievers” and “end users”. Among other things, retrievers 4 are configured to access information in the blockchain 7 and publish the public data and/or decrypted private data (if authorized) of the account holders 2. Retrievers are likely to be applications that benefit from accessing and, in some cases, publishing the profile data of the account holders 2. Retrievers 4 may include job boards, marketplaces, other networks, customer relationship managers (CRM), banks, etc. End users 5 may not have any account data stored on the blockchain 7 at all, but may access and read from the blockchain 7, either directly, or indirectly by using the retrievers 4. This is a function of the blockchain 7 being publicly available to any user. End users 5 may have accounts or subscriptions established with the retrievers 4 to use the data that the retrievers provide from the blockchain 7. In embodiments, the wallets 2 can act as and have the same or similar functionality as the end-users 5. Thus, it may be that account holders, acting as end users, may use a wallet that interacts with the blockchain via the retrievers 4.

In view of the foregoing, it will be appreciated that the network 1 described in accordance with this disclosure is decentralized and open to any party. By being decentralized, the network liberates data from centralized-proprietary services and silos. Blockchain technology makes profile data of account holders accessible across various applications and platforms. Moreover, as will be described in greater detail below, since the data on the blockchain 7 is immutable, and can be accessed publicly, the information stored there can be checked for its veracity and manipulation by account holders. In addition, because each transaction contains its own proof of validity and its own proof of authorization, a central administrator of the data stored on the blockchain is not required, enabling the data to be directly shared across boundaries of trust. Further details of the functionality of the participants of the network 1 of FIG. 1A will be described in further detail below. However, before such explanation, a listing of some exemplary data structures and associated data elements are listed below followed by descriptions thereof.

FIG. 1B shows a schema of the aforementioned data structures associated with an account holder's profile data. The data fields of any data structure can be public and/or private. As will be described in greater detail below, the private data of an account holder can be encrypted and decrypted using a public key/private key pair of the account holder. Thus, the account holder's private data is encrypted using the account holder's public encryption key, and the encrypted private data is decrypted using the account holder's private encryption key, which the account holder retains control of, but can selectively authorize other participants (i.e., retrievers) of the network to use. All data structures of the account profile can share a common data element, namely, the account ID, which links all of the profile data of the account holder together on the distributed ledger. Further, as noted below, the account holder's name is public data. Therefore, at a minimum, any participant of the network is able to associate any account holders name to an account ID and vice versa. This enables all participants to locate account holders by name as well as account ID.

The data structures of the schema shown in FIG. 1B include the following.

### Account Information—9

### Public Data:

Account: account ID
Account holder name: string
Account Verification Status: boolean
Professional headline: string
Total Recommendation weight: bigdecimal
Characteristic Signal weight: bigdecimal (optionally made public)
Public keys: sequence of public keys
Created: time

### Private Data:

Past encryption keys: sequence of past public keys for encryption.

### Biographical Data of the User's Account—17

### Public Data:

Account: account ID

### Private Data

Picture: file
Location coordinates: coordinates
Location name: string
Links: string
Bio summary: string
Email address: string
Telephone country: string
Telephone number: string

### Organization Data—18

### Public Data:

Account: account ID
Organization ID: string
Organization Name: string

### Experience Data—19

### Public Data:

Account: account ID
Experience ID: string
Experience Type (job, project, publication, education, mentoring, achievement/award, investment): integer
Experience Name: string
Organizations: sequence of organization IDs
Date from year: integer
Date from month: integer
Date to year: integer
Date to month: integer
Location coordinates: coordinates
Location name: string
Related strengths/skills: sequence of strength/skills IDs
Experience Verification Status: boolean
Verifications: integer
Recommendations: bigdecimal
Recommendation weight: bigdecimal
Created: time

### Private Data:

Contribution: string
Description: string
Related links: string
Persons: sequence of persons IDs
Related experiences: sequence of experience IDs
Related interests: sequence of interest IDs

### Strength/Skill Data—12

### Public Data:

Account: account ID
Strength ID: string
Strength Name: string

### Account Strength/Skill Data—13

### Public Data:

Account: account ID
Account Strength ID: string
Strength/skill: Strength ID
Related experiences: sequence of experience IDs
Recommendations: bigdecimal
Recommendation weight: bigdecimal
Created: time

### Private Data:

Description: string
Related links: string
Related strengths/skills: sequence of strength/skills IDs
Related interests: sequence of interest IDs

### Interest Data—10

### Public Data:

Account: account ID
Interest ID: string
Interest Name: string
Created: time

### Private Data:

Interest Description: string
Related links: string
Related experiences: sequence of experience IDs
Related strengths/skills: sequence of strength/skills IDs
Related interests: sequence of interest IDs

### Verification Data—15

### Public Data:

Account: account ID
Verification ID: string
Verifier: account ID
Verified: account ID
Verifier experience: experience ID
Verified experience: experience ID
Relationship type (led, worked alongside, reported to, was client of, was vendor of, taught, was student of, was student mate of, received mentoring from, was mentor of, invested in, received investment from, received award from, gave award to, receive award alongside): integer
Created: time
Retracted: time

### Recommendation Data—16

### Public Data:

Account: account ID
Recommendation ID: string
Recommender: account ID
Recommended: account ID
Strengths/skills: sequence of strength/skill IDs
Longevity type: (minutes, hours, days, weeks, months, years): integer
Verification: Verification ID
Recommendation weight: bigdecimal
Created: time
Retracted: time

### Signal Data—11

### Public Data:

Signal ID: string
Signaler: account ID
Signalee: account ID
Signal strength attribute (default, weak, strong): integer
Signal weight: bigdecimal
Deletion requested: time
Created: time
Retracted: time

### Connection Data—14

### Public Data:

Account: account ID
Connection ID: string
Requester: account ID
Recipient: account ID
Created: time
Accepted: time
Rejected: time
Connection termination: time

The data structures include an account table or object 9 for each registered account holder, which includes, among other fields, an “account ID” field for identifying the registered account holder, a “created” field representing the data and time that the registered account holder was created, a “recommendation weight” field that represents the total recommendation weight for the registered account holder, and a “signal weight” field that represents that characteristic signal weight for the registered account holder.

The data structures also include a strengths table or object 12 for each strength or other experience of the account holder, which includes an “account ID” field, a “strength/skill ID” field for identifying the strength or other experience, a “strength/skill name” field that refers the name of the strength or other experience corresponding to the “strength/skill ID”. The strengths table 12 can be pre-populated for each account holder in accordance with the network protocol.

The data structures also include an account strength/skill table or object 13 for each account. The object 13 includes an “account strength/skill ID” for identifying a particular account strength associated with the account, an “account ID” field for identifying the account holder, a “strength/skill ID” field for identifying the strength or skill identified in the strengths table 12, a “related experiences” field for identifying one or more experience ID's in an experiences table 19 (described later), a “recommendation” field for specifying a recommendation amount, a “recommendation weight” field that represents the current value of the per-experience weight for the strength or other experience, a “created” field representing a timestamp that the account strength/skill was created.

The data structures also include a connections table or object 14 for each connection between account holders, which includes, among other fields, a “connection ID” field for identifying the connection, a “requester” field that refers or links to the account table or object 9 in which the account holder of the connection is identified, and a “recipient” field that refers or links to the account table or object 9 in which the other account holder of the connection is identified. The connections table 14 also includes a “created time” field for noting the timestamp of when the connection was sent by the requester, an “accepted time” field for noting the timestamp of when the connection was accepted by the recipient establishing the connection, a “rejected time” field for noting the timestamp of when the connection request was rejected by the recipient, and a “trashed time” field for noting the timestamp of when the recipient retracted his or her acceptance.

The data structures also include a verification table or object 15 that represents the verification of one account holder (verified) by another account holder (verifier). The verification table 15 includes a “verification id” field for identifying the verification, a “verifier” field for identifying the account ID of the verifier's account from the account table 9, a “verified” field for identifying the account ID of the verified account holder from the account table 9, a “relationship” field that represents the type of relation of the verifier to the verified account holder, an “verifier experience” field that refers to or links to an experience of the verifier that pertains to the verification, an “verified experience” field that refers to or links to an experience of the verified account holder that pertains to the verification, and “created” and “retracted” fields representing the data and time that the verification was created and retracted (if applicable), respectively.

The data structures also include a recommendations table or object 16 that represents a recommendation given by one account holder (the recommender) to another account holder (the recommended). The recommendations table 16 includes a “recommendation id” field for identifying the recommendation, a “verification id” field that refers or links to a corresponding verification in the verification table 15, a “recommender” field for identifying the account ID of the recommender account holder in account table 9, a “recommended field” for identifying the account ID of the recommended account holder in account table 9, a “strength/skills” field for identifying one or more strength/skill ID's from strength/skill ID table 12, a “longevity type” field that represents the longevity type of the relation between the recommender and the recommended upon which the recommendation is based, a “recommendation weight” field that represents a current value of the recommendation weight, and “created” and retracted” fields representing the data and time that the recommendation was created and retracted (if applicable), respectively.

The data structures also include a biographic information table or object 17 that lists biographical information of the account holder. The biographic information table 17 includes an “account Id” field for identifying the account ID of the account holder in account table 9 associated with the biographical information in table 17, a “picture” field for saving a picture file, a “location coordinates” field for specifying the geographical coordinates of the account holder, a “location name” field for specifying the name of the geographical location of the account holder, a “links” field for listing links related to the account holder which can be accessed online by other account holders, a “bio summary” field for storing a summary of the biographical information of the account holder in a narrative form, for example, an “email address field” for specifying an email contact of the account holder, a “telephone country” field for specifying a country dialing code of the account holder, and a “telephone number” field for specifying a telephone number of the account holder.

The data structures also include an organization information table or object 18 for each organization of the account holder, which includes an “account ID” field for identifying the account holder in account table 9, an “organization ID” field for identifying an organization, and an “organization name” field to specify a name of the organization corresponding to the organization ID.

The data structures also include an experience information table or object 19 for each account holder. The table 19 includes an “account ID” field to identify the account holder in table 1 associated with the experience, an “experience ID” field for identifying the experience, an “experience name” field corresponding to the experience ID, an “experience type” field for specifying the type of experience, an “experience organization” field for specifying one or more organization ID's from organization information table 18 corresponding to the organization at which the experience took place, a “date from year”, “date from month”, “date to year”, and “date to month” fields to specify the start and end times of the experience, a “location coordinates” field for specifying the geographical location of the experience, a “location name” field for specifying the geographic name of the location of the experience, a “related strength/skills” field for specifying one or more strength/skills ID from strength/skills ID table 12 for the account holder's strengths and skills, a “verified” field for specifying whether or not another account holder has verified the account holder's experience, a “verifications field” for specifying a number of verifications of the experience, a “recommendations” field for specifying recommendations associated with the experience, a “recommendation weight” field specifies a recommendation weight associated with recommendations for the experience, and a “created” field for specifying a timestamp of when the experience was created. In addition to the foregoing fields, the experience table 19 can include a “contribution” field for specifying an account holder's contribution to the experience, a “description” field for describing the experience, a “related links” field for listing one or more links to the content about the experience, a “persons ID” for specifying one or more account ID's of other account holders who shared the experience in common, a “related experiences” field for specifying one or more related experience ID's listed in the experience table 19, and a “related interests” field for specifying one or more interest ID's from an interest information table, described in greater detail below.

The data structures also include an interest information table or object 10 for each account holder. The interest table 10 includes an “interest ID” field for identifying each interest, an “account ID” field for identifying the account holder corresponding to the interest ID, an “interest name” field for naming the interest, a “created” field for specifying a timestamp of when the interest was created. In addition, the interest table 10 includes a “description” field for describing the interest, a “related links” field for specifying links about the interest, a “related experiences” field for listing one or more experience ID's of experiences listed in the experience table 19, a “related strengths/skills” field for specifying one or more strength/skill ID's of strengths/skills listed in the strength/skill ID table 12, and a “related interests” field for specifying one or more interest IDs of interests listed in the interest table 10.

The data structures also include a signal information table or object 11 for each account holder. The signal table 11 can include a “signal ID” field for identifying the signal, a “signaler field” for identifying the account ID of the account holder of the “signaler” or source of the signal from account table 9, a “signalee field” for identifying the account ID of the account holder of the “signalee” or target of the signal from account table 9, a “signal strength” field that represented a type or strength (an integer) related to the signal, a “signal weight” field that represented a signal weight associated with the signal, a “deletion requested” field to specify a timestamp of when a signaler sought to retract a signal, a “creation” field to specify a timestamp of when a signaler sent the signal, and a “retracted” field to specify a timestamp of when the signaler retracted the signal.

One important feature of the network is that account holders may connect with or link to other account holders. A “connection” is a reciprocal relationship between two account holders or other party, such as a service provider or application. The connections are similar to Facebook® friendships and LinkedIn® connections. While connections must be accepted by both parties to establish the connection, connections can be broken (i.e., retracted) by either party. With the intent of reducing potential abuse, the number of yet-to-be-accepted connection requests per account holder can be limited.

Among the data structures listed above, the recommendations, verifications, and signals, permit other account holders (as well as other parties) to evaluate the veracity of the profile data of the account holder stored in the blockchain 7. For example, recommendations can be received from and given by any account holder, although recommendations do not have to be reciprocal.

As used herein, a “recommendation” of an account holder shall mean an action where one account holder (the “recommender”) recommends or endorses another account holder (the “recommended”). It is contemplated that the recommender can associate zero or more strengths or other experiences of the recommended that is part of the profile of the recommended with the recommendation so as to convey a basis for the recommendation. Recommendations, which are stored in the blockchain 7 with the other account profile data, are publicly available for all users to see. Also, recommendations can be publicly retracted by account holders who made the recommendations, but they cannot be deleted from the distributed ledger. This adds to the credibility of the network, since it makes transparent to other users whether recommendations are being manipulated.

In one embodiment, to enhance the credibility of a recommendation, each recommendation is accompanied by a corresponding recommendation weight, which can dynamically change over time, as noted in greater detail below. A recommendation weight for a recommendation is a relative indication of the trustworthiness of the recommender making the recommendation. Thus, if a very trusted account holder with a good reputation recommends another user with a numerical rank, the recommendation weight may be applied to the numerical rank which will result in a weighted numerical rank that will indicate to all other account holders viewing the recommended account holder's profile that the recommendation carries additional weight or is more trustworthy than a recommendation with a lower weight. Thus, if a numerical recommendation given is 100 out of 0-100 scale, and the recommendation weight of a highly recommended account holder is 1, the effective or weighted rank is 100 (1×100=100). However, if another account holder has a lesser reputation, that account holder's recommendations may carry less weight (e.g., 0.80). Therefore, if the second account holder gives a recommendation of 100, the effective or weighted recommendation would only be 80 (0.80×100=80), which is less than the first account holder's recommendation.

Recommendation weight is intended to be scarce and dynamically changing. Moreover, recommendations have greater weight when they come from account holders who have themselves been recommended by other account holders, and, thus, have established credibility and a reputation. With each recommendation given by an account holder, the overall recommendation weight of that account holder's recommendations diminishes proportionally. Thus, the recommendations made by an account holder who recommends selectively have greater weight than those recommendations made by an account holder who does not recommend selectively. Since it is possible that the selectiveness of an account holder making recommendations can change over time, the weights attached to any recommendations that the account holder makes for other account holders can also change over time. Thus, as noted above, the recommendation weights of the recommended account holder and the recommender account holder can change over time.

The recommendation weight for a given recommendation is calculated from the total recommendation weight of the recommender and a longevity parameter that characterizes the time duration of the relation between the recommender and the recommended. The total recommendation weight for the recommender is calculated from the sum of the recommendation weights for all recommendations received by the recommender. The recommendation weight associated with a given recommendation can provide a measure of trustworthiness of the given recommendation as a recommendation with a relatively higher recommendation weight comes from a user that has been more highly recommended by other users.

In addition to a recommendation given for a user, each recommendation can be qualified by being accompanied by a list of strengths or positive attributes of the recommended account holder. As used herein, a “strength” of a person or user shall mean a particular skill or specialty or talent or other attribute or quality possessed by the recommended account holder. The recommendation weight associated with a given recommendation can be distributed amongst one or more strengths or other experiences of the recommended specified by the recommender to derive a set of per-strength (or per-experience) recommendation weights associated with a given recommendation. Each per-strength (or per-experience) recommendation weight can provide a measure of trustworthiness of the corresponding strength (or experience) specified by the recommender as part of the recommendation. Furthermore, the total recommendation weight for an account holder can provide a measure of trustworthiness of the account holder as an account holder with a relatively higher total recommendation weight has been more highly recommended by other users. In this manner, the recommendation weights for the recommendations received by an account holder, the per-strength (or per-experience) recommendation weights associated therewith, and the total recommendation weight of the account holder can add measures of trustworthiness (and truthfulness) to the account holder's professional data stored in the distributed ledger. Moreover, others can use these measures of trustworthiness and truthfulness in evaluating the trustworthiness and/or truthfulness of the professional experiences that the account holder has stored in the distributed ledger.

As noted above, recommendation weights may also be based on verified, shared experiences between account holders. An account holder may include an experience among their structured data. For example, recommendations have greater weight when they are associated with a shared, verified experience between the recommender and the recommended. As used herein, an “experience” of an account holder shall mean a past or present job or position of the account holder, a title for a job or position of the account holder, a project that the account holder is contributing to (or has contributed to), an educational degree or certificate earned by the account holder, an interest of the account holder, a strength of the account holder, an organization or club that the account holder participates in or belongs to, and/or other experiences that relate to the account holder's profession(s) or occupation(s) over time.

Each user experience can be verified by one or more other account holders. A verification is a public acknowledgment that one account holder gives to another account holder in reference to a shared professional-related experience. Like recommendations, verifications also do not have to be reciprocal. Verifications include a relationship type, which may include, for example, “led”, “worked alongside”, “reported to”, “was client of”, “was vendor of”, “taught”, “was student of”, “was classmate of”, and “received mentoring from”.

Verifications can serve multiple purposes. When an experience is verified (a job, a project, etc.), it is marked or otherwise appended in the structured data in the verification table 15 as being verified by a verifier account holder, thus adding to the trustworthiness of the professional data associated with the account holder. Moreover, as shown in the account table 9, an entire profile of an account holder can be verified when the account holder has received experience verifications from a predetermined number (e.g., three) of different already-verified account holders, thus adding trustworthiness to the data.

The verification information is public and can be accessed by any participant of the network, i.e., all account holders. While verifications can be publically retracted by their verifier, the verifications cannot be deleted from the distributed ledger (i.e., they are immutable). Thus, even if a verification of an account holder's experience is retracted by a verifier, other account holders or other users viewing the account holder's data on the distributed ledger will see the original verification as well as the retraction. To speed up the adoption of the network, temporary data verification methods could be implemented. For example, to “seed’ the network with verified users, network administrators could manually verify certain users for some time.

Recommendations and verifications are related. As noted above, the recommendation weight associated with a recommendation can be significantly more when it is associated with a verified, shared experienced. Thus, for example, when a recommender is verified and has a total recommendation weight below 100 (for example a new account holder to the network), the total recommendation weight of the recommender may be 100. However, if the recommender has not been verified, the total recommendation weight of the recommender is 0. To reduce the chances of manipulation, the recommendation weight and signal weight seed the network through verified persons.

In addition to recommendations and verifications, another data element that can be exchanged between account holders is a signal, which, as used herein shall mean an action from one account holder (the “signaler” or source account holder) to another account holder (the “signalee” or target account holder) to indicate that the signaler is interested in working with the signalee, for example, on a project or job, or to indicate that the signaler is interested in doing business with the signalee, or to indicate that the signaler is interested in learning from the signalee, or to indicate that the signaler has some other professional interest in the signalee. It is contemplated that the signaler can associate any number of strengths or other experiences of the signalee with the signal so as to convey a basis for the signaler's interest in the signalee.

In embodiments, any account holder can signal another account holder. As with recommendations and verifications, signals do not have to be reciprocal. Of course, it will be appreciated that a signaler who signals many account holders may not actually be interested in professional relationships with all of the signalees, but may be only interested in soliciting attention. Thus, it is important for account holders who are signaled to be able to determine the veracity of the signals they receive.

One way of indicating the relative trustworthiness of the signal and the signaler is to introduce the concept of signal weights associated with each signal, in similar fashion to recommendation weights. For example, signals have greater weight when they come from account holders who have also been signaled by other account holders. Signal weight, like recommendation weight, is intended to be scarce and dynamically changing. Moreover, a signal weight associated with a signal can have greater weight when it comes from an account holder who has been signaled by other account holders. With each signal sent by a particular account holder, the characteristic signal weight of that particular account holder can diminish proportionally. Thus, similar to recommendations, the signals sent by an account holder who signals selectively can have greater weight than those signals sent by an account holder who does not signal selectively. Thus a higher signal weight associated with a given signal can indicate that the signaler is more serious in their interest with the signalee than a signal from another signaler who has a lower signal weight associated with their signal.

The signal weight for a given signal can be calculated from many factors, such as the characteristic signal weight of the signaler, a signal-type factor for the given signal, a damping factor, and a total of the signal-type factors for all of the signals given by the signaler.

The characteristic signal weight of an account holder can be calculated from the sum of the signal weights for all signals received by the signaler or by other formulaic calculations as described herein.

Moreover, the signal weight associated with a given signal can be distributed amongst one or more strengths or other experiences of the signalee specified by the signaler to derive a set of per-strength (or per-experience) signal weights associated with a given signal. Such per-strength (or per-experience) signal weights are similar to the per-strength (or per-experience) recommendation weights as described herein. Each per-strength (or per-experience) signal weight can provide a measure of trustworthiness of the corresponding strength (or experience) specified by the signaler as part of the signal. Others can use these measures of trustworthiness and seriousness in evaluating the trustworthiness and/or truthfulness of the signaler.

In embodiments, a signal can be associated with a signal strength attribute that is selected by the account holder that generates or sends the signal. The signal strength attribute can represent varying levels of interest of the sending account holder of the signal with the recipient account holder of the signal. For example, the signal strength attribute can be one of two values that represent a “regular” signal and a “super” signal. In this case, the signal strength attribute value of the “super” signal represents a higher or stronger level of interest of the sending account holder of the signal with the recipient account holder of the signal relative to the signal strength attribute value of the “regular” signal.

In embodiments, the service can use the signals to automate the process of referring or notifying people of a job or opportunity. For example, the service can be configured to automatically notify the sending account holder of a signal of relevant opportunities posted by the recipient account holder (person or organization) of the signal. Furthermore, when the recipient account holder (or possibly an agent acting on behalf of the recipient account holder) performs a search for talent to fill a job opportunity, the recipient account holder (or possibly the agent acting on behalf of the recipient account holder) can be automatically notified of the signal generated or sent by the sending account holder to the recipient account holder.

In embodiments, a signal generated or sent by the sending account holder is visible to a limited class of participants of the network, such as only to the recipient account holder and possibly to an agent acting on behalf of the recipient account holder and possibly to other recipient account holders that the sending account holder has signaled. It is also possible for the sending account holder that generated or sent a signal to share that signal to the other participants to help them find talent.

In embodiments, with the intent of reducing potential manipulation, a signal can be retracted by the signaler (sending account holder) of that signal within a limited time period, such as within a one year period after being created. However, regardless of being retracted, a record of the retraction of the signal can be stored by the system and viewable to some or all participants of the network.

In embodiments, the count or number of signals that have been sent by a given account holder and/or the count or number of signals that have been sent to a given account holder can be public information available to all users of the network and displayed as part of the biographical profile date of the given account holder.

The recommendations and recommendation weights maintained by the network will now be described. In the following example, each recommendation is made by a first account holder (the recommender) who recommends a second account holder (the recommended). Total recommendation weights corresponding to the plurality of account holders as well as recommendation weights corresponding to the recommendations can be dynamically calculated, and data representing the total recommendation weights corresponding to the plurality of account holders and data representing the recommendation weights corresponding to the recommendations can be stored. Data representing the total recommendation weight corresponding to a given account holder can be retrieved and displayed in conjunction with the display of at least part of a profile data of the account holder. A representation of a given recommendation and data representing the recommendation weight corresponding to the given recommendation can be displayed together.

In embodiments, the representation of a given recommendation and the data representing the recommendation weight corresponding to the given recommendation can be displayed in conjunction with displaying at least part of a profile of the second account holder of the given recommendation. Additionally or alternatively, the representation of a given recommendation and the data representing the recommendation weight corresponding to the given recommendation can be displayed in conjunction with displaying at least part of a profile of the first user of the given recommendation.

In embodiments, the recommendation weight for a given recommendation can be based on the total recommendation weight of the first account holder of the given recommendation. Additionally or alternatively, the recommendation weight for a given recommendation can be based on a longevity parameter that characterizes time duration of the relation between the first account holder and the second account holder of the given recommendation. Additionally or alternatively, the recommendation weight for a given recommendation is based on a factor dictated by type of relationship between the first account holder and the second account holder of the given recommendation. Additionally or alternatively, the recommendation weight for a given recommendation is normalized by a sum corresponding to the total number of recommendations made by the first account holder of the given recommendation.

In embodiments, the recommendation weight for a given recommendation can be of the form:

$${w}_{r} ( X 1 , Y ) = \frac{t ( X 1 ) {L}_{X 1 , Y} {F}_{X 1 , Y} d}{{{Σ}_{i = 0}^{n} ( {L}_{i} {F}_{i} )}_{X 1}} \qquad Eqn . ( 1 )$$

where X1 denotes the first account holder giving the recommendation and Y denotes the second account holder receiving the recommendation,
t(X1) is the total recommendation weight of X1;
L_{X1,Y} is a longevity factor that depends on the time duration of the relation between X1 and Y;
F_{X1,Y} is a factor associated with the type of relation between X1 and Y;
d is a damping factor constant in the interval [0,1] (e.g., 0.9), which limits the extent to which X1's total recommendation weight will be inherited by its recommendations; and
the summation Σᵢ₌₀ⁿ(LᵢFᵢ)_{X1} corresponds to the total number of recommendations made by X1, and more specifically adds the multiplication product of the longevity factors and relation type factors for all the recommendations given by X1.

At any moment in time, the summation of all recommendation weights cannot be more than 100V, where V is the number of verified account holders in the network.

Σᵣ₌₀ⁿWᵣ≤100V Eqn. (2)

The difference in value between the two sides of the equation, if any, is caused by retracted recommendations.

In embodiments, the total recommendation weight for a given account holder can be calculated from the sum of the recommendation weights for all recommendations received by the given account holder. For example, the total recommendation weight for a given user can be of the form:

t(Y)=β(wᵣ(X1,Y)+ . . . wᵣ(Xn,Y)) Eqn. (3)
where Y is the recommended account holder by a number of other account holders denoted X1 . . . Xn;
β is a damping factor constant in the interval [0,1], which limits the extent in which Y's total recommendation weight will be inherited by its recommendations; and
the sum wᵣ(X1, Y)+ . . . wᵣ(Xn, Y) represents the sum of all the recommendations weights for the recommendations that Y has received.

Thus, it will be appreciated that the recommendation weight corresponding to a given recommendation can provide a measure of trustworthiness of the given recommendation, and the total recommendation weight corresponding to a given account holder can provide a measure of trustworthiness of the given account holder.

As shown above, the experience table 109 includes the “recommendations” and “recommendation weight” fields. Thus, a recommender can associate their recommendation with one or more experiences associated with the recommended account holder's profile. A method can include calculating per-experience recommendation weights for the set of experiences of the second account holder that are associated with the given recommendation, and storing data representing the per-experience recommendation weights for the set of experiences of the second user that are associated with the given recommendation. The per-experience recommendation weights associated with the given recommendation can be calculated by distributing the recommendation weight corresponding to the given recommendation.

Also, a method can include determining a total per-experience weight for at least one particular experience of a given account holder by summing the per-experience recommendation weights for the particular experience that corresponds to all recommendations received by the given account holder, and storing data representing the total per-experience weight for the at least one particular experience of the given account holder. Data representing the total per-experience weight for at least one particular experience of the account holders can be used to rank account holders that match a particular job posting or account holders that are interested in a particular job posting. Additionally or alternatively, data representing the total recommendation weights of account holders can be used to rank account holders that match a particular job posting or account holders that are interested in a particular job posting.

The signals and signal weights maintained by the network will now be described. In the following example, each signal is made by a first account holder (the signaler) who signals to a second account holder (the signalee) of his/her interest in a professional relationship with the second account holder (the signalee). For example, the signal can represent an interest of first account holder (the signaler) in working with or doing business with or learning from the second account holder (the signalee). A method includes storing data representing the signals. Signal weights corresponding to the signals as well as characteristic signal weights corresponding to the plurality of account holders can be dynamically calculated by the system, and data representing the signal weights corresponding to the signals and data representing the characteristic signal weights corresponding to the plurality of account holders can be stored in data storage (i.e., stored in the blockchain or the weight sidechain/auxchain/or other data storage). Data representing a signal and optionally the signal weight corresponding to the signal can be displayed, such as in a graphical user interface used by a respective account holder, in conjunction with the display of at least part of a profile of the respective account holder. A representation of a given signal and data representing the signal weight corresponding to the given signal can be displayed together. Optionally, data representing the characteristic signal weight corresponding to a respective account holder can be displayed, such as in a graphical user interface used by the respective account holder, in conjunction with the display of at least part of a profile of the respective account holder.

In embodiments, the representation of a given signal and optionally the data representing the signal weight corresponding to the given signal can be displayed in conjunction with displaying at least part of a profile of the second account holder of the received signal. Additionally or alternatively, the representation of a given signal and optionally the data representing the signal weight corresponding to the given signal can be displayed in conjunction with displaying at least part of a profile of the first account holder of the given signal.

The signal weight for a given signal can be based on the characteristic signal weight of the first account holder (i.e., the signaler) of the given signal. Additionally or alternatively, the signal weight for a given signal is based on a factor dictated by a signal strength attribute (such as a regular-type or super-type that specifies variable strength of the signal). Also, the signal weight for a given signal can be based on a damping factor that reduces signal weight of successive signals made by the given account holder. Additionally or alternatively, the signal weight for a given signal is normalized by a sum corresponding to type factors of all signals given by the signaler, including signals marked for deletion.

For example, in embodiments, the signal weight for a given signal can be of the form:

$${w}_{s} ( X 1 , Y ) = \frac{t ( X 1 ) d {F}_{X 1 , Y}}{{{Σ}_{i = 0}^{n} ( {F}_{i} )}_{X 1}} \qquad Eqn . ( 4 )$$

where X1 denotes the account holder giving the signal (the signaler) and Y denotes the account holder to which the signal is directed (the signalee);
t(X1) is the characteristic signal weight of X1;
d is a damping factor;
F_{X1,Y} is a signal-strength attribute factor associated with the strength-type of signal, for example, the factor can numerically be in the range of [1, 100]; and
the summation Σᵢ₌₀ⁿ(Fᵢ)_{X1} corresponds to the total of factors of all the signals made given by X1, including signals marked for deletion.

The characteristic signal weight for a particular account holder can be calculated using one or more different formulaic expressions based on data representing one or more signal weights for the particular account holder corresponding to one or more signals directed to the particular account holder. For example, the characteristic signal weight for a particular account holder can be calculated by summing signal weights for the particular account holder which correspond to signals directed to the particular account holder that have not been retracted. In another example, the characteristic signal weight for a particular account holder can be calculated by averaging signal weights for the particular account holder which correspond to signals directed to the particular account holder that have not been retracted. In yet another example, the characteristic signal weight for a particular account holder can be calculated by selecting a highest signal weight from the signal weights for the particular account holder which correspond to signals directed to the particular account holder that have not been retracted. Other suitable numeric operations can also be used to calculate the characteristic signal weight for a particular account holder.

In embodiments, at any moment in time, the summation of all signal weights cannot be more than 100V, where V is the number of verified account holders in the system as follows:

Σₛ₌₀ⁿWₛ≤100V Eqn. (5)

Note that the difference in value between the two sides of the equation, if any, is caused by retracted signals.

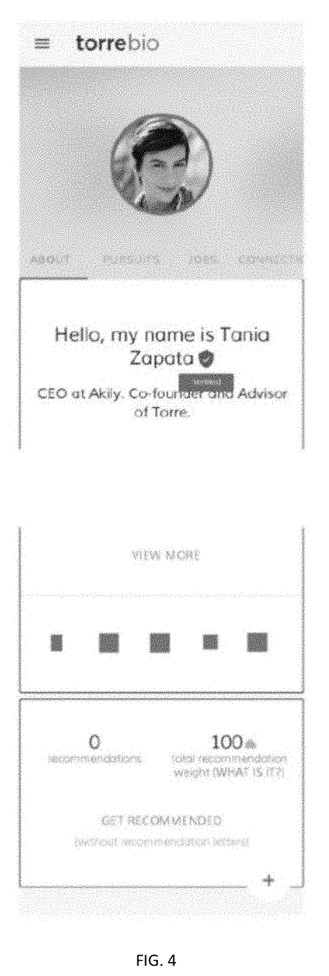

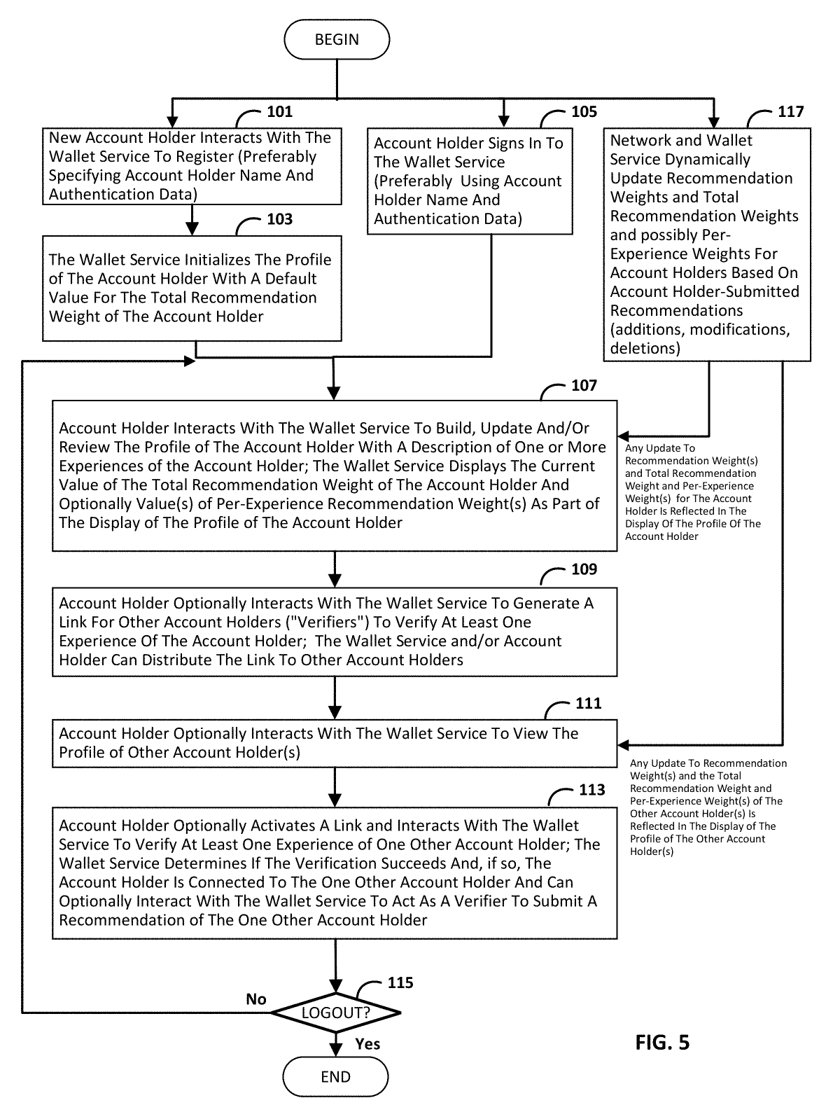

In embodiments, at least one computer processor of the system, such as a graphical user interface used by an account holder, can be further configured to include at least one module configured to present for display data representing the total recommendation weight and signal weight corresponding to a given account holder in conjunction with displaying at least part of a profile of the given account holder, as shown in FIG. 4, for example. Additionally or alternatively, the at least one computer processor of the system can be further configured to include at least one module configured to present for display a representation of the given recommendation and signal and data representing the recommendation and signal weights corresponding to the given recommendation and signal.

In embodiments, at least one computer processor of the system can be configured to include modules that perform other parts of the method as described and claimed in the present disclosure.

In other aspects, parts or all of the methods as described and claimed in the present disclosure can be embodied in a machine or computer readable storage medium including instructed, which when executed on the machine or computer, cause the machine or computer to carry out such method steps.

In other aspects, the user account data, including user connections, verifications, recommendations, and signals, along with recommendation weights and signal weights, may be stored in a distributed ledger, such as the blockchain and weight sidechain/auxchain shown in FIG. 1A.

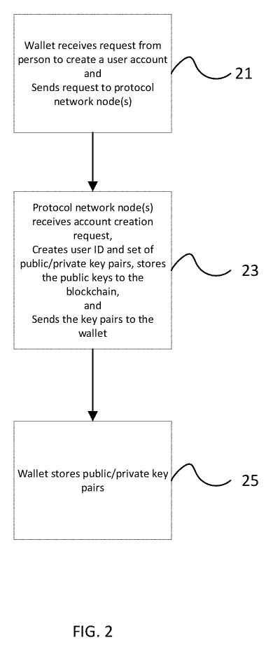

As a precursor to the methods shown in FIG. 1A, each account holder in FIG. 1A must create an account, further details of which are described with reference to FIG. 2. At step 21 a party seeking to create an account on the network sends an account creation request, which is a transaction request, to protocol network nodes using a respective wallet. At step 23, the protocol network node receives the account creation request, generates an account ID, and a plurality of public/private key pairs, and commits the public keys and the account ID to the distributed ledger (e.g., blockchain). At step 23, the account ID may be added to account table 9 in FIG. 1B. At step 25, protocol network nodes return the plurality of the public/private key pairs and the account ID to the wallet of the party, which is now an account holder.

Once an account is created, the new account holder can request, using the wallet, additions and updates of profile data associated with his or her account ID. To add or update any profile data of the account holder, such as any data in fields of the schema of FIG. 1B, an account holder can issue one or more embedded requests to the protocol network nodes via their respective wallet. To be validated, each request must be signed with a digital signature of the account holder. Such digital signature can be generated and validated using the account holder's private key/public key pair.

The private key/public key pairs are used to authenticate account ownership and for various functions. The protocol can be implemented using one of many available private-public key authentication schemas. In one embodiment, the public keys of the key pairs are stored in plain-text format in the blockchain, while the private keys are stored separately by the account holder, such as in a wallet accessible by the account holder. The validation protocol used in the network can be implemented using different types of key pairs. In one embodiment, the key pairs may include:
Public and Private Validation keys: Used to validate account ownership. They do not grant access to encrypted content, nor allow account changes.
Public and Private Encryption keys: Used to encrypt and decrypt account data that is private and must reside in the distributed ledger.
Public and Private Management keys: Used to add and update account information, such as data elements of structured data of account holder profiles.
Public and Private Connection keys: Used to create connections in one step and avoid going through a connection request.

Account holders can store the keys on non-transitory storage media (such as a USB drive, hard disk drive, floppy disk), which may be used with wallet(s). In one embodiment, a network-specific wallet can be employed to store the key pairs. The wallets can be “hot” or “cold”, hardware-based, web-based, etc. Physical wallets and online wallets can interact in multiple ways, including widely adopted protocols such as OAuth.

For security reasons, account holders can reset all of their keys using their management keys or similar. Such a reset must be made as an embedded request to a wallet and include requests to:
1. Encrypt the old encryption keys with a new encryption key;
2. Add the encrypted old encryption keys to the sequence of past encryption keys of the account; and
3. Add the new public keys, including the new public management key, to the distributed ledger.

Some requests from account holders, such as making a recommendation for another account holder or sending a signal to another account holder, can involve recommendation weights or signal weights. Such requests can require calculating the recommendation or signal weight associated with the recommendation or signal. As shown in FIG. 1A, upon receiving a transaction request from an account holder, a wallet can generate a digital signature of the account holder using the account holder's private keys, which can be held or stored by the wallet. The wallet can embed the digital signature into the transaction request and send it to the protocol network node(s) 3, which validate the request at step 3a. Once the request is validated, the protocol network nodes 3 determine whether the validated request involves recommendation or signal weights at step 3b. If the transaction does not involve recommendation or signal weights (e.g., an account holder updated his location coordinates) (NO at step 3b), then the protocol network nodes 3 can perform the requested transaction and commit the information to the blockchain 7 at step 3c. However, if the transaction does involve recommendation or signal weights (e.g., an account holder is sending a signal)(YES at step 3b), then the protocol network nodes 3 can perform the requested transaction at step 3c and commit the information to the blockchain 7, while also performing one or more auxiliary transactions for the weight calculation at steps 3d, 3e, 3f, and 3g. Specifically, the additional transaction calculates any weights at step 3d, updates any weights at step 3e, validates a request to store any weights at step 3f, and stores any weights to a sidechain/auxchain/or other data storage location at step 3g, (or to the blockchain 7). Alternatively, in embodiments, steps 3d to 3g may not be done by the network 1 at all, and the calculation and storage of weights may be performed by one or more other processing systems.

All nodes of the network 1 can store the distributed blockchain 7, which contains data corresponding to transactions and data corresponding to blocks (e.g., FIG. 1D, blocks A, B, C) of transactions. The nodes can store portions of the blockchain 7 or the complete blockchain 7. For example, some nodes might store data for the entire blockchain, while other nodes might store data for only certain transactions, such as the calculated recommendation and signal weights. A node (e.g., wallet 2, and protocol network node 3) might include functionality that validates each transaction request, as well as each block of the blockchain and transactions in those blocks.

A node may perform some or all of the steps 3a to 3g in FIG. 1A. For example, some of the nodes can be considered “miner” nodes that can carry out step 3c in FIG. 1A. Such miner nodes can aggregate transaction requests and create the blocks (e.g., FIG. 1D, blocks A, B, and C) of transactions so that a new block can be added to the blockchain 7. A miner node might perform some operations that easily verified by other authorized nodes. Such operations can be intentionally both complex (to avoid non-authorized nodes from easily creating improper blocks) and dependent on the data of the included transactions (so that a non-authorized node cannot perform the complex operation ahead of time). Multiple miner nodes can possibly compete to perform the necessary work in creating the new block, which is referred to as a “proof-of-work” mining. Alternatively, the miner node for the new block can be selected based on its wealth or stake in the network (referred to as a “proof-of-stake work” mining or forging). Such selection may be made in a deterministic manner. After mining the new block, the miner node disseminates the new block to other nodes, which validate the new block and transactions embedded therein. If the other nodes succeed in validating the new node, the mining node adds the new block to the blockchain and propagates the new block to other nodes, thereby committing the new block to the blockchain 7. Once committed to the blockchain, the transaction is immutable and cannot be deleted, although the transaction may be modified or reversed by a subsequent transaction.

FIG. 1D shows a schematic illustration of the blockchain 7. In embodiments, valid blocks are added to the blockchain 7 by a consensus of the protocol network nodes 3 in the network 1. The blockchain 7 may include an ordered list of validated blocks A, B, and C, each of which groups together multiple transactions. Each block A, B, and C is labeled with a timestamp and a “fingerprint” of a respective previous block. The fingerprint may be a hash of the previous block. Thus, block B may include a timestamp and a hash of block A, which preceded block B in time in the blockchain. In this manner, blocks A and B become linked forming the chain. Additionally, each block includes information (e.g., transaction identifiers) that associates the block with the group of transactions in the block. As shown in FIG. 1D, for example, block B includes a block header “B0” that refers to a group of transactions for block B. Block B also includes transaction identifiers B0(1), B0(2), B0(3), B0(4), B0(5), and B0(6) that are referenced by the block header B0. Each transaction can include one of the transactions of an account holder to add or update data stored account profile data on the blockchain 7. It will be noted that the aforementioned sidechain may have the structure of the blockchain 7 described herein.

In addition to transactions from account holders adding and/or updating data on the distributed ledger (e.g., blockchain), additional transactions can be requested from retriever nodes on behalf of themselves or at the direction of end-users or at the direction of account holders. As shown in FIG. 1A, the retrievers can issue requests to access public and/or private data stored on the distributed ledger (e.g., blockchain) and can decrypt private data if they have been given the account holder's private encryption key in a separate transaction between the account holder and the retriever.

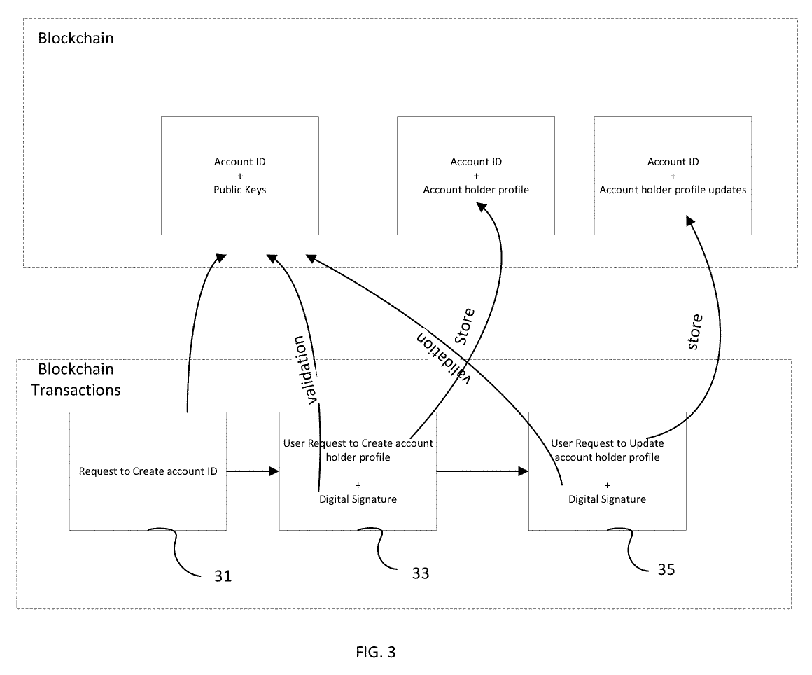

FIG. 3 shows some steps an account holder may take in interacting with the network 1. In step 31, a new user interacts with a wallet to register with the network, which can involve the new user using a wallet and specifying a username and authentication mechanism such as password or other form of authentication (e.g., fingerprint, voice and/or facial verification on a mobile device or two-factor authentication methods). The wallet may then perform the account creation steps 21, 23, and 25 shown in FIG. 2. The generated key pairs in step 25 can then be stored in the wallet, for example, for later use to generate digital signatures. Also, the generated public keys are stored on the blockchain.

In step 33, a registered account holder, either through the wallet, or directly using the network protocol, generates an embedded transaction request to create a profile with some or all of the structured data discussed herein. The transaction request includes the profile data to be stored on the blockchain. Also, the transaction request is signed with the account holder's private key to generate a digital signature of the account holder. The digital signature is embedded into the transaction request. The request is submitted to the protocol network nodes 3 for validation in accordance with the protocol or set of rules for the network.

The protocol network nodes 3 receive the embedded transaction request with the digital signature. The protocol network nodes 3 search for account holder's public keys stored on the blockchain 7 from the previous recorded transaction at step 31. The embedded digital signature acts as a lock which can be unlocked by the correct public key of the account holder. The protocol network nodes 3 verify that the account holder's public key corresponds to the digital signature embedded in the current transaction request in step 33. If the public key “unlocks” the signature the protocol network nodes 3 validate the transaction, the profile data is committed to the blockchain and becomes associated with the account ID of the account holder for future reference.

Moreover, since each “account” data structure of the account holder's profile includes a “signal weight” data element and a “recommendation weight” data element, the creation of the account holder's profile necessarily involves weights, thereby requiring the determination of the weights as discussed above in connection with FIG. 1A. Since the account is newly created, the protocol may be configured to initialize the weights to default values for the total recommendation weight and signal weight of the account holder. For example, in one embodiment, the default value for the total recommendation weight and signal weight of the new account holder can be zero, and once the user is verified by another account holder, the total recommendation weight of the account holder can be adjusted to another predefined value, such as a value of 100.

At step 35, a registered account holder, using the wallet, generates an embedded request to update a portion or all their profile data. The request is signed with the digital signature of the account holder, and the signature is embedded in the request along with the profile data to be updated on the blockchain. The request is validated by comparing the digital signature embedded in the request against the public keys stored initially in the blockchain location at the time of account creation, and, upon validation of the request, the updated profile data is committed to the blockchain and is associated with the account ID of the account holder for future reference.

As noted above, when submitting a request for an existing account holder's account, the wallet ensures that the request is embedded with a digital signature signed with the private management key of the account. Then, the protocol network nodes re-validate the request by using the public management key of the account available in the distributed ledger and add or update the distributed ledger.

The following are example requests/commands issued by a wallet on receiving another biographic information related request from an account holder:
Updates an account via Manage.UpdateAccount(AccountID)
Updates a bio via Manage.UpdateBio(BioID)
Creates an organization via Put.AddOrganization
Creates an experience via Put.AddExperience
Updates an experience via Manage.UpdateExperience(ExperienceID)
Trashes an experience via Manage.TrashExperience
Creates a strength/skill via Put.AddStrengthSkill
Updates a strength/skill via Manage.UpdateStrengthSkill(StrengthSkillID)
Trashes a strength/skill via Manage. TrashStrengthSkill(StrengthSkillID)
Creates an interest via Put.AddInterest
Updates an interest via Manage.UpdateInterest(InterestID)
Trashes an interest via Manage.Trashlnterest(InterestID)

The following are example requests/commands issued by a wallet on receiving a recommendation-related request from an account holder:
Creates a recommendation via Put.Recommendation
Updates longevity of the affiliation between the recommender and the recommended via Manage.ExtendRecommendationLongevity(RecommendationID)
Adds new strengths/skills to the recommendation via Manage.AddStrengthsSkillsToRecommendation(RecommendationID)
Retracts a recommendation via Manage.RetractRecommendation(RecommendationID)

The following are example requests/commands issued by a wallet on receiving a verification-related request from an account holder:
Creates a verification via Put.Verification
Retracts a verification via Manage.RetractVerification(VerificationID)

The following are example requests/commands issued by a wallet on receiving a signal-related request from an account holder:
Creates a signal (including setting the signal strength attribute of the signal) based on the user input via Put. Signal
Updates the signal strength attribute of the signal based on the user input via Manage. StrengthenSignal(SignalID)
Retracts a signal based on user input via Manage.RetractSignal(SignalID)

The following are example requests/commands issued by a wallet on receiving a connection-related request from an account holder:
Creates a connection request via Put.ConnectionRequest
Accepts a connection request via Manage. AcceptConnectionRequest(ConnectionID)
Trashes a connection request via Manage. TrashConnectionRequest(ConnectionRequestID)
Trashes a connection via Manage.TrashConnection(ConnectionID)

The following are example actions taken by protocol network nodes on receiving a request to create biographic data structure from a wallet:
If provided, validates that the requested username is not in use by another account holder. Otherwise, it creates a new username dynamically.
Adds the biographic data to the distributed ledger including its username and public keys.

The following are example actions taken by protocol network nodes on receiving a request to create an organization data structure from a wallet:
Adds the organization to the distributed ledger

The following are example actions taken by protocol network nodes on receiving a request to create a strength/skill from a wallet:
Adds the strength/skill to the distributed ledger

The following are example actions taken by protocol network nodes on receiving subsequent requests from a wallet. In general, protocol network nodes can validate the digital signature provided by the wallet by using the public management key of the person's account, and:
On receiving a request to modify an experience, strength/skill, interest, and other biographic attributes:
   Adds the new values to the distributed ledger.
On receiving a request to trash an experience, strength/skill, interest, and other biographic attributes:
   Adds a trash transaction to the distributed ledger pointing to the original (but now trashed) data element.
On receiving a request to create a recommendation:
   Adds a recommendation to the distributed ledger
   Runs the recommendation weight algorithm
On receiving a request to update the longevity of the affiliation between the recommender and the recommended:
   Verifies that the new longevity is greater than the current one
   Adds a recommendation update to the distributed ledger including a pointer to the original recommendation.
   Runs the recommendation weight algorithm
On receiving a request to add new strengths/skills to a recommendation:
   Adds a recommendation update to the distributed ledger including a pointer to the original recommendation.
   Runs the recommendation weight algorithm
On receiving a request to retract a recommendation:
   Adds a recommendation retraction to the distributed ledger including a pointer to the original (but now retracted) recommendation
   Runs the recommendation weight algorithm
On running the recommendation weight algorithm:
   Calculates the recommendation weight for the recently added or modified recommendation
   Calculates the recommendation weight for each strength/skill of the recommendation
   Recalculates the recommendation weight of the receiver
   Recalculates the recommendation weight of all the recommendations given by the receiver
   Continues the cycle certain amount of times as defined in the parameters set by the governance of the network
   Adds the updated recommendation weights to the distributed ledger
On receiving a request to create a verification:
   Adds a verification to the distributed ledger
   If the verification has a recommendation related to it:
      Runs the recommendation weight algorithm
   If the person has received three or more non-retracted verifications by verified persons and is not marked yet as person verified:
      Adds a person verified entry to the distributed ledger
      Runs the signal weight algorithm
      Runs the recommendation weight algorithm
On receiving a request to retract a verification:
   Adds the verification retraction to the distributed ledger including a pointer to the original (but now retracted) verification
   If the retracted verification has a recommendation related to it:
      Runs the recommendation weight algorithm
   If the person has received two or fewer non-retracted verifications by verified persons and is marked as person verified:
      Adds a person no longer verified entry to the distributed ledger
      Runs the signal weight algorithm
      Runs the recommendation weight algorithm
On receiving a request to create a signal (including the associated signal strength attribute):
   Adds a signal (including its associated signal strength attribute) to the distributed ledger
   Runs the signal weight algorithm
On receiving a request to strengthen the signal strength attribute of a signal:
   Verifies that the new signal strength attribute is greater than the current one.
   Adds a signal update (which updates the signal strength attribute of the signal) to the distributed ledger including a pointer to the original signal
   Runs the signal weight algorithm
On receiving a request to retract a signal:
   Verifies that the signal was created more than 364 days ago.
   Adds a signal retracted entry to the distributed ledger including a pointer to the original (but now retracted) signal
On running the signal weight algorithm:
   Calculates the signal weight for the recently added or modified signal
   Recalculates the characteristic signal weight of the signalee
   Recalculates the signal weight of all the signals given by the signalee using the recalculated characteristic signal weight of the signalee
   Continues the cycle certain amount of times as defined in the parameters set by the governance of the network
   Adds the updated signal weights and characteristic signal weights to the distributed ledger
On receiving a connection request:
   Adds the connection to the distributed ledger
   If the request includes a connection key, validates it and mark the connection as accepted right away
On receiving a request to accept a connection:
   Adds the connection acceptance to the distributed ledger
On receiving a request to trash a connection:
   Adds a trash transaction to the distributed ledger pointing to the original (but now trashed) connection.

Once an account holder's profile data is stored on the distributed ledger (e.g., blockchain), the public data and private data can be retrieved by any participant of the network, and the private data can be decrypted by any party who the account holder authorizes through sharing of the account holder's private encryption keys. One important retrieval process is a request from an account holder to be able to view a snapshot of their profile data, such as in a GUI format similar to an online social network profile webpage.

In one example, an account holder, using a wallet, can generate a plurality of requests to retrieve all of the transactions associated with the account holder's account ID. In addition, the account holder accesses all of the blockchain blocks corresponding to the retrieved transactions. The wallet can then validate all of the accessed blocks and transactions associated with the account ID of the account holder. In validating the transactions, the wallet checks the signature of the transaction against the account holder's public key stored in the wallet. After validating the blocks and the transactions, the wallet may extract the user profile data from the transactions, which may include decrypting any private profile data using the private encryption keys of the account holder stored in the wallet. The wallet may use time stamp information from each transaction to arrange the extracted profile data in chronological order. The wallet can then display profile data to the user at a preselected account time (i.e., the time of the data request) or any account time selected by the user. An example of a display of a portion of an account holder's profile is shown in FIG. 4. It is expected that the account holder may wish to be able to see the most recent profile data as a “snapshot” of the most relevant account time for an account holder. However, the account holder can view snapshots of their profile at any time, to thereby see changes to the account over time. For example, an account holder may be able to determine when a connection to another account holder ended or began by analyzing changes in their profile data.

It will be appreciated that any participant of the network (such as retrievers, and end-users) can create a snapshot of any account holder's profile data in the same manner as described above for one account holder retrieving his or her own profile data. Of course, any participant wishing to view private data would have to have access to the respective private keys of the respective account holder to decrypt the private data.

In another example, a retriever node, which may be a “job board” as shown in FIG. 1A, may be a service used by an account holder or an end-user (e.g., a recruiter). In this case, the account holder may create an account with the retriever so that the account holder can grant the retriever node access to the account holder's private encryption keys so that the retriever can access and decrypt the user's private data for sharing with an end-user recruiter, for example.

Thus, the network enables account holders to build and use anywhere their profile, which includes verifications, weighted recommendations, and weighted signals. As described above, account holders can authorize retrievers (which may be applications, such as job boards and online marketplaces) to access and extract account holder to and from the blockchain. The retrievers, in turn, can use this data to improve, automate, and speed up processes such as job matching (full-time, gigs, freelancing), recruiting, lead scoring, career advice, and professional networking. The network may enable new functionalities, such as recommendations for short interaction (for example, recommend a barista, etc.), new ways of searching for vendors (for example, find a nearby coffee shop with the best baristas, etc.), and new ways of networking, which may in-turn help increase socioeconomic and job mobility, enable permission-less innovation, allow people to remain in control of their reputation, and make work fulfilling for all.

The decentralized network described hereinabove employs dynamics that create value and attract participants to the network. To increase positive network effects and reduce friction to a minimum, in at least one embodiment, it is important for account holders (wallets), and retrievers to be able to use the network for free, while simultaneously providing significant incentives to the account holders to add data to the network, to the protocol network nodes to host the protocol and its distributed ledger, and the retrievers to use the data. In some embodiments, account holders and other users of the network 1 may have to provide payment to the network 1, such as, for example, to add or update their profile data.

The network may use tokens as a means to grant rights to manage the network, i.e., voting for nodes, network parameter changes, etc. The tokens are issued to reward the various nodes for using their resources (e.g., for mining the blocks of the blockchain and hosting the blockchain). Tokens can be transferred and exchanged for value (e.g., money).

With the goal of keeping the network free of abuse and manipulation, recommendations, verifications, or signals cannot be purchased or sold. The primary reason for account holders to use the network should be intrinsic and not extrinsic.

Individual account holders are motivated to use the network as a) they remain in control of their reputation, b) they can port it to apps and services connected to the network, and c) they have the potential of increasing their socioeconomic and job mobility. Also, as noted above, the network is free to use for account holders.

Wallets are motivated because having their apps and services pushing and pulling data to and from the blockchain is one of their selling points for account holders. As network effects grow exponential, so does this incentive.

Protocol network nodes are motivated extrinsically by getting paid with tokens for their computational and bookkeeping services. To keep the service free for all other participants of the network, new tokens are automatically created by the network to pay the protocol network nodes. The rate at which new tokens are created may be determined by the governance of the network protocol.

Retrievers are motivated both intrinsically and extrinsically. Retrievers are intrinsically motivated to use the network, because having their apps and services pulling and publishing data from the network is one of the benefits that their users experience. Retrievers are extrinsically motivated, because a) collecting an account holder's data would have otherwise been significantly expensive or practically impossible for the retriever, and b) the retriever may, in turn, make this data accessible to others for free or for a fee.

To speed up the adoption of the network, temporary extrinsic incentives, such as tokens, can be given to account holders, wallets, protocol network nodes, and retrievers early on.

Wallets and retrievers may be motivated to hold tokens as they grant rights to manage the network, which their respective businesses may depend on. The market cap of the token may be influenced by the value being created by the network and its participants.

Ownership and management of the network may be evenly split between token holders and the account holders using the network. Decisions are made through voting in the network. For the half corresponding to token holders, voting weight is directly proportional to the percentage of tokens owned by the holder. For the half corresponding to account holders using the network, voting weight is directly proportional to the added recommendation weight and signal weight of each person compared to the total added recommendation weight and signal weight in the network. This approach attempts to give more voting weight to persons that have committed more time and energy to building their reputation in the network.

To keep the service free for persons, storers, and retrievers, new tokens are automatically created by the network to reward protocol network nodes for their computational and bookkeeping services. The reward (R) paid for each transaction (t) is determined by the type of request, a global variable set by the governance of the network, and the quality score of the wallet that made the request:

Rₜ=UₐVQₛ Eqn. (6)

In this equation, Rt is the reward the node earns for a given transaction measured in tokens. a is the type of transaction. For example, creating an account holder profile, adding a recommendation, retracting a signal, accepting a contact request, etc. Uₐ is the median number of computing units estimated to be used by the type of transaction. Some transactions are expected to use significantly more computing resources than others. For example, adding a contact request is much simpler than adding a recommendation, as the latter is likely to trigger the recalculation of the recommendation weights of multiple recommendations and account holders. The number of units for each type of transaction can be adjusted by the governance of the network. V is a variable set by the governance of the network. It is meant to be used to control the number of protocol network nodes in the network and the speed at which requests are processed. Increasing V increases the rewards received by the protocol network nodes, thus attracting more protocol network nodes and making the network faster (by reducing the time of processing transaction requests). Decreasing V discourages protocol network nodes from participating and makes the network slower. Given that nodes are rewarded by tokens created on-demand, increasing V speeds up the dilution of tokens, while decreasing it slows down dilution of tokens. s is the storer making the request. Qs is the quality score of the wallet making the request. It is meant to encourage protocol network nodes to prioritize requests submitted by wallets with a good reputation and deprioritize or block requests submitted by wallets with a poor reputation. The quality score for each wallet is dynamically set with votes following the governance of the network. The network protocol can dynamically limit the number of requests for new wallets and subsequently relax that number as their quality score increases.

When building or selecting a distributed ledger framework for implementing the network protocol described herein, the following factors may be relevant:
The computing power required to calculate recommendation weights and signal weights;
The ability for nodes to be paid by the protocol itself instead of the wallets that add data to the distributed ledger; and
The liquidity that the token may need.

Popular proof-of-work frameworks, such as Ethereum, provide relative liquidity to tokens built on top of them. However, such proof-of-work frameworks are impractically costly for complex computation, such as the one needed to calculate recommendation weights and signal weights described herein. Frameworks using proof-of-stake and delegated-Byzantine-fault-tolerance paradigms may be a better match for complex computation, such as the one needed to calculate recommendation weights and signal weights described herein. Examples of these frameworks include Neo, Qtum, and Dispatch. Unfortunately, they are designed so that the users requesting additions to the distributed ledger (i.e., the wallets in the case of the present disclosure) are the ones paying the protocol network nodes. In contrast, in the network protocol described herein, protocol network nodes are paid by the network by issuing new tokens.

Several mechanisms have been described above with respect to recommendations, verifications, signals, connections, and incentives with the intent to keep the network free of abuse and manipulation.

In embodiments, recommendations and associated recommendation weights are public. Also, recommendations can be publicly retracted, but they cannot be deleted in view of the immutability of the blockchain. The only attribute of a recommendation that can be changed is the longevity of the affiliation between the recommender and the recommended; i.e., it can be made longer but it can't be shortened. All data required to independently verify recommendation weights is public, and the recommendation-weight algorithm seeds the system only through verified persons.

With regard to verifications, they are public, as well as the verifier and the verified account holders are public. Moreover, the verification can be publicly retracted, though they cannot be deleted in view of the immutability of the blockchain. Moreover, account holders are only verified after multiple, already-verified other account holders have verified at least one experience with the respective account holder.

With regard to connections, to guard against abuse and mere solicitation, the number of yet-to-be-accepted (i.e., pending) connection requests sent by each account holder can be limited.

With regard to incentives, to guard against abuse, recommendations, verifications, or signals cannot be purchased or sold through the network. Moreover, account holders, wallets, and receivers are motivated intrinsically; i.e., they do not receive payment in tokens for transacting in the network.

The wallet (or wallet service) may be a dedicated application for use with the network. The following embodiment describes such an application and its use with the blockchain enabled network described hereinabove.

In FIG. 5, at step 101 a party interacts with the wallet to request the creation of a new account on the network. The wallet may ask the party to specify an account name, as well as authentication information for the party to be authenticated to the wallet. In step 103, the network, via the protocol network nodes 3 described hereinabove, create the account and initialize data of the account holder's profile with default values for weighted data, such as recommendations. In step 105, an account holder interacts with the wallet to sign in to the wallet. The wallet will then interact with the protocol network nodes using the account name and authentication mechanism (public and private key authentication) specified by the account holder in the registration step 101, and the operations continue to steps 107 to 115.

In step 107, the account holder interacts with the wallet to build, update and/or review the profile of the account holder with a description of one or more experiences of the account holder. The wallet can display the current value of the total recommendation weight and signal weight of the account holder and optionally value(s) of one or more per-experience recommendation weight(s) as part of the display of the profile of the account holder.

In step 109, the account holder optionally interacts with the wallet to generate a link for other account holders (“verifiers”) to verify at least one experience of the account holder. The wallet and/or account holder can distribute the link to other account holders.

In step 111, the account holder optionally interacts with the wallet to view the profile of other account holders(s).

In step 113, the account holder optionally activates a link and interacts with the wallet to verify at least one experience of one other account holder. The wallet can determine if the verification succeeds. If so, the account holder is connected to the one other account holder and can optionally interact with the wallet to act as a verifier to submit a recommendation of the one other account holder at the discretion of the account holder.

In alternate embodiments, steps 109 to 113 can be adapted to use a link or other interface to enable the account holder to interact with the wallet to act as a recommender to submit a recommendation of the one other account holder at the discretion of the account holder.

In step 115, the wallet determines if the account holder has logged off (or otherwise terminated its session with the wallet). If not, the operations of steps 107 to 115 can continue. If so, the account holder's access is terminated and subsequent access to the wallet (steps 107 to 113) requires another account holder login (step 105).

In step 117, the wallet and network use the recommendations submitted by account holders (“recommenders”) to dynamically update the recommendation weight(s) and the total recommendation weight and optionally per-experience recommendation weight(s) for the account holders of the network. As a result of this process, any update to the recommendation weight(s) and the total recommendation weight and per-experience recommendation weight(s) for a given account holder is reflected in the profile of the given account holder and its display in steps 107 and 111.

Note that although the operations of steps 101 to 115 are described for a single account holder, these operations can be performed by multiple account holders of the network whereby the multiple account holders access the network (e.g., via respective wallets) in a sequential manner or in parallel with one another. Also, other potential actions can be provided by the wallet in conjunction with an account holder's access to the network. For example, the wallet can possibly provide messaging or other forms of communication between account holders and presentation of advertisements to account holders.

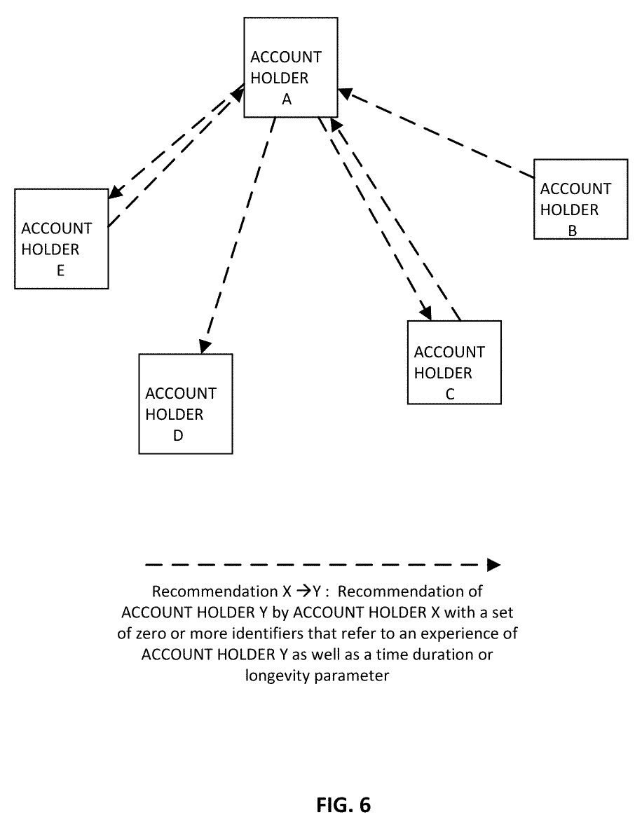

In order to illustrate the present method, consider the graph of FIG. 6, which represents recommendations involving five different account holders (A, B, C, D, E) depicted as nodes in the graph. An arrow with broken line represents a recommendation from one account holder (the recommender) to another account holder (the recommended). The tail end of the broken line interfaces to the recommender and head of the arrow interfaces to the recommended. Each recommendation can be associated with a set of zero or more identifiers each referring to an experience of the recommended as well as a time duration or longevity parameter. The time duration or longevity parameter characterizes the time duration of the relation between the recommender and the recommended for the particular recommendation.

In embodiments, a connection between account holders (for example, a connection between account holder B and account holder A) must be established before one of the account holders (for example, account holder A or account holder B) can submit a recommendation for the other account holder (for example, account holder B or account holder A). This connection can be established by one account holder (for example, account holder B) entering data to verify at least one experience of the other account holder (account holder A). The network can process such data to determine that the verification succeeds. If so, the network can update the profile data of the two account holders (account holder A and account holder B) to record the connection between the two account holder. Once this connection is established, the account holder (account holder B) can submit a recommendation for the other account holder (account holder A) and vice versa. If the verification does not succeed, the connection between the account holders is not established and the account holder (account holder B) cannot submit a recommendation for the other account holder (account holder A) and vice versa.

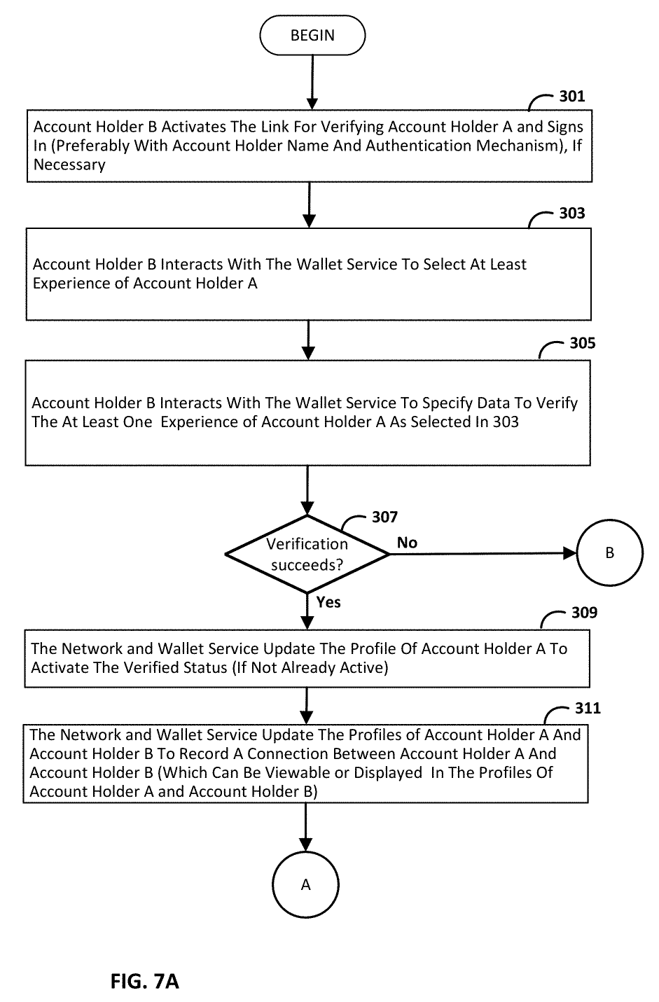

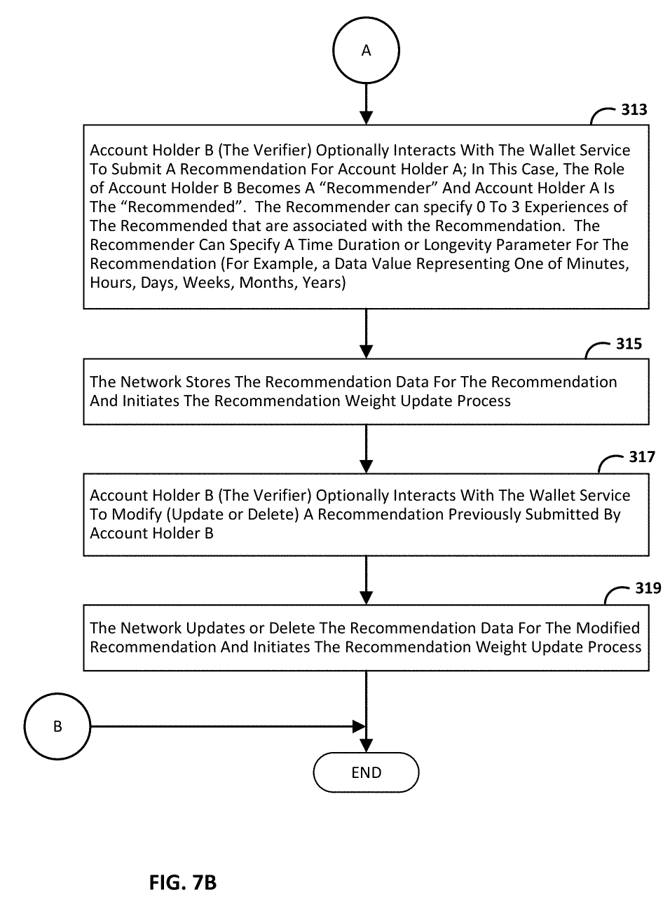

FIGS. 7A and 7B presents a view of a method for establishing a connection between account holders (referred to as account holder B and account holder A) of the network and submitting recommendations pertaining to connected account holder according to one example implementation. In embodiments, the method can be performed as part of step 113 of the method of FIG. 6 carried out by account holder B after account holder A has communicated a link for verifying account holder A to account holder B. The communication of such link can be part of step 109 of the method of FIG. 6 carried out by account holder A.

In step 301, account holder B activates a link for verifying account holder A and signs into the wallet (preferably with a username and authentication mechanism) if necessary.

In step 303, account holder B interacts with the wallet to select at least one experience of account holder A. One or more, which are stored in the profile of account holder A, can be presented in a list (such as a drop-down list) for selection by account holder B.

In step 305, account holder B interacts with the wallet to specify data to verify the at least one experience of account holder A as selected in step 303. For example, the specified data can define or describe the relationship between account holder B and account holder A, the most relevant experience of account holder B for this relationship, the name of the job or position of account holder B at the time of this relationship, and possibly the entity or organization that employed account holder B at the time of this relationship. Some or all of the specified data can possibly be stored in the profile of account holder B and can be presented in one or more lists (such as drop-down lists) for selection by account holder B.

In step 307, the wallet and network can process the data entered by account holder B in step 305 to determine whether the verification succeeds. If so, the operations proceed to steps 309 to 319 to establish the connection between the account holders and allow account holder B to submit (or modify or cancel) a recommendation for the other account holder (account holder A) and vice versa. If not, the operations of steps 309 to 319 are bypassed and the connection between the account holder is not established and the account holder (account holder B) cannot submit (or modify or cancel) a recommendation for the other account holder (account holder A) and vice versa.

In step 309, the wallet and network updates the profile of account holder A to activate a verified status (if not already active). Note that when a verified status of an account holder is not active, the initial value of the total recommendation weight of that account holder can be set to a predefined value, such as 0. However, when the verified status of an account holder is active, the value of the total recommendation weight of that account holder can be updated to another predefined value, such as 100.

In step 311, the wallet and network updates the profiles of account holder A and account holder B to record a connection between account holder A and account holder B (which can be viewable or displayed in the profiles of account holder A and account holder B).

In step 313, account holder B (the verifier) optionally interacts with the wallet to submit a recommendation for account holder A. In this case, the role of account holder B becomes a “recommender” and account holder A is the “recommended.” The recommender (account holder B) can specify a set of 0 to 3 strengths (or possibly other experiences) of the recommended (account holder A) that are associated with recommendation. The set of strengths (or other experiences) of the recommended as specified by the recommender are preferably demonstrated by the recommended during the relationship between the recommender and the recommender and can provide a basis for the recommendation. The recommender (account holder B) can also specify a time duration or longevity parameter for the recommendation (for example, a data value representing one of minutes, hours, days, weeks, months, years). This time duration or longevity parameter as specified by the recommender preferably characterize the time duration of the relationship between the recommender and the recommender and can provide a further basis for the recommendation. Such time duration can be used to determine the longevity factor for the recommendation that is used as part of the recommendation weight update process as described herein.

In step 315, the network stores the recommendation data for the recommendation submitted by the recommender (account holder B) in step 313 and initiates the recommendation weight update process (step 117 of FIG. 5).

In step 317, account holder B (the verifier) optionally interacts with the wallet to modify (e.g., update or delete) a recommendation previously submitted by account holder B. For example, recommender (account holder B) can update the set of 0 to 3 experiences of the recommended that are associated with recommendation. The recommender (account holder B) can also update the time duration or longevity parameter for the recommendation (can lengthen but not shorten). In another example, the recommender (account holder B) can retract the recommendation.

In step 319, the network updates (or deletes) the recommendation data for the recommendation modified in step 317 and initiates the recommendation weight update process (step 117 of FIG. 5).

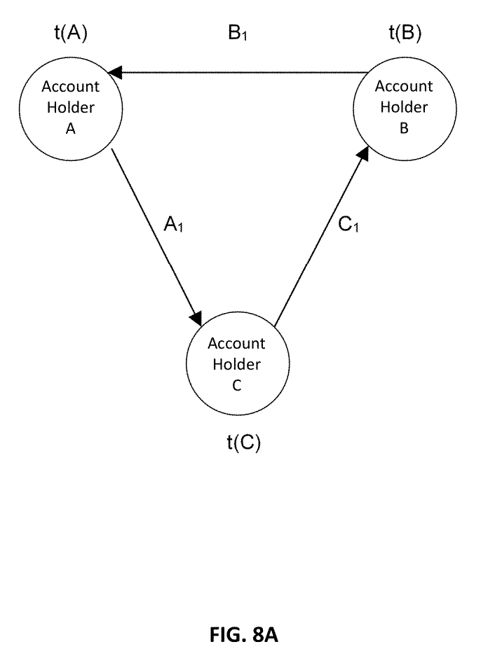

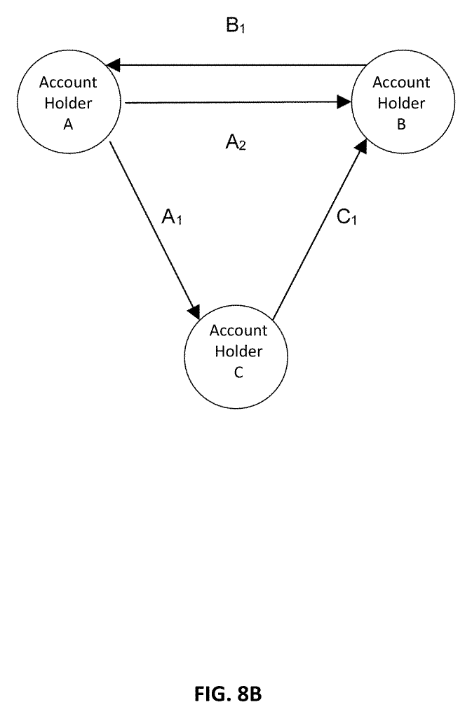

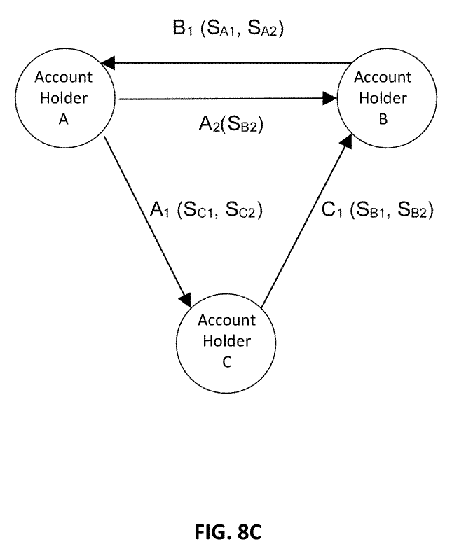

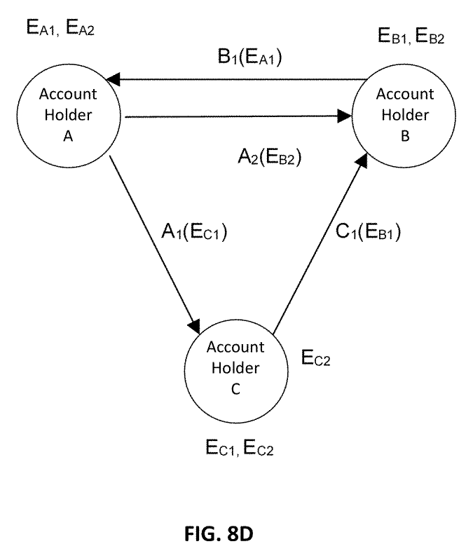

FIGS. 8A-8E are graphs that illustrate an exemplary recommendation weight update process. In embodiments, the process can be performed as part of step 117 of the method of FIG. 6 or step 319 of the method of FIGS. 7A and 7B. The process can be represented as a graph of nodes, where each node represents an account holder and the arrow connections between them are the recommendations that one account holder (the recommender) has provided to another account holder (the recommended).

FIG. 8A shows a scenario involving three account holders (account holder A, account holder B and account holder C) that have recommendations between them. Account holder A has recommended account holder C (recommendation A₁). Account holder B has recommended account holder A (recommendation B₁). Account holder C has recommended account holder B (recommendation C₁). The total recommendation weights of account holder A, account holder B and account holder C, are t(A), t(B) and t(C), respectively.

As described above, the total recommendation weight of a particular account holder is calculated from the sum of all the recommendations weights for the recommendations that the particular account holder has received. Thus, for any given account holder Y (or node) of the graph assuming that account holder Y is recommended by a number of other account holder (denoted X1 . . . Xn), the total recommendation weight t(Y) is given as:

t(Y)=β(wᵣ(X1,Y)+ . . . wᵣ(Xn,Y)) Eqn. (7)
where β is a damping factor constant in the interval [0,1], which limits the extent in which the account holder Y's total recommendation weight will be inherited by its recommendations; and
the sum (wᵣ(X1, Y)+ . . . wᵣ (Xn, Y) represents the sum of all the recommendations weights for the recommendations that the given account holder Y has received.

Furthermore, the recommendation weight wᵣ(X1, Y) given by account holder X1 for account holder Y is given by:

$${w}_{r} ( X 1 , Y ) = \frac{t ( X 1 ) {L}_{X 1 , Y} {F}_{X 1 , Y}}{{{Σ}_{i = 0}^{n} ( {L}_{i} {F}_{i} )}_{X 1}} \qquad Eqn . ( 8 )$$

where t(X1) is the total recommendation weight of the account holder X1 (recommender);
L_{X1,Y} is a longevity factor that depends on the time duration of the relation between account holder X1 (recommender) and account holder Y (recommended);
F_{X1,Y} is a factor associated with the type of relation between account holder X1 (recommender) and account holder Y (recommended); for most relationship types, the factor is 1. For relationship types where the recommender is a subordinate to the recommended (for example, was led, hired, taught, mentored, or received investment by the recommended), the factor can be a higher value (such as the “golden ratio” of 1.6180339887); and
the summation Σᵢ₌₀ⁿ(LᵢFᵢ)_{X1} corresponds to the total number of recommendations made by the account holder X1 of the given recommendation and specifically adds the multiplication product of the longevity factors and relation type factors for all the recommendations given by the account holder X1 (recommender).
   This same equation (8) can be used to determine the recommendation weights wᵣ(X2, Y) . . . wᵣ(Xn, Y) for all of the other account holders that recommend the account holder Y. This means that not all the recommendations from a given account holder are going to be weighted equally, as the total weight of the recommender is distributed proportionally depending on the longevity and type of the relations.

In the graph of FIG. 8A, consider a value of damping factor β equal to one (1) and the initial total recommendation weight of each account holder (node) given as:

t(B)=t(C)=t(A) Eqn. (9)

In embodiments, the initial state of the total recommendation weight of an account holder is 0 if the account holder has not been verified, and 100 if the account holder has been verified.

In FIG. 8B, account holder A has submitted a new recommendation for account holder B (recommendation A₂). Thus, the total recommendation weight t(B) for account holder B is given by Eqn. (1) as:

$$\begin{matrix}t ( B ) = β ( {w}_{r} ( A , B ) + {w}_{r} ( C , B ) ) & Eqn . ( 10 a ) \\ = 1 ( {w}_{r} ( A , B ) + {w}_{r} ( C , B ) ) & Eqn . ( 10 b ) \\ = {w}_{r} ( A , B ) + {w}_{r} ( C , B ) & Eqn . ( 10 c )\end{matrix}$$

wᵣ(A, B) is given by Eqn. (8) as:

$$\begin{matrix}{w}_{r} ( A , B ) = \frac{t ( A ) {L}_{A , B} {F}_{A , B}}{{{Σ}_{i = 0}^{n} ( {L}_{i} {F}_{i} )}_{A}} & Eqn . ( 11 a ) \\ = \frac{t ( A ) {L}_{A , B} {F}_{A , B}}{{L}_{A , B} {F}_{A , B} + {L}_{A , C} {F}_{A , C}} & Eqn . ( 11 b )\end{matrix}$$

And wᵣ(C, B) is given by Eqn. (8) as:

$$\begin{matrix}{w}_{r} ( C , B ) = \frac{t ( C ) {L}_{C , B} {F}_{C , B}}{{{Σ}_{i = 0}^{n} ( {L}_{i} {F}_{i} )}_{AC}} & Eqn . ( 12 a ) \\ = \frac{t ( C ) {L}_{C , B} {F}_{C , B}}{{L}_{C , B} F {,}_{CB}} & Eqn . ( 12 b ) \\ = t ( C ) & Eqn . ( 12 c )\end{matrix}$$

Combining Eqns. 10(c), 11(b) and 12(c) gives:

$$t ( B ) = \frac{t ( A ) {L}_{A , B} {F}_{A , B}}{{L}_{A , B} {F}_{A , B} + {L}_{A , C} {F}_{A , C}} + t ( C ) \qquad Eqn . ( 13 )$$

Similarly, the total recommendation weight t(A) for account holder A is given by Eqn. (1) as:

$$\begin{matrix}t ( A ) = β {w}_{r} ( B , A ) & Eqn . ( 14 a ) \\ = 1 {w}_{r} ( B , A ) ) & Eqn . ( 14 b ) \\ = {w}_{r} ( B , A ) & Eqn . ( 14 c )\end{matrix}$$

wᵣ(B, A) is given by Eqn. (8) as:

$$\begin{matrix}{w}_{r} ( B , A ) = \frac{t ( B ) {L}_{B , A} {F}_{B , A}}{{{Σ}_{i = 0}^{n} ( {L}_{i} {F}_{i} )}_{B}} & Eqn . ( 15 a ) \\ = \frac{t ( B ) {L}_{B , A} {F}_{B , A}}{{L}_{B , A} {F}_{B , A}} & Eqn . ( 15 b ) \\ = t ( B ) & Eqn . ( 15 c )\end{matrix}$$

Combining Eqns. 14(c) and 15(c) gives:

t(A)=t(B) Eqn. (16)

Similarly, the total recommendation weight t(C) for account holder C is given by Eqn. (7) as:

$$\begin{matrix}t ( C ) = β {w}_{r} ( A , C ) & Eqn . ( 17 a ) \\ = 1 {w}_{r} ( A , C ) ) & Eqn . ( 17 b ) \\ = {w}_{r} ( A , C ) & Eqn . ( 17 c )\end{matrix}$$

wᵣ(A, C) is given by Eqn. (8) as:

$$\begin{matrix}{w}_{r} ( A , C ) = \frac{t ( A ) {L}_{A , C} {F}_{A , C}}{{{Σ}_{i = 0}^{n} ( {L}_{i} {F}_{i} )}_{A}} & Eqn . ( 18 a ) \\ = \frac{t ( A ) {L}_{A , C} {F}_{A , C}}{{L}_{A , B} {F}_{A , B} + {L}_{A , C} {F}_{A , C}} & Eqn . ( 18 b )\end{matrix}$$

Combining Eqns. 17(c) and 18(b) gives:

$$t ( C ) = \frac{t ( A ) {L}_{A , C} {F}_{A , C}}{{L}_{A , B} {F}_{A , B} + {L}_{A , C} {F}_{A , C}} \qquad Eqn . ( 19 )$$

Eqns. (13), (16) and (19) represent a series of equations with three unknowns t(A), t(B), t(C) as follows:

$$\begin{matrix}t ( B ) = \frac{t ( A ) {L}_{A , B} {F}_{A , B}}{{L}_{A , B} {F}_{A , B} + {L}_{A , C} {F}_{A , C}} + t ( C ) & Eqn . ( 20 a ) \\ t ( A ) = t ( B ) & Eqn . ( 20 b ) \\ t ( C ) = \frac{t ( A ) {L}_{A , C} {F}_{A , C}}{{L}_{A , B} {F}_{A , B} + {L}_{A , C} {F}_{A , C}} & Eqn . ( 20 c )\end{matrix}$$

The system of equations (20a, 20b, 20c) can be solved by a number of well-known iterative algorithms that makes guesses for the three unknowns t(A), t(B), t(C) and updates the guesses over a finite number of iterations until the results provide sufficient convergence for the three unknowns. With solutions for the three unknowns t(A), t(B), t(C), the recommendation weights for the recommendations of the graph can be determined according to the Eqns. 11(b), 12(c), 15(c) and 18(b). Note that this computational model can readily be extended to represent any number of arbitrary account holders and recommendations between such account holders.

FIG. 8C is a graph that illustrates strengths (or other experiences) of the recommended that are associated with recommendations. In this case, S_{C1} and S_{C2} are two different strengths (or other experiences) of account holder C that are associated with the recommendation A₁ given by account holder A to account holder C. S_{B1} and S_{B2} are two different strengths (or other experiences) of account holder B that are associated with the recommendation C₁ given by account holder C to account holder B. S_{A1} and S_{A2} are two different strengths (or other experiences) of account holder A that are associated with the recommendation B₁ given by account holder B to account holder A. S_{B2} is a strength (or other experiences) of account holder B that is associated with the recommendation A₂ given by account holder A to account holder B. The strength(s) (or other experiences) associated with a given recommendation can be assigned corresponding per-strength (or per-experience) recommendation weight(s) by distributing the recommendation weight of the given recommendation evenly across the strength(s) (or experiences) associated with the given recommendation.

Thus, assuming the recommendation weight for the recommendation C₁ is given as wᵣ(C₁), the per-strength recommendation weights wᵣ(S_{B1}, C₁) and wᵣ (S_{B2}, C₁) for the strengths S_{B1} and S_{B2} of account holder B that are associated with the recommendation C₁ can be equated as:

wᵣ(S_{B1},C₁)=wᵣ(S_{B2},C₁)=wᵣ(C₁)/2. Eqn. (21)

Similarly, assuming the recommendation weight for the recommendation A₂ is given as wᵣ(A₂), the per-strength recommendation weight wᵣ(S_{B2}, A₂) for the strength S_{B2} of account holder B that is associated with the recommendation A₂ can be equated as:

wᵣ(S_{B2},A₂)=wᵣ(A₂). Eqn. (22)

Furthermore, the per-strength (or per-experience) recommendation weight(s) for a given strength (or experience) of an account holder can be summed over the recommendations received by the account holder to calculate a total per-strength (or per-experience) recommendation weight for the given strength (or experience) of the account holder. For example, the per-strength recommendation weights wᵣ(S_{B2}, A₂) and wᵣ(S_{B1}, C₁) for the strength S_{B2} of account holder B for the recommendations A₂ and C₁ received by account holder B can be summed to provide a total per-strength recommendation weight for the strength S_{B2} of account holder B equal to:

[wᵣ(S_{B2},A₂)+wᵣ(S_{B2},C₁)]=[wᵣ(A₂)+wᵣ(C₁)/2]. Eqn. (23)

It is also contemplated that an account holder can specify and store “experience recommendations”, which, as noted hereinabove, is an action where one person (the “recommender”) recommends or endorses a particular experience of another account holder (the “recommended”). FIG. 8D shows a scenario involving three account holders (account holder A, account holder B and account holder C) that have experience recommendations between them. Account holder A has recommended an experience E_{C1} of account holder C (experience recommendation A₁) and has recommended an experience E_{B2} of account holder B (experience recommendation A₂). Account holder B has recommended an experience E_{A1} of account holder A (experience recommendation B₁). Account holder C has recommended an experience E_{B1} of account holder B (experience recommendation C₁).

In this embodiment, the weight update process can calculate a total experience recommendation weight for each account holder (e.g., A, B, C) in a manner similar to the total recommendation weights derived from the account holder-to-account holder recommendations as described herein. In this case, the total experience recommendation weight for each account holder can be calculated from the sum of all the experience recommendation weights for the experience recommendation that the particular account holder has received and possibly a damping factor similar to Eqn. (1) as described above.

Furthermore, the weight update process can calculate weights (or scores) associated with each experience recommendation (e.g., A₁, A₂, B₁, C₁) in a manner similar to the recommendation weights associated with the account holder-to-account holder recommendations as described herein. In this case, the experience recommendation weight for a given experience recommendation can be derived from the total experience recommendation weight of the recommender given experience recommendation, a longevity factor that depends on the time duration of the relation between the recommender and recommended of the given experience recommendation, a factor associated with the type of relation between the recommender and the recommended of the given experience recommendation, and a summation that corresponds to the total number of experience recommendations made by the recommender of the given experience recommendation (preferably adding the multiplication product of the longevity factors and relation type factors for all the experience recommendations given by the recommender of the experience recommendation) similar to Eqn. (8) as described above.

Signal weights can be calculated using equations (4) and (5) and by adapting the methods used for calculating recommendation weights described above for equations 9-23, which can readily be analogized to signal weights.

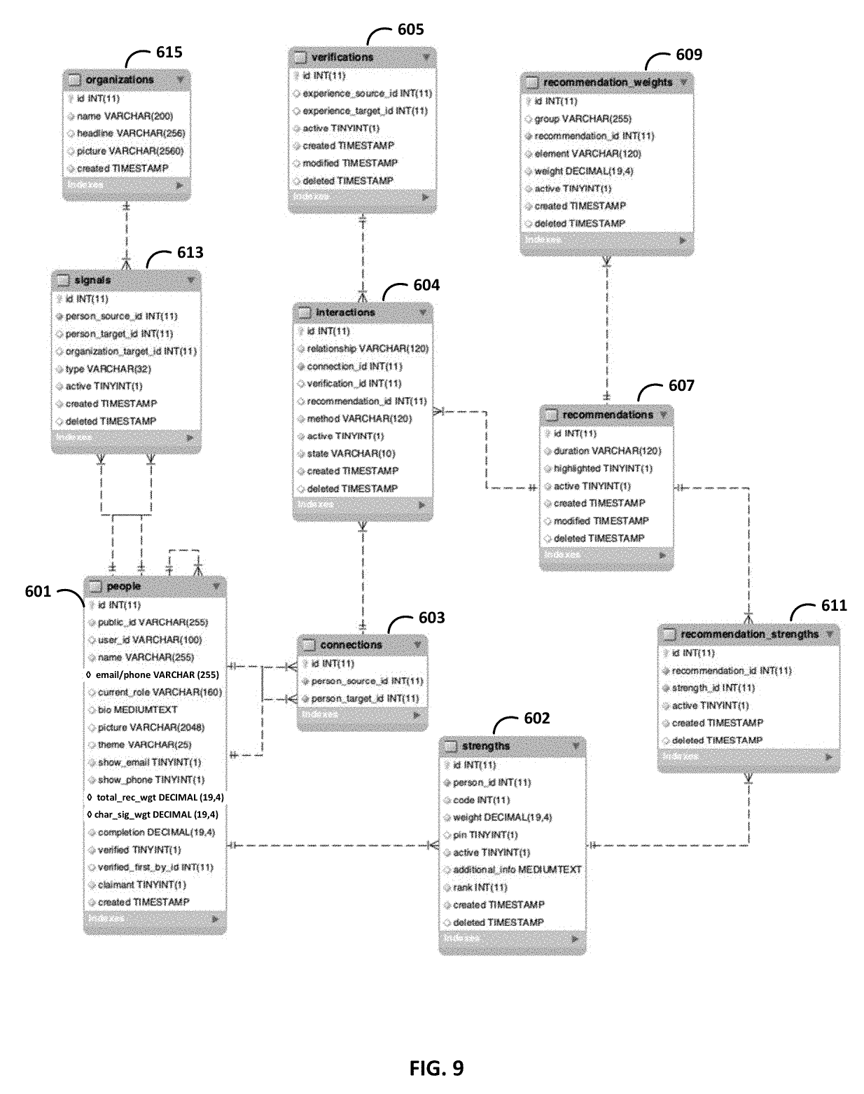

FIG. 9 shows a schema for exemplary data structures maintained by a professional social networking service according to the present disclosure. The data structures include a people table or object 601 for each registered account holder, which includes an “id” field for identifying the registered account holder, a “total_rec_wgt” field that represents the total recommendation weight for the registered account holder, and “a char_sig_wgt” field that represents the characteristic signal weight for the registered account holder, other fields representing biographical information of the registered account holder (such as name, email address, phone number, current role, picture), and a “timestamp” field representing the data and time that the registered account holder was created.

The data structures include an organizations table or object 615 for each registered organization, which includes an “id” field for identifying the registered organization, other fields representing biographical information of the organization (such as name, picture), and a “timestamp” field representing the data and time that the registered organization was created.

The data structures also include a strengths table or object 602 for each strength or other experience of the account holders, which includes an “id” field for identifying the strength or other experience, a “person_id” field that refers or links to the people table or object 601 to specify the account holder to which the strength or other experience belongs, a “weight” field that represents the current value of the per-experience weight for the strength or other experience, an “active” field that represents whether or not the strength or other experience is active, other fields related to the strength or other experience, and “timestamp” fields representing the data and time that the strength was created and deleted (if applicable).

The data structures also include a connections table or object 603 for each connection between account holders, which includes an “id” field for identifying the connection, a “person_source_id” field that refers or links to the people table or object 601 for one account holder (source account holder) of the connection, and a “person_target_id” field that refers or links to the people table or object 601 for the other account holder (target account holder) of the connection.

The data structures also include an interactions table or object 604 that links verifications and recommendations to account holders that are connected to one another by the connections specified in the connections table 603. The interactions table 604 includes an “id” field, a “relationship” field that represents the type of relation between the connected account holders of a verification or recommendation, a “connection_id” field that refers or links to a corresponding connection table or object 603 to specify the connected account holders of a verification or recommendation, a “verification_id” field that refers to or links to a corresponding verification in the verifications table 605, a “recommendation” field that refers to or links to a corresponding recommendation in the recommendations table 607, “method”/“state”/“active” fields that are used to create and manage the associated verifications and recommendations, and “timestamp” fields representing the data and time that the verification was created and deleted (if applicable).

The data structures also include a verification table or object 605 that represents the verification of one account holder (target account holder) by another account holder (source account holder), which includes an “id” field for identifying the verification. This “id” field refers or links to a corresponding interactions table or object 604, which refers or links to a corresponding connection table or object 603 to specify the target account holder and source account holder of the verification. The verification table or object 605 also includes an “experience_source_id” field that refers to or links to an experience of the source account holder that pertains to the verification, an “experience_target_id” field that refers to or links to an experience of the target account holder that pertains to the verification, an “active” field that represents whether or not the verification status of the target account holder is active, and “timestamp” fields representing the data and time that the verification was created and deleted (if applicable).

The data structures also include a recommendations table or object 607 that represents a recommendation given by one account holder (source account holder or recommender) to another account holder (target account holder or recommended), which includes an “id” field for identifying the recommendation. This “id” field refers or links to a corresponding interactions table or object 604, which refers or links to a corresponding connection table or object 603 to specify the source account holder (recommender) and the target account holder (recommended) of the recommendation. The recommendations table or object 607 also includes a “duration” field that represents the longevity of the relation between the target account holder and source account holder upon which the recommendation is based, an “active” field that represents whether or not the recommendation is active, and “timestamp” fields representing the data and time that the recommendation was created and deleted (if applicable).

The data structures also include a recommendations weights table or object 609 that represents the recommendation weight associated with a recommendation, which includes an “id” field for identifying the recommendation weight, a “recommendation_id” field that refers or links to a recommendations table or object 607 for specifying the recommendation that is associated with the recommendation weight, a “weight” field that represents a current value of the recommendation weight, an “active” field that represents whether or not the recommendation weight is active, and “timestamp” fields representing the data and time that the recommendation weight was created and deleted (if applicable).

The data structures also include a recommendations strengths table or object 611 that associates a recommendation and strength of an account holder, which includes an “id” field for identifying the associated table or object, a “recommendation_id” field that refers or links to a recommendations table or object 607 and “a strength_id” field that refers or links to a strength table or object 602 for specifying the associated recommendation and strength of an account holder.

The data structures also include a signals table or object 613 that represents the signals maintained by the system. As described herein, a signal is given by one account holder (“signaler” or source account holder of the signal) to another account holder (“signalee” or target person or organization of the signal). The signals table 613 includes the following items for each signal: a “signal_id” field for identifying the signal, a “person_source_id” field that refers or links to the signaler of the signal, a “person target_id” field that refers or links to a person signalee of the signal, an “organization target_id” field that refers or links to an organization signalee of the signal, a “type” field that specifies the type or strength (e.g., regular or super-strength) of the signal, an “active” field that represents whether or not the signal is active, and “timestamp” fields representing the data and time that the signal was created and deleted (if applicable).

The data structures can also include a signal weights table or object (not shown) that represents the signal weights maintained by the system. As described herein, a signal weight is associated with signal. Similar to the recommendation weights table 609, the signal weights table can include the following items for each signal weight: an “id” field that identifies the signal weight, a “signal_id” field that refers or links to the signal that is associated with the signal weight, a “weight” field that represents a current value of the signal weight, an “active” field that represents whether or not the signal weight is active, and “timestamp” fields representing the data and time that the signal weight was created and deleted (if applicable).

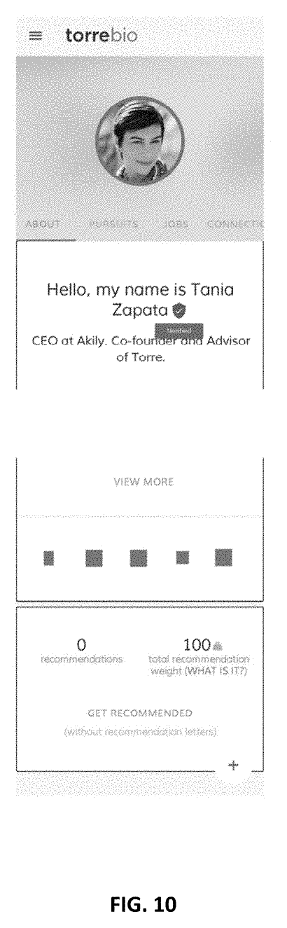

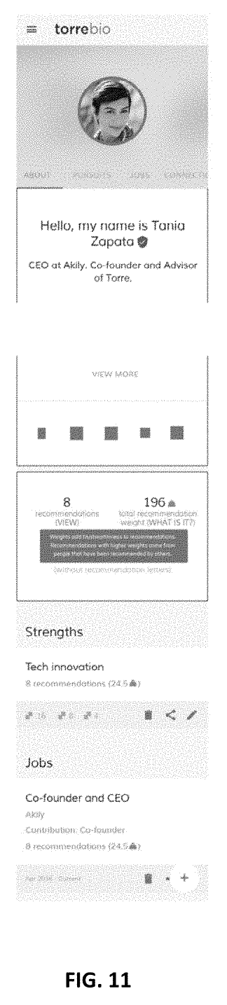

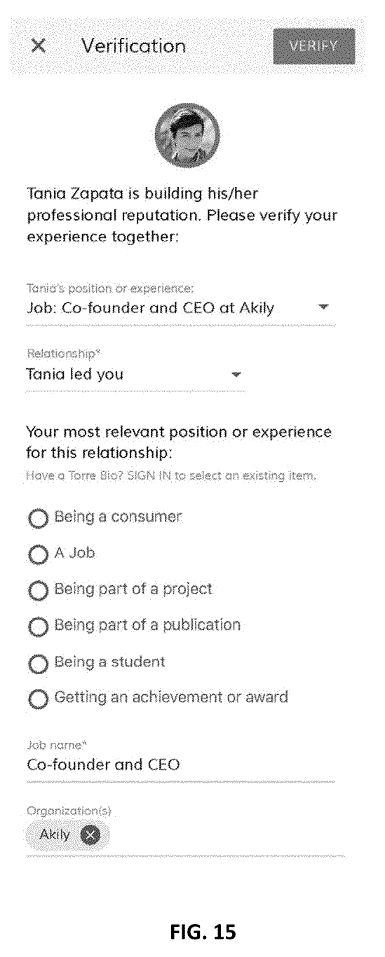

FIGS. 10-19J show display screens of example graphical user interfaces that are presented for display on account holder computer systems and implement operations of the present disclosure. FIG. 10 shows a graphical user interface that can be presented to an account holder upon login (for example, when logging in to the system or wallet). The top part presents the account holder's name, profile picture, and current job title(s) and company name(s). The bottom part presents the number of recommendation received by the account holder and the total recommendation weight of the account holder. The account holder can click on the “VIEW MORE” field to present additional profile information as shown in FIG. 11, which include information relating to strengths or other experience of the account holder with associated per-experience recommendation weights. In this example, the account holder has received 8 recommendations associated with both a “Tech Innovation” experience and a “Co-founder and CEO” job experience.

Furthermore, the system has calculated a per-experience recommendation weight of 24.5 for both the “Tech Innovation” experience and the “Co-founder and CEO” job experience, which is displayed directly under the respective listings of the “Tech Innovation” experience and “Co-founder and CEO” job experience as shown. Note that the graphical user interface also provides buttons or widgets to delete and edit these experiences and share these experiences as shown. The graphical user interface can also display the recommendation weights for the recommendations received by the account holder as part of the display of the account holder's profile. It can also display the recommendations that the account holder has made and associated recommendation weights as part of the display of the account holder's profile.

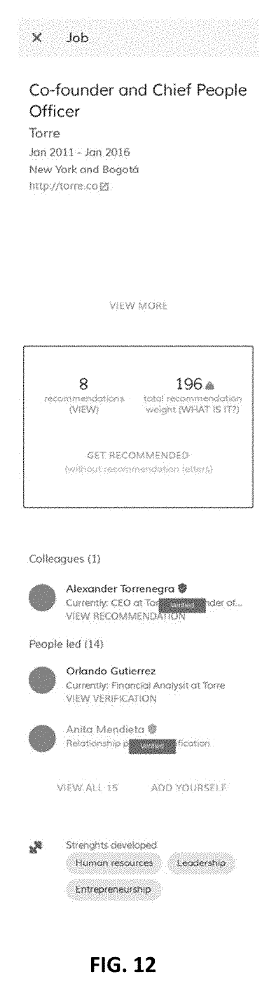

FIG. 12 shows the graphical user interface that can be presented to an account holder in viewing a particular job. It can present the title, company, time frame, and location for the job as shown, along with the ability to edit such information. It can also present the number of recommendation received by the account holder and the total recommendation weight of the account holder. It can also present colleagues of the account holder and people led by the account holder of the account holder, the verification status of such account holders, and widgets to view verifications or recommendations pertaining to these account holders. It can also present a list of strengths or other experiences of the account holder that is associated with the job as shown.

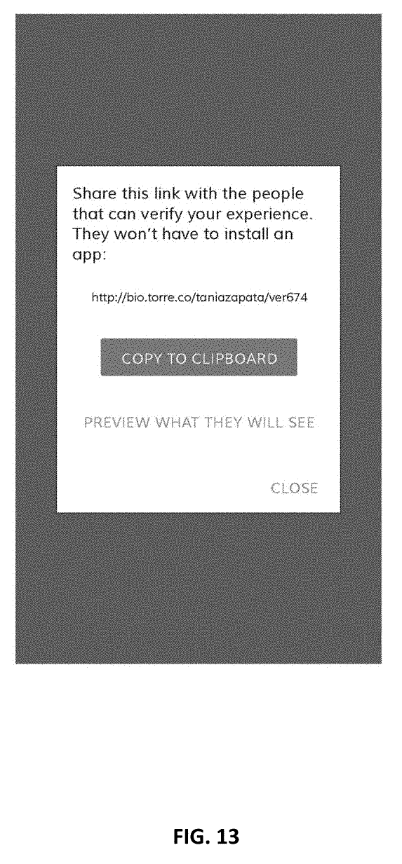

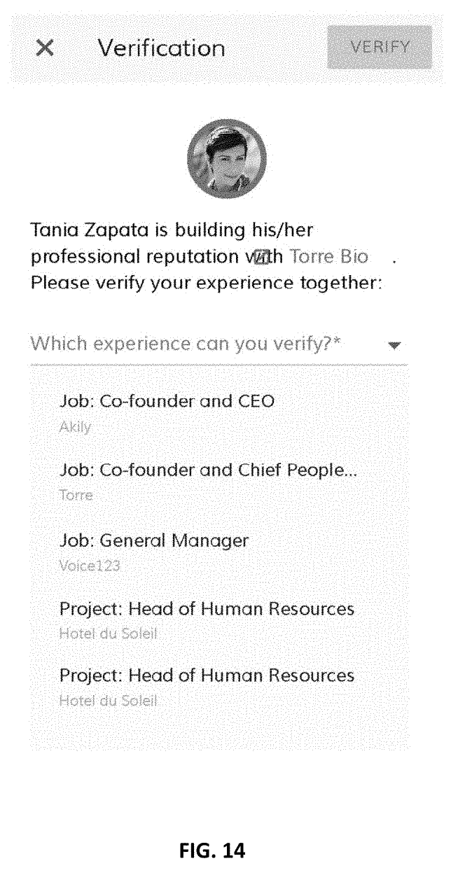

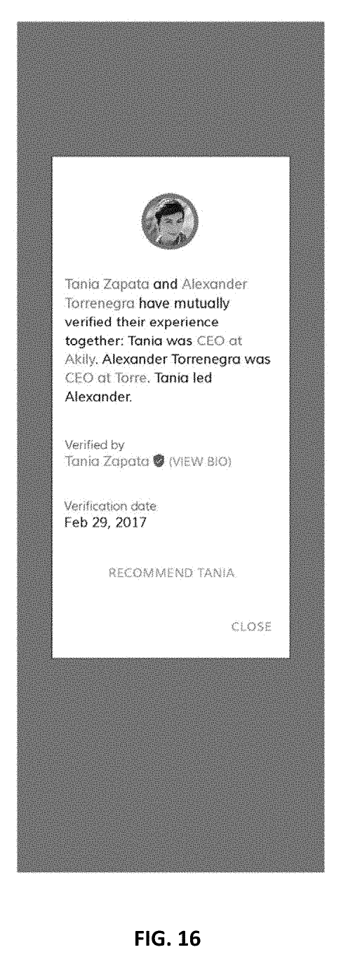

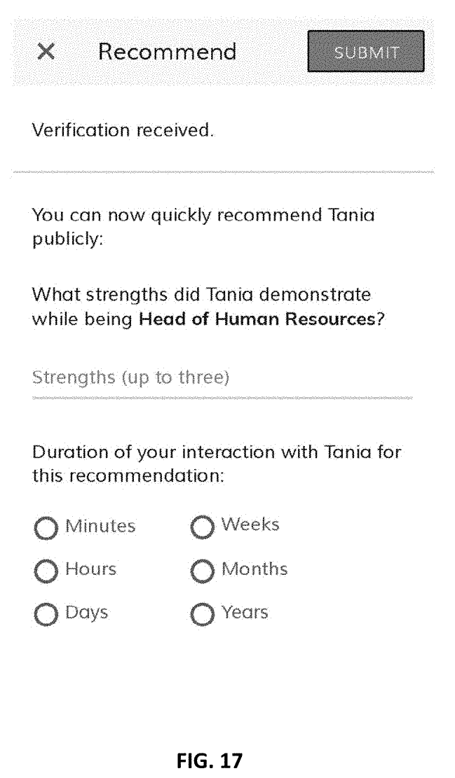

FIG. 13 shows a graphical user interface that presents a link that is operative to verify one or more experiences of a particular account holder (target account holder). The link can be communicated or shared by the target account holder to another account holder or potential account holder (verifier or source account holder) of the network for such verification. When the link is activated by the source account holder, the interface can present an interface that allows the source account holder to verify one or more experiences of the target account holder (in this case “Tania Zapata”) as shown in FIGS. 14, 15 and 16. The graphical user interface includes a drop-down list that allows source account holder to select an experience of the target account holder to verify as shown in FIG. 14. The target account holder then specifies the type of relation between source account holder and the particular account holder (for example by a drop-down list) as well as specifics of the job and experience that is most relevant to the relationship between the source account holder and the target account holder. After specifying this information, the source account holder submits the information by clicking on the “VERIFY” button in the upper right corner of the interface. In response to this request, the network (i.e., protocol network nodes) processes the information entered by the source account holder to determine whether the verification succeeds (Step 307 of FIG. 7A). If the verification succeeds, the source account holder can be presented with a notification in the interface as shown in FIG. 16, which includes a button (in this case labeled “RECOMMEND TANIA” button) that when activated allows the source account holder to recommend the target account holder as shown in FIG. 17.

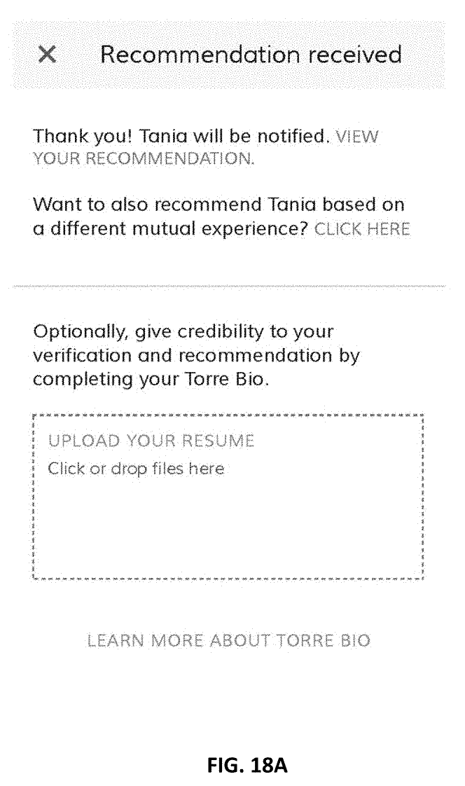

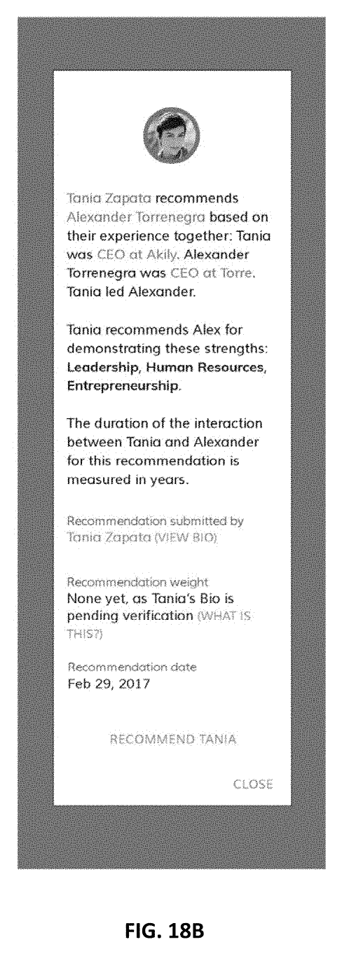

FIG. 17 shows a graphical user interface that allows the source account holder to recommend the target account holder. The graphical user interface includes a field where the source account holder can specify zero to three strengths or other experiences of the target account holder that are associated with the recommendation. The graphical user interface allows includes check buttons where the source account holder can specify a time duration for the relationship/interaction between the source account holder and target account holder upon which the recommendation is based. Such time duration can be used to determine the longevity factor for this particular recommendation that is used as part of the recommendation weight update process as described herein. After specifying this information, the source account holder submits or commits the recommendation to the system (i.e., as a blockchain transaction request to the protocol network nodes) by clicking on the “SUBMIT” button in the upper right corner of the interface. In response to this request, the recommendation data is stored in data storage (for example, by the protocol network nodes issuing a transaction request to the blockchain) and the recommendation weight update process is initiated (Step 315 of FIG. 7B) in order to calculate and store the recommendation weights in data storage (such as a sidechain/auxchain). Thereafter, the source account holder is presented with the graphical user interface of FIG. 18A. Similar graphical user interfaces can be used to edit or retract a recommendation, and to submit, edit or retract a signal. As part of this processing, the signal data is stored in data storage (for example, by the protocol network nodes issuing a transaction request to the blockchain) and a signal weight update process is initiated in order to calculate and store the signal weights and characteristic signal weights in data storage (such as a sidechain/auxchain).

FIG. 18B shows a graphical user interface that presents the details of the recommendation to account holders of the network. Note that this interface includes information that describes the source account holder and target account holder of the recommendation, the set of strengths or other experiences of the target account holder that are associated with the recommendation, the duration of the relationship between the source account holder and the target account holder that is the basis for the recommendation, and the recommendation weight for the recommendation as determined by the recommendation weight update process as described herein.

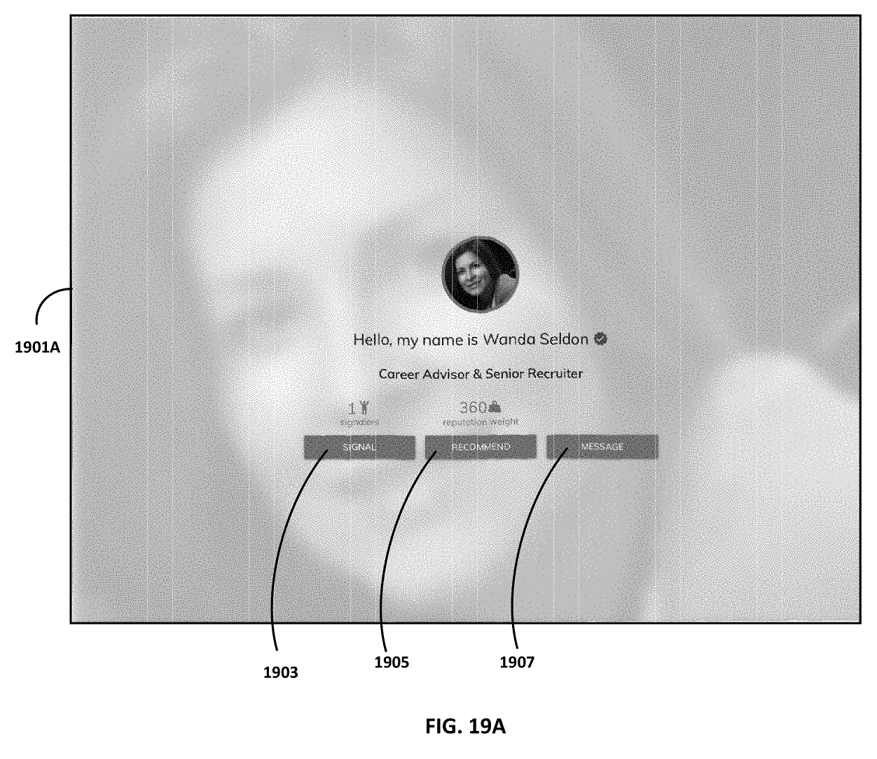

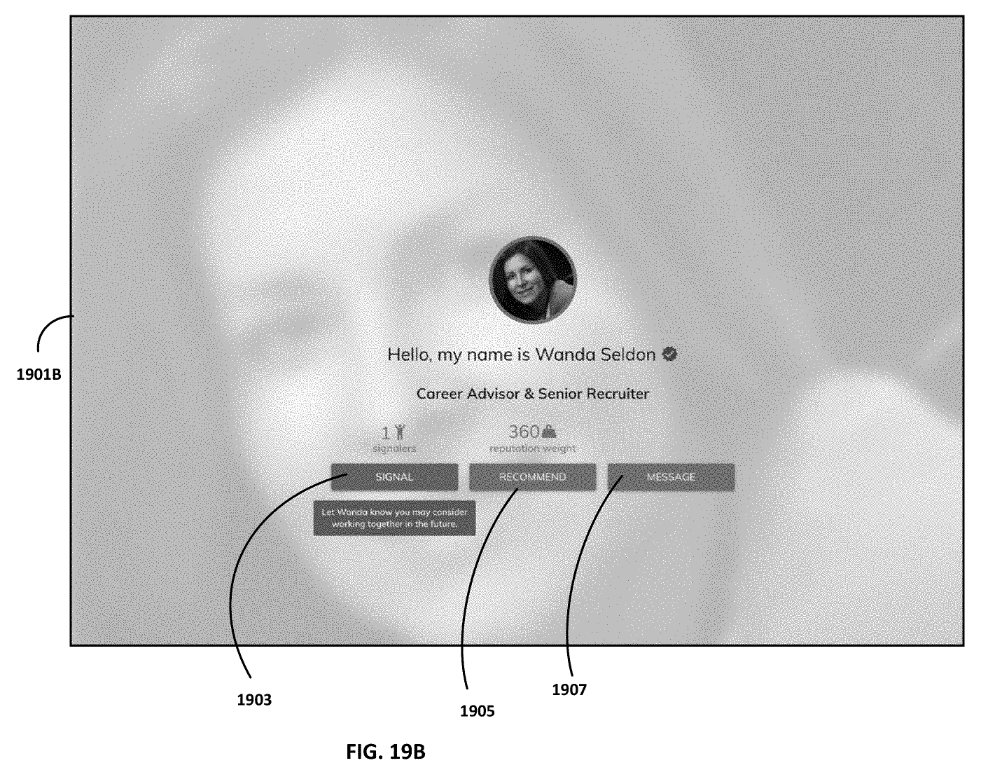

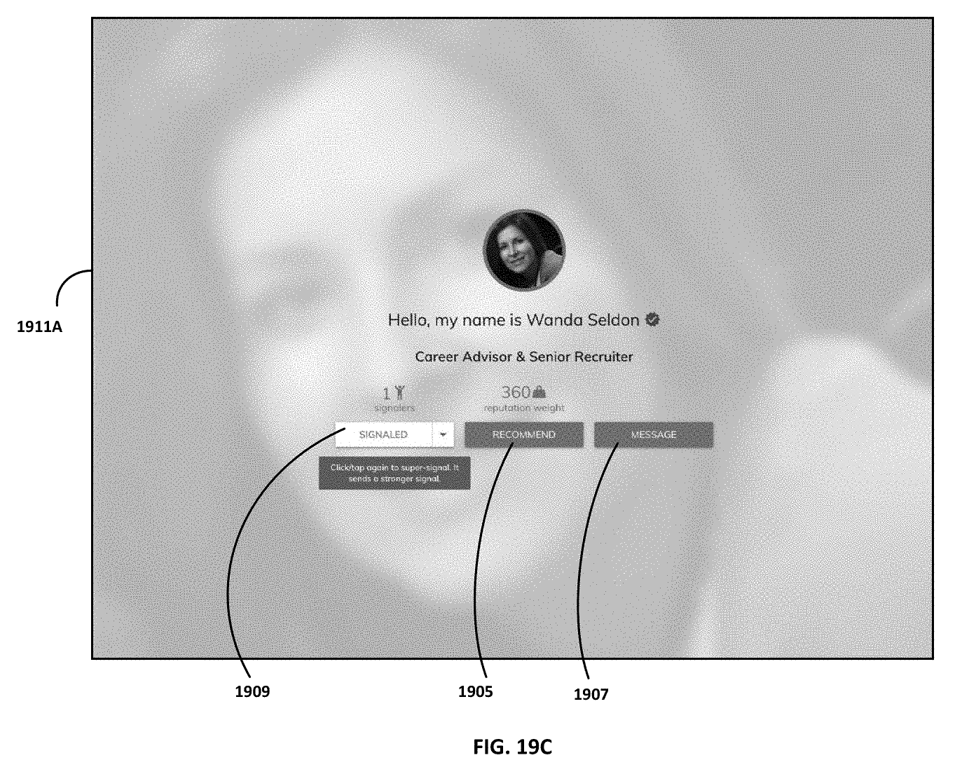

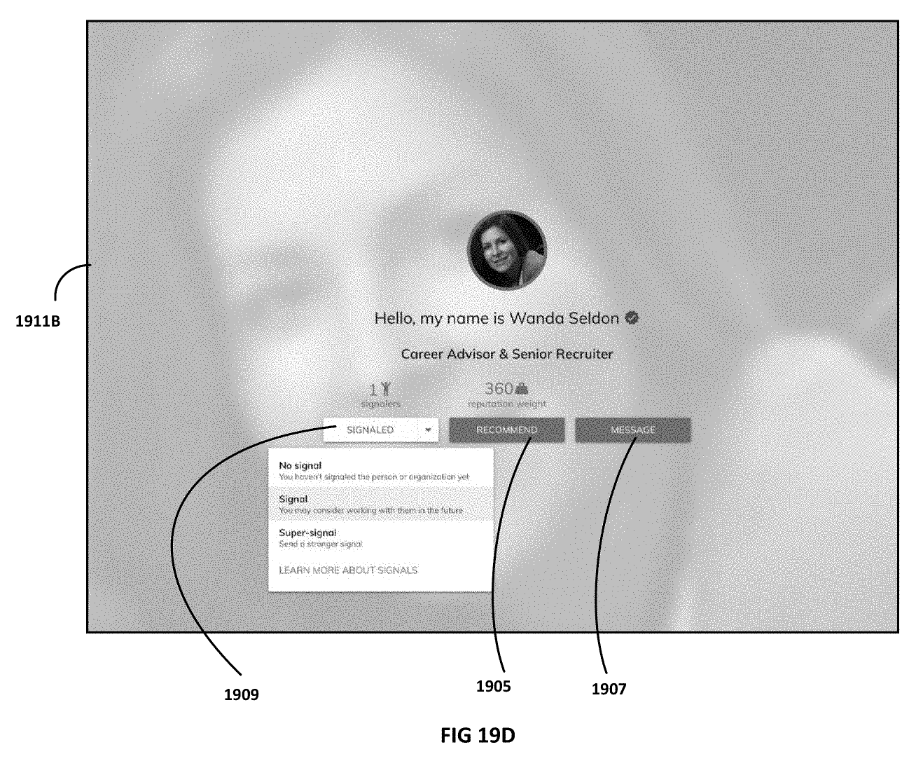

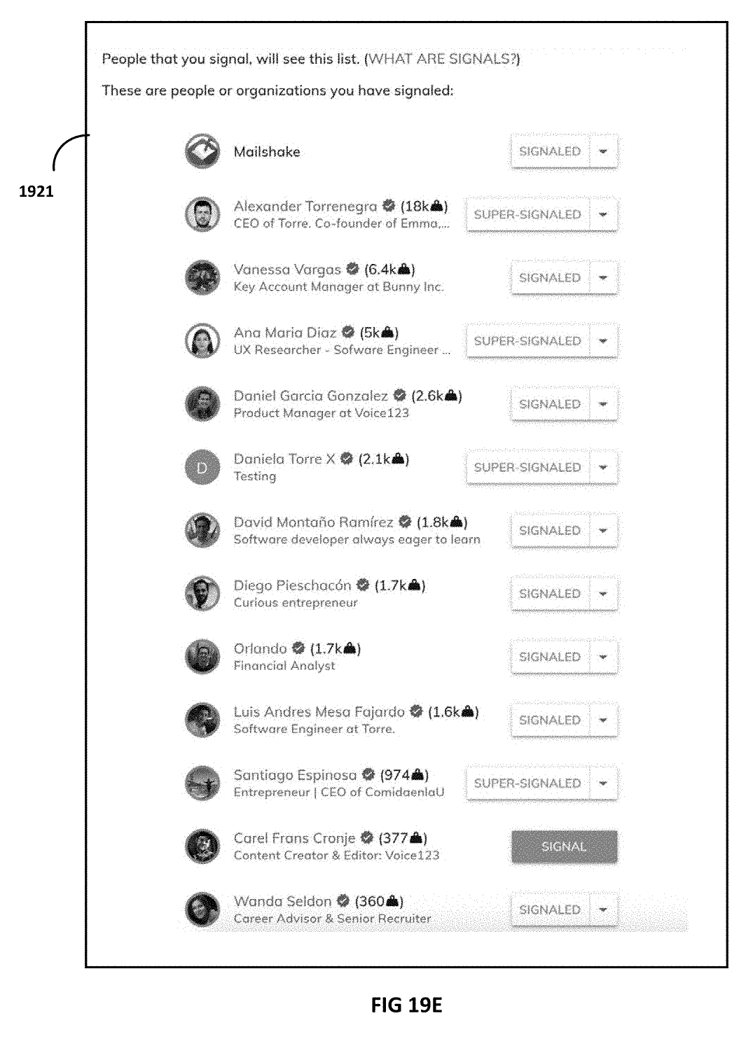

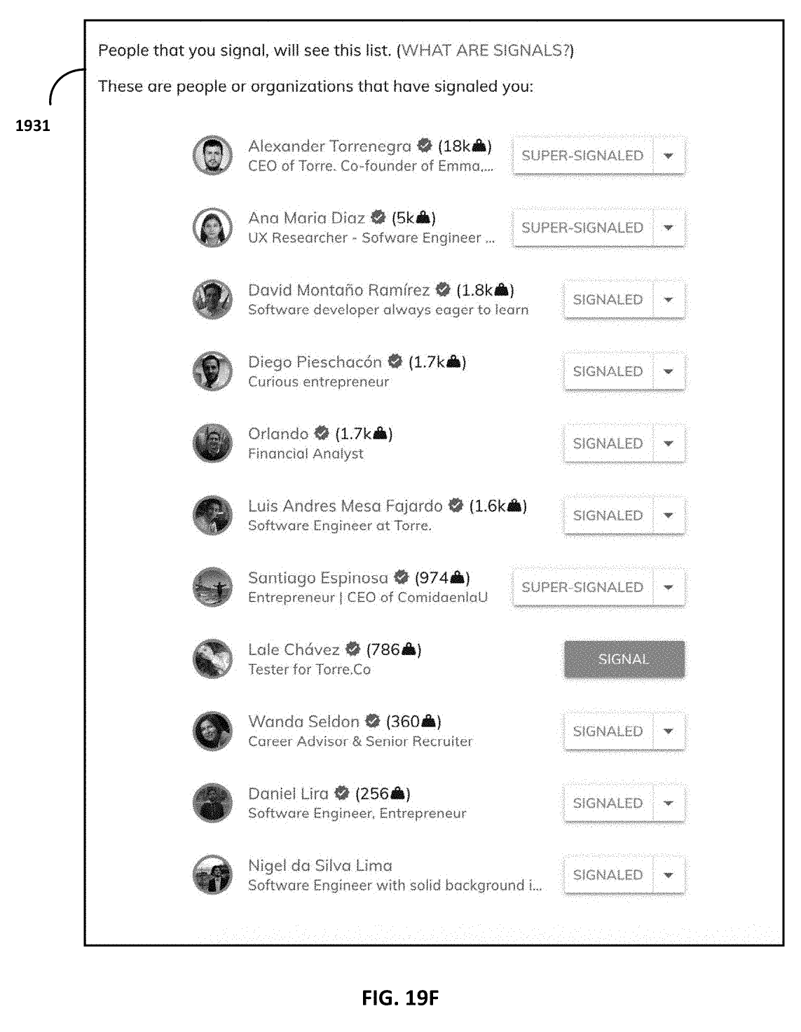

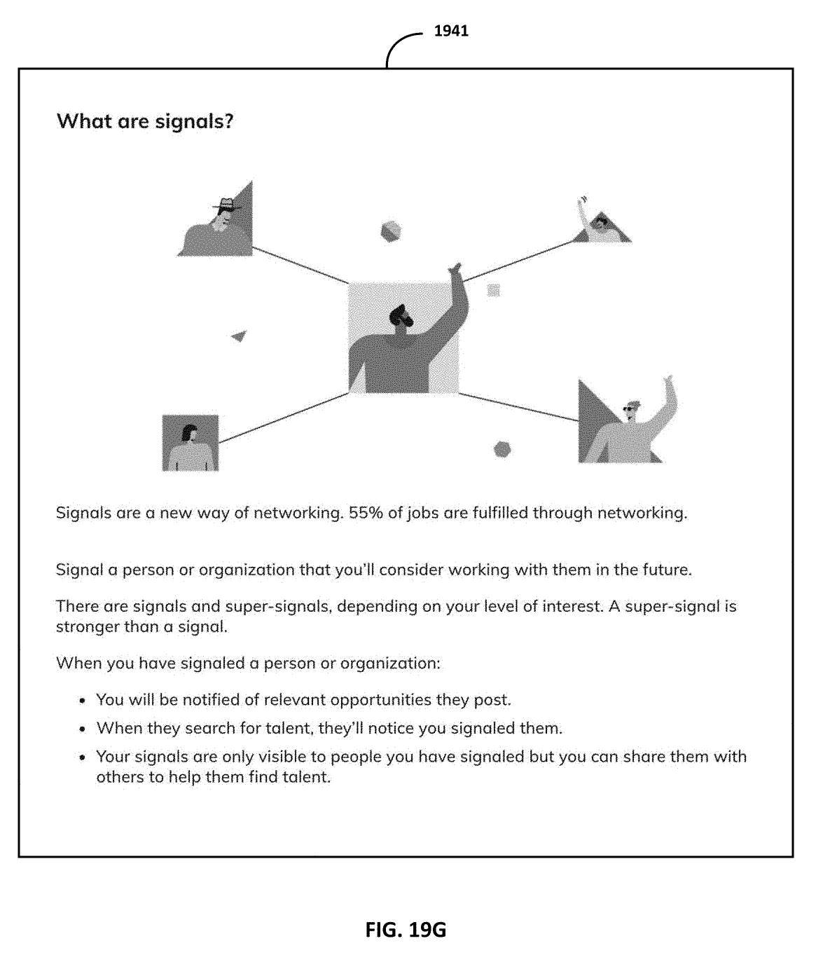

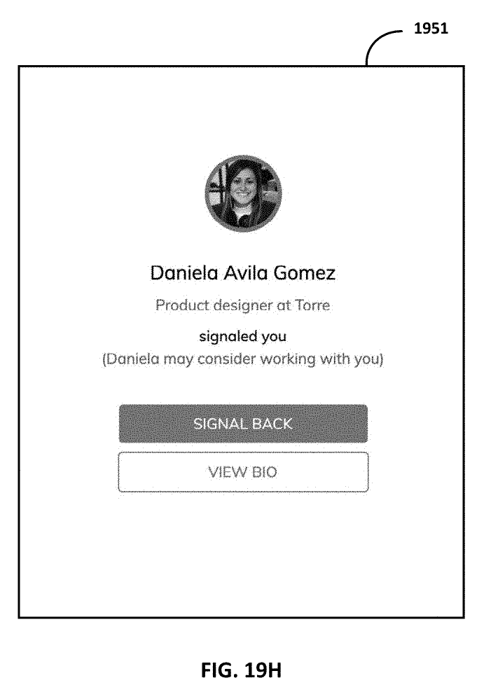

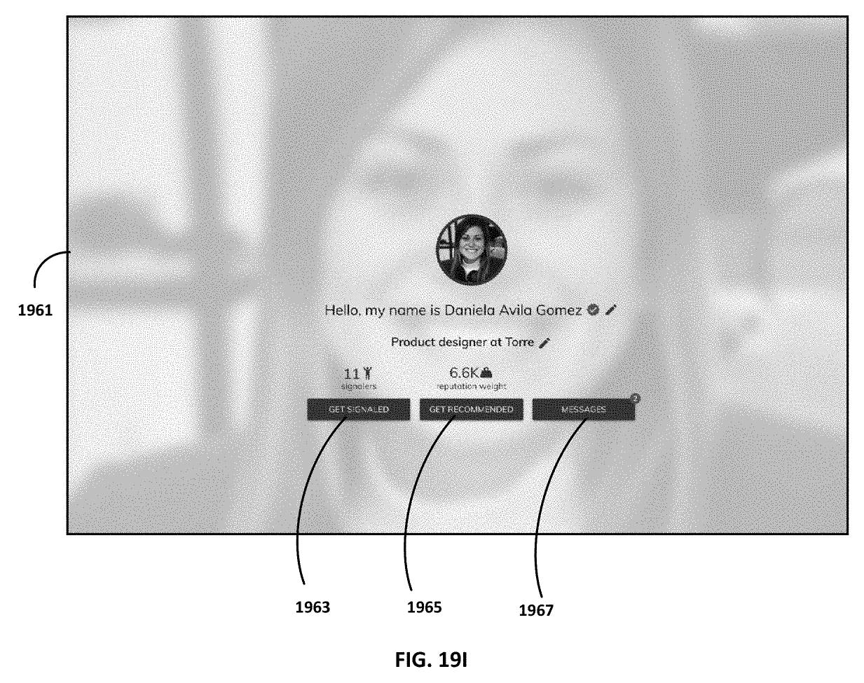

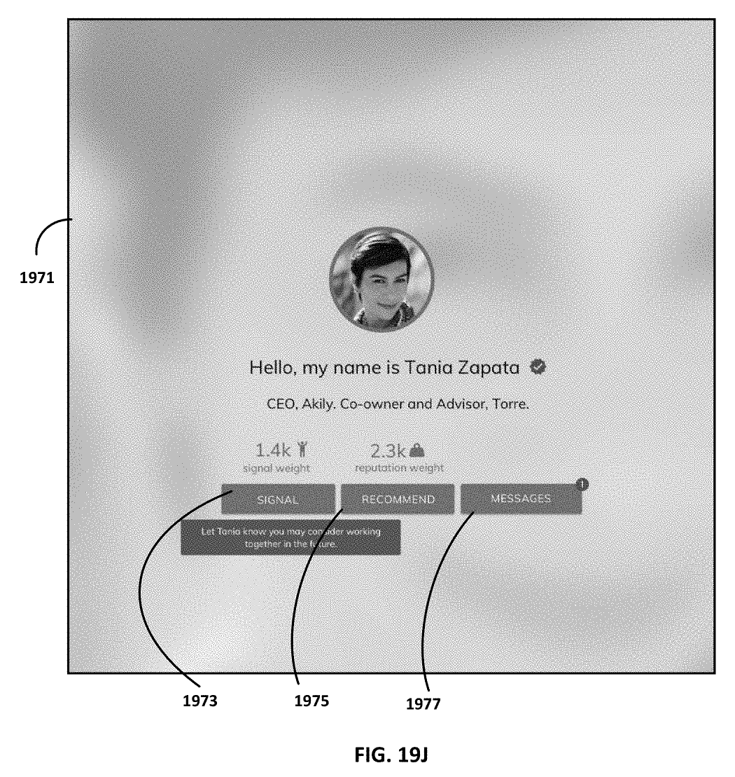

FIGS. 19A and 19B show exemplary graphical user interfaces 1901A and 1901B, respectively, that present summary biographical information of a particular account holder (e.g., Wanda Seldon) to another account holder. The interfaces 1901A, 1901B each include a widget or button 1903 that can be clicked on or otherwise selected by the other account holder (“signaler”) that is viewing the interface to generate a signal directed to the particular account holder Wanda Seldon (“signalee”). The interfaces 1901A, 1901B can also each present a count of the number of signals directed to the particular account holder Wanda Seldon (i.e., a count of the signals where the particular account holder Wanda Seldon is the signalee) above the button 1903. The interfaces 1901A, 1901B can also each include a widget or button 1905 that can be clicked on or otherwise selected by the other account holder (“recommender”) that is viewing the interface to generate a recommendation directed to the particular account holder Wanda Seldon (“recommended”). The interfaces 1901A, 190B can also each present the total recommendation weight of the particular account holder Wanda Seldon above the button 1905. The interfaces 1901A, 1901B can also each include a widget or button 1907 that can be clicked on or otherwise selected by the other account holder that is viewing the interface to generate a message directed to the particular account holder Wanda Seldon.

FIGS. 19C and 19D show exemplary graphical user interfaces 1911A and 1911B, respectively, that can be presented after a signaler account holder clicks on or otherwise selects button 1903. In these interfaces, button 1909 is presented in place of button 1903 to indicate that the signal directed from the signaler to the signalee account holder Wanda Seldon has been generated and stored. It is also contemplated that the signaler account holder can click on or otherwise select button 1911 to adjust the strength attribute of the signal directed from the signaler to the signalee account holder Wanda Seldon, such as by adjusting the signal strength attribute from a default strength to a super-strength type as described herein. The interfaces 1911A, 1911B can also each present a count of the number of signals directed to the account holder Wanda Seldon (i.e., a count of the signals where the particular account holder Wanda Seldon is the signalee) above the button 1909. The interfaces 1911A, 1911B can also each include a widget or button 1905 that can be clicked on or otherwise selected by the other account holder (“recommender”) that is viewing the interface to generate a recommendation directed to the account holder Wanda Seldon (“recommended”). The interfaces 1911A, 1911B can also each present the total recommendation weight of the account holder Wanda Seldon above the button 1905. The interfaces 1911A, 1911B can also each include a widget or button 1907 that can be clicked on or otherwise selected by the other account holder that is viewing the interface to generate a message directed to the account holder Wanda Seldon.

FIG. 19E shows an exemplary graphical user interface 1921 that can be presented to a particular account holder to present information that summarizes some or all of the signals that have been generated by the particular account holder (i.e., signals where the particular account holder is the signaler). In embodiments, the account holders that are signaled by the particular account holder, i.e., signalee account holder(s) for signal(s) where the particular account holder is the signaler, can be permitted to view this summary information as well.

FIG. 19F shows an exemplary graphical user interface 1931 that can be presented to a particular account holder to present information that summarizes some or all of the signals that have been directed to the particular account holder (i.e., signals where the particular account holder is the signalee). In embodiments, the account holders that are signaled by the particular account holder, i.e., signalee account holders for signals where the particular account holder is the signaler, can be permitted to view this summary information as well.

FIG. 19G shows an exemplary graphical user interface 1941 that can be presented to an account holder or other user to present a functional overview of signals as described herein.

FIG. 19H shows an exemplary graphical user interface 1951 that can be presented to a particular account holder (e.g., Daniela Avila Gomez) to present a notification or indication that a signal has been directed to the particular account holder (i.e., a signal where Daniela Avila Gomez is the signalee).

FIG. 19I shows an exemplary graphical user interface 1961 that presents summary biographical information of a particular account holder (e.g., Daniela Avila Gomez) to the particular account holder. The interface 1961 can present a count of the number of signals directed to the particular account holder (Daniela Avila Gomez) above button 1963 (“Get Signaled”). The interface 1961 can also present the total recommendation weight of the particular account holder (Daniela Avila Gomez) above the button 1965 (“Get Recommended”). The interface 1961 can also include a widget or button 1967 that can be clicked on or otherwise selected by the particular account holder (Daniela Avila Gomez) to view or generate messages directed to or from the account holder (Daniela Avila Gomez).

FIG. 19J shows an exemplary graphical user interface 1971 that presents summary biographical information of a particular account holder (e.g., Tania Zapata). The interfaces 1971 can include a widget or button 1973 that can be clicked on or otherwise selected by another account holder (“signaler”) that is viewing the interface to generate a signal directed to the particular account holder (Tania Zapata) as the “signalee”. The interface 1971 can also present a characteristic signal weight for the particular account holder (Tania Zapata) above button 1973. The interface 1971 can also include a widget or button 1975 that can be clicked on or otherwise selected by the other account holder (“recommender”) that is viewing the interface to generate a recommendation directed to the particular account holder (Tania Zapata) as the “recommended”. The interface 1971 can also present the total recommendation weight of the particular account holder (Tania Zapata) above the button 1975. The interface 1971 can also include a widget or button 1977 that can be clicked on or otherwise selected by the other account holder that is viewing the interface to generate a message directed to the particular account holder (Tania Zapata).

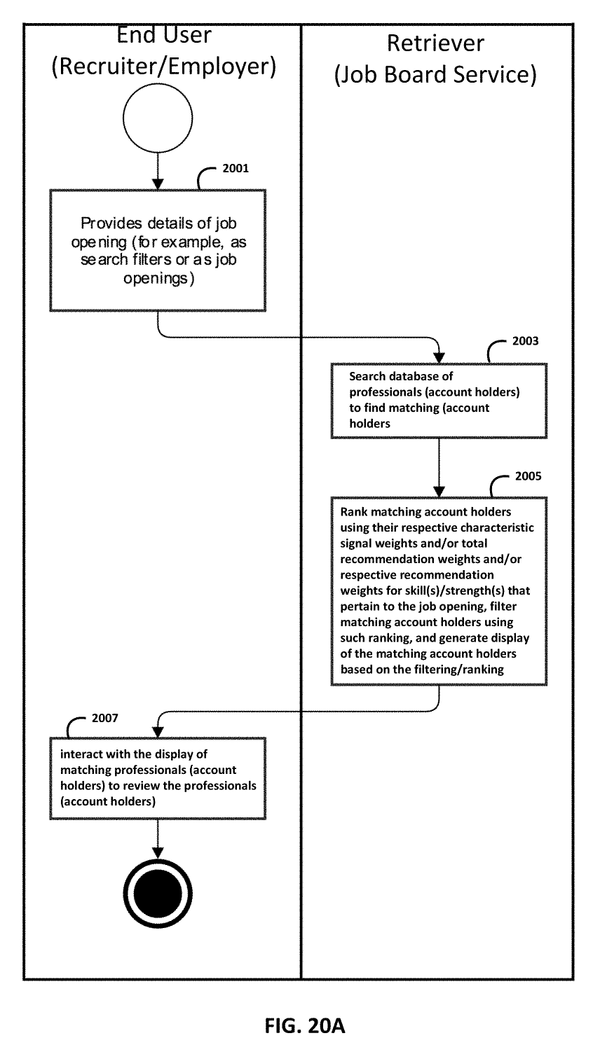

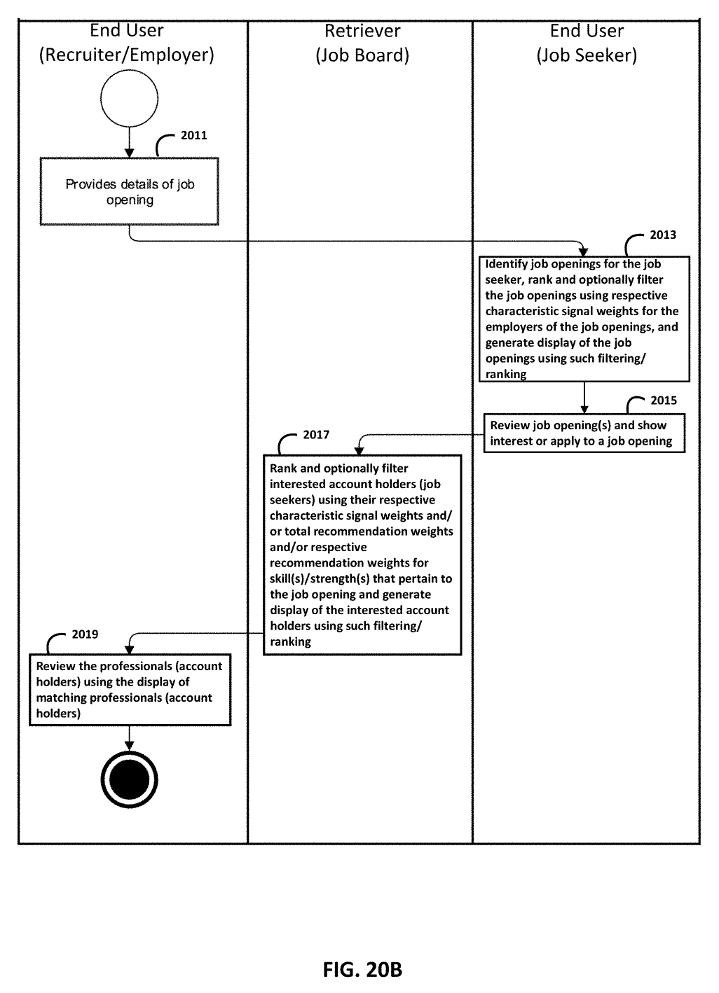

In embodiments, the operations of the system or network can be extended to allow end-users, such as recruiters or employers, to search the account holder profile data (which can be stored by the system or in a decentralized ledger) to identify and review potential candidates for a job opening as shown in FIG. 20A. In this embodiment, in block 2001, the recruiter/employer can provide details of a job opening (for example as search filters or job opening information). In block 2003, the system or network can query the account holder profile data to find account holders that match the details of the job opening. In block 2005, the system or network can rank the matched account holders based on the total recommendation weights and/or the characteristic signal weights of the matched account holders (with higher weighted account holders ranked above lower weighted account holders). Additionally or alternatively, the recruiter/employer can specify one or more per-experience recommendation weights, and the system can rank the matched account holders based on the specified one or more per-experience recommendation weights of the matched account holders. The system or network can use the ranking and/or the total recommendation weights and/or per-experience recommendation weights and/or characteristic signal weights to filter or remove one or more of the matched account holders. For example, one or more of the lowest ranked matched account holders can be filtered out or removed from the ranked list of matched account holders. In another example, one or more matched account holders having a total recommendation weight and/or per-experience recommendation weight and/or characteristic signal weight that do not meet a specified selection criteria(s) related to such weights can be filtered out or removed from the ranked list of matched account holders. The resulting ranked and optionally filtered list of matched account holders can be used to generate a display of the matched account holders for presentation to the recruiter/employer. In embodiments, the display can present the account holders according to the rank order of the ranked list with higher weighted account holders above lower weighted account holders. In block 2007, the recruiter or employer can interact with the display of matched account holders to review the profiles of the account holders as desired.

In other embodiments, the operations of the system or network can be extended to allow recruiters or employers to provide details of job opening to account holders of the service as shown in FIG. 20B. In this embodiments, in block 2011, recruiters/employers can provide details of job openings (job opening information), which is stored by the system. The job openings can be related to specific jobs, positions, roles or other professional opportunities. In block 2013, the system or network can search the job opening information to identify job openings for a job seeker (account holder). Such search can possibly involve matching job opening information to search criteria specified by the job seeker (account holder) and/or matching job opening information to profile data of the job seeker (account holder). The system or network can rank the identified job openings using respective characteristic signal weights for the employers (organizations or people) of the job openings (with higher weighted job openings ranked above lower weighted job openings). The system or network can use the ranking and/or the characteristic signal weights for the employers of the job openings to filter or remove one or more of the matched job openings. For example, one or more of the lowest ranked job openings can be filtered out or removed from the ranked list of matched job openings. In another example, one or more matched job openings for employers having a characteristic signal weight that do not meet a specified selection criteria can be filtered out or removed from the ranked list of matched job openings. The system or network can use the resulting ranked and optionally filtered list of matched job openings to generate a display of the job openings for presentation to the job seeker/account holder. In embodiments, the display can present the job openings according to the rank order of the ranked list with higher weighted job openings above lower weighted job openings. In block 2015, the job seeker/account holder can interact with the display of job openings, review the details of one or more of the job openings, and submit an interest or apply to a particular job, which associates the account holder (referred to as an “interested account holder”) to a particular job opening. In block 2017, for a given job opening, the system or network can rank and possibly filter the interested account holders associated with the given job opening based on the characteristic signal weights and/or total recommendation weights of the interested account holders (with higher weighted account holders ranked above lower weighted account holders). Additionally or alternatively, the recruiter/employer can specify one or more per-experience recommendation weights, and the service can rank and possibly filter the interested account holders associated with the given job opening based on the specified one or more per-experience recommendation weights of the interested account holders. The system or network can use the resulting ranked and optionally filtered list of interested account holders to generate a display of the interested account holders for presentation to the recruiter/employer. In embodiments, the display can present the interest account holders according to the rank order of the ranked list with higher weighted interest account holders above lower weighted interested account holders. In block 2019, the recruiter or employer can interact with the display of interested account holders to review the profiles of the account holders as desired.

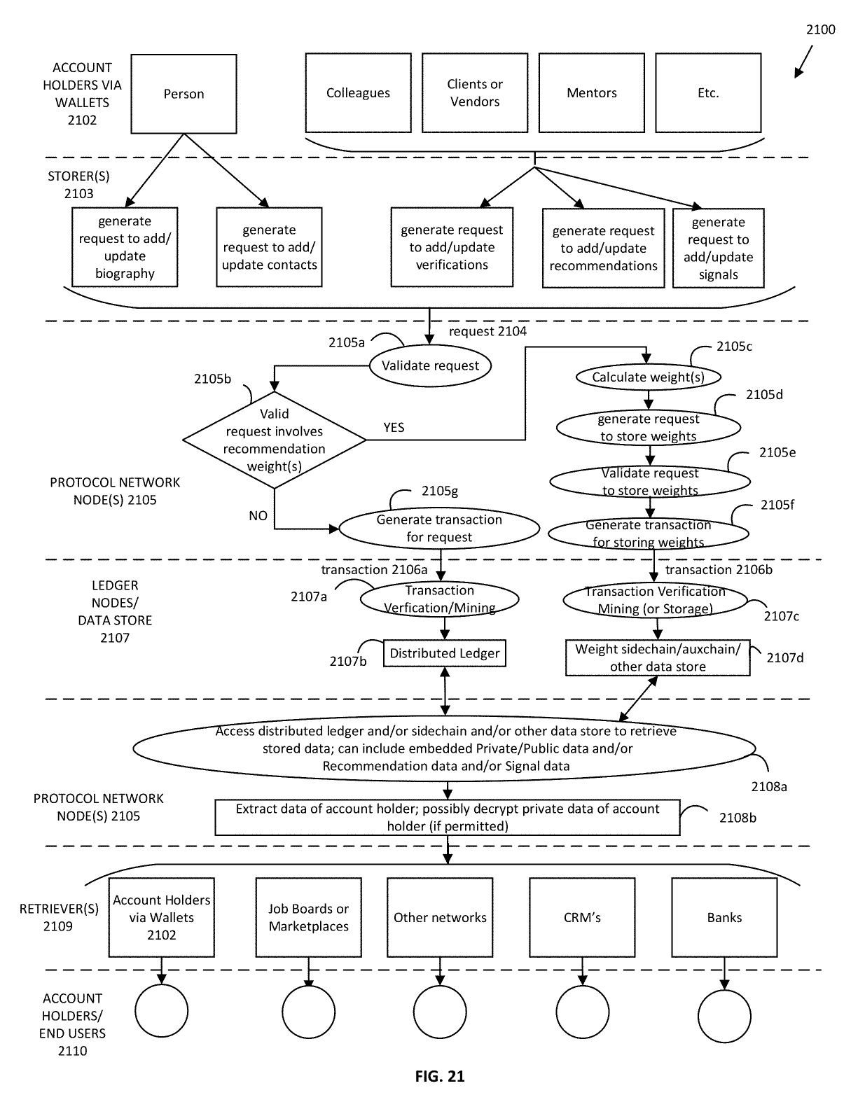

In an alternative embodiment, the professional social network as described herein can be embodied by a decentralized network as shown in FIG. 21, which includes a number of participants that include account holders (or users of the social network), one or more storers, one or more protocol network nodes, one or more retrievers, and end-users (who need not be an account holder or user). The participants can be referred to as “nodes” of the social network and each node can be embodied by processor-based system or other suitable processing device or system as described herein. The participants will be described in further detail below.

First, it will be noted that account holders (or users) can include various types of parties, including individuals, colleagues, clients or vendors, mentors, etc. It is contemplated that an account holder will use electronic wallet functionality (or wallet) 2102 as shown that cooperates with one or more storer nodes 2103 to generate requests 2104 to add or update user profile data of the account holder. For example, such requests 2104 can add or update the biographical data of the account holder, add or update contacts data of the account holder (which refers to other account holders that are connected or linked to the account holder), add or update verification data of the account holder, and/or add or update recommendation data of the account holder. The requests 2104 generated by the storer node(s) 2103 are supplied to one or more network protocol nodes 2105, which process such requests in accordance with steps 2105a-2105g as described in detail below. In essence, the wallet functionality 2102 and storer node(s) 2103 provide an interface between the account holders and the protocol network nodes 2105 in order to generate and issue requests to add, or modify profile data of the account holder as stored on the distributed ledger 2107b or possibly stored in a side chain or aux chain or other data store 2107d as described in detail below. The wallet functionality 2102 can be realized by online electronic wallet systems, hot or cold wallets, hardware-based wallets, etc. The wallet functionality and the storer node(s) can interact in many ways, including widely adopted protocols such as OAuth. Note that the wallet functionality 2102 can store public and private encryption keys or other passwords. The private encryption key of the account holder can be used by the wallet functionality to digitally sign requests issued by the account holder and supplied to the one or more network protocol nodes 2105. In alternate embodiments, the account holders can employ software functionality that interfaces directly with the one or more network protocol nodes 2105 to supply requests that are digitally signed by the account holder using a private encryption key or other password of the account holder.

Note that each and every account holder can be associated with a network account (or wallet account) and a unique account ID, which uniquely identifies the account and correspond account holder on the social network. The profile data of a given account holder can also include one or more data structure types as described in the present application (e.g., see FIG. 1B). Examples of such data structure types include biographical information about the account holder, organizational information associated with the account holders past and present employers, experience(s) associated with the account holder, verifications associated with the account holder, recommendations associated with the account holder, signals associated with the account holder, connections associated with the account holder, interests associated with the account holder, account strengths and skills associated with the account holder, strengths and skills associated with the account holder, and account information associated with the account holder. Further details of a schema of the data structure types are provided hereinbelow. As a whole, in one embodiment, the profile data contained in the data structures can be used to construct an enhanced, structured curricula vitae of an account holder. In one embodiment, some or all of the profile data structures are stored on a distributed ledger 2107b (such as the blockchain). It is also possible that some of the profile data structures (such as recommendation weights and/or signal weights for the account holders) can be stored in a side chain or auxiliary chain or other data store 2107d. Note that once a transaction is committed to the blockchain, the transaction is immutable and cannot be deleted. However, some transaction types (such as a recommendation transaction) may be modified or reversed or retracted by a subsequent transaction, but it cannot be deleted.

Note that the account holders can control access to any private data stored on the distributed ledger 2107b or other data store 1807d through the use of public/private key encryption technologies as described below.

As used herein, a blockchain is a continuously growing list of records, called blocks, which are linked and secured using cryptography. Each block typically contains a cryptographic hash of the previous block, a timestamp and transaction data. A blockchain is an open, distributed ledger that can record transactions efficiently and in a verifiable and permanent way. For use as a distributed ledger, a blockchain is typically managed by a peer-to-peer network collectively adhering to a protocol for inter-node communication and validating new blocks, which is hereinafter termed “mining” blocks of the blockchain. By design, a blockchain is inherently resistant to modification of the data. Once recorded, the data in any given block cannot be altered retroactively without the alteration of all subsequent blocks, which requires collusion of the network majority. Blockchains are secure by design and exemplify a distributed computing system with high Byzantine fault tolerance. Decentralized consensus has therefore been achieved with a blockchain. This makes blockchains potentially suitable for the recording of events and records, such as transaction processing.

In the decentralized network of FIG. 21, the protocol network node(s) 2105 can operate to receive, validate and process requests to add or update the structured profile data of the account holder. Such a request should include a digital signature signed with the private encryption key of the account holder, and validation of the request can verify the digital signature against the public key of the account holder as stored in the distributed ledger. The protocol network node(s) 2105 can also perform calculations required by the network protocol as a precondition of the task of adding and/or updating the structured data. For example, in response to a request to add or update a recommendation for an account holder (user), in block 2105c the protocol network node(s) 2105 can automatically calculate the total recommendation weight of the account holders (or users) as well as the recommendation weights of the recommendations given by the account holders (or users). Details of exemplary calculations of such recommendation weights are described above with respect to FIGS. 8A-8D. A recommendation given by an account holder (user) need not be reciprocal, and the account holder (user) that receives the recommendation can reject it. Furthermore, the recommendation weight that is assigned to the recommendations given by an account holder (user) is scarce. That is, with each given recommendation, the overall weight of the account holder's recommendation (their reputation weight) can diminish proportionally. Thus, the recommendations made by an account holder (user) who recommends selectively (with less frequency) have greater recommendation weight than those made by an account holder (user) who is recommend less selectively (with higher frequency). It is contemplated that an account holder (or user) can reverse or retract an earlier recommendation by a subsequent request. In this case, the calculation of the recommendation weights can be adjusted accordingly. In one embodiment, the total recommendation weight of the account holder (or user) who retracted the earlier recommendation can be calculated based upon all recommendations given by the account holder (or user), including any and all retracted recommendations. In another example, in response to a request to add or update a signal for an account holder (user), in block 2105c the protocol network node(s) 2105 can automatically calculate the characteristic signal weight of the account holders (or users) as well as the signal weights of the signals given by the account holders (or users). The protocol network node(s) 2105 can also responsible for generating transactions (labeled 2106a) based on valid requests issued by the storer node(s) on behalf of the account holders or issued directly by an account holder (block 2105g). Each transaction 2106a (when validated and stored on distributed ledger) adds or updates profile data of a respective account holder as referenced in the transaction 2106a. Some or all of the transactions generated by the protocol network node(s) 2105 can be communicated to a network of ledger nodes for verification and storage in the distributed ledger 2107b. The protocol network node(s) 2105 can also responsible for generating transactions based on requests generated automatically by operation of the protocol network node(s) 2105. For example, the protocol network node(s) 2105 can generate transactions 2106b to store the calculated recommendation weights or signal weights of the account holders (block 2105f). Each transaction 2106b (when validated and stored) can add or update recommendation weight profile data or signal weight profile data of a respective account holder as referenced in the transaction 2106b. Certain transactions (such as recommendation weight transactions 2106b) that carry data to be stored in a side chain or aux chain or other data store can be communicated to the other data store for verification and storage.

The protocol network node(s) 2105 can be configured to carry out a predefined set of actions that add or update profile data of an account holder in response to the requests supplied thereto. The predefine set of actions cooperate with the ledger nodes or other data store 2107 to add or update the profile data of an account holder as stored in the distributed ledger 2107b or in the side chain or aux chain or other data store 2107d. Illustrative examples of actions that can be included in this set include, but are not limited to, the following:

create an account for an account holder;

update an account of an account holder;

update biographic information of an account holder

create an organization for an account holder;

create an experience of an account holder;

update an experience of an account holder;

delete an experience of an account holder;

creates a strength/skill of an account holder;

update a strength/skill of an account holder;

delete a strength/skill of an account holder;

creates an interest of an account holder;

update an interest of an account holder;

delete an experience of an account holder;

create a recommendation between a recommender account holder and a recommended account holder;

updates longevity of affiliation between recommender account holder and the recommended account holder;

add new strength/skill to a recommendation;

retract a recommendation;

reject a recommendation (by the recommended account holder);

create a signal sent by one account holder to another account holder;

retract a signal (by the sending account holder);

update strength of a signal (by the sending account holder);

create a verification; and

reject a verification (by the recipient account holder);

retrieve all or part of the transaction data stored in the distributed ledger 2107b for an account holder; and

retrieve all or part of the transaction data stored in the side chain or other data store 2107d for an account holder.

The network of ledger nodes can be configured to verify the transactions supplied thereto and add valid transactions to new blocks that are created or mined (such operations are labeled block 2107a). The new blocks are stored as part of the distributed ledger 2107b. Certain transactions (such as transactions 2106b that involve recommendation weights or signal weights) that carry data to be stored in a side chain or aux chain or other data store can also be verified and added to the side chain or aux chain or other data store 2107d by mining or other suitable data storage operations (such operations are labeled block 2107c).

As noted above, the participants of the network can also include one or more retriever(s) and end users. The retriever(s) 2109 are configured to cooperate with the protocol network nodes 2105 to access the transaction data of a respective account holder as stored in the distributed ledger 2107b or in the sidechain or aux chain or other data store 2107d (block 2108a), extract the public data and/or encrypted private data of the respective account holder from such transaction data and possibly decrypt the private data of the respective account holder (block 2108b), and publish the profile data respective account holder or part thereof. If and when an account holder has requested access to encrypted private data (or the account holder has authorized another participant to access such encrypted private data), the retriever(s) 2109 can cooperate with the wallet functionality 2102 of the respective account holder to decrypt the encrypted private data (using the private encryption key of the account holder). The decrypted private data of the account holder can be communicated (for example, over an encrypted link) from the wallet to the retriever 2109 that requested the private data.

The retriever(s) 2109 can be software-implemented applications that execute on one or more computing platforms and that benefit from accessing and, in some cases, processing and publishing the profile data of account holders as stored in the distributed ledger 2107b or in the sidechain or aux chain or other data store 2107d. The retriever(s) 2109 can be part of the functionality implemented by job boards, marketplaces, other networks, customer relationship managers (CRM), banks, etc. For example, the retriever(s) 2109 can be part of the job recruitment functionality that implement the workflow of FIGS. 20A and 20B as described herein.

Note that the end users 2110 may not have any profile data stored on the distributed ledger 2107b or in the sidechain or aux chain or other data store 2107d, but may access and read such data using the retriever(s) 2109. Note that some or all end users 2110 may have accounts or subscriptions established with the retrievers(s) to use the data that the retrievers provide as read from the distributed ledger 2107b or from the sidechain or aux chain or other data store 2107d. In embodiments, the wallet functionality 2102 can act as and have the same or similar functionality as the end-users 2110. Thus, it may be that account holders, acting as end users, may use the wallet functionality 2102 to cooperate with the retriever(s) functionality 2109 to read profile data from the distributed ledger 2107b or from the sidechain or aux chain or other data store 2107d. For example, software applications (such as mobile application, desktop application or web-based applications) can be controlled by account holders (or end users) and operate as retrievers 2109 to the read the profile data of a respective account holder as stored in the distributed ledger 2107b or in the sidechain or aux chain or other data store 1807d and publish or display such profile data. Such applications can possibly include graphical user interfaces similar to the graphical user interfaces of FIGS. 10-19 as described herein.

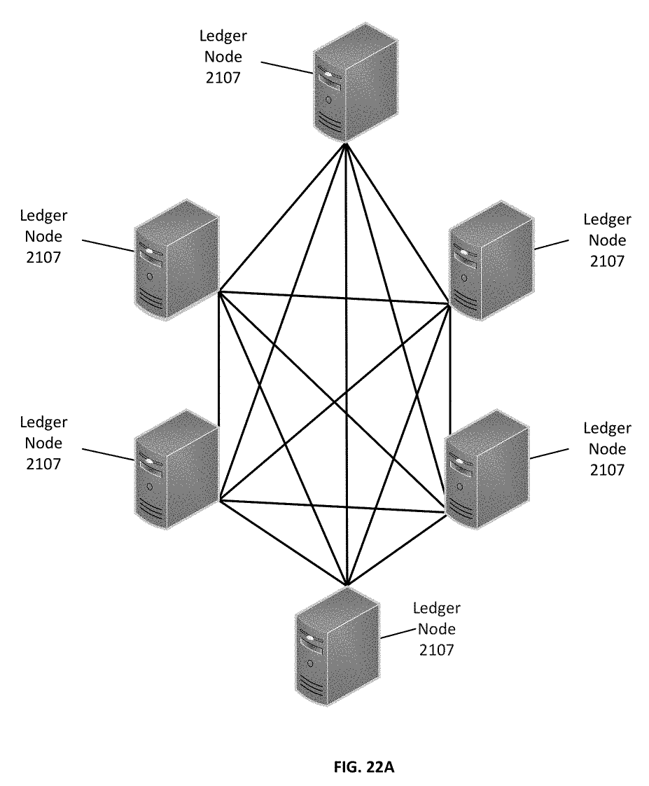

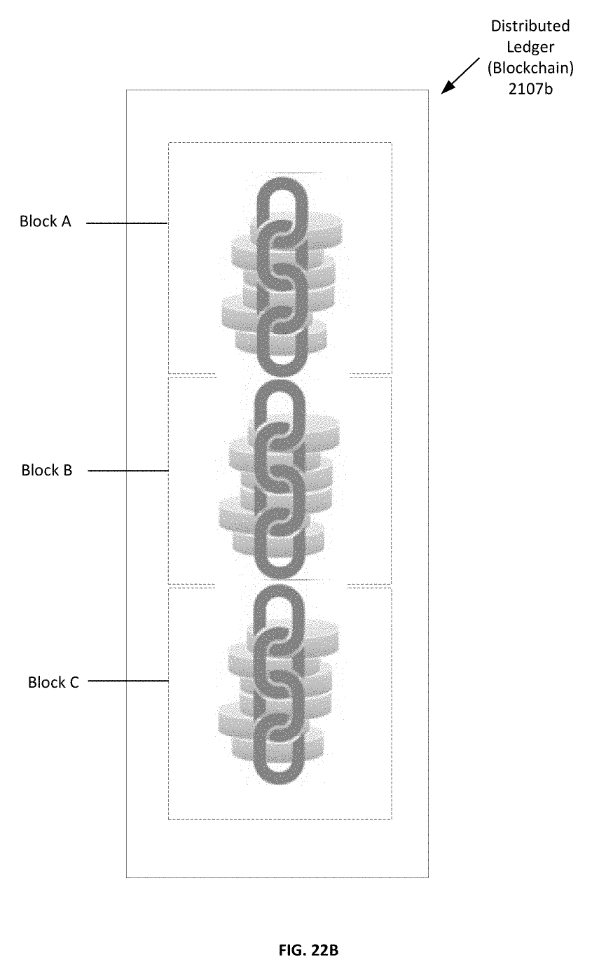

FIG. 22A illustrates an embodiment of a network of ledger nodes 2107 that are configured to manage and store transaction data on the distributed ledger 2107b. In one embodiment, all of the ledger nodes 2107 can store a copy of the distributed ledger 2107b, which includes block data for a sequence of blocks organized a blockchain formed over time. The block data can include transaction data that is aggregated and included as part of a new block that is added to the blockchain. The ledger nodes 2107 can store portions of the blockchain 2107b or the complete blockchain 2107b. For example, some nodes might store data for the entire blockchain, while other nodes might store data for only certain transactions, such as the calculated recommendation weights. Each ledger node 2107 (and possibly the wallet functionality 2102 and the protocol network node(s) 2105) can include functionality that can validate each block of the blockchain as well as the transaction(s) in a given block.

Some of the ledger nodes 2107 can be considered “miner” nodes that aggregate transactions and create a new block for addition to the blockchain. A miner node might perform some operations that easily verified by other ledger nodes 2107. Such operations can be intentionally both complex (to avoid non-authorized nodes from easily creating improper blocks) and dependent on the data of the included transactions (so that a non-authorized node cannot perform the complex operation ahead of time). Multiple miner nodes can possibly compete to perform the necessary work in creating the new block, which is referred to as a “proof-of-work” mining. Alternatively, the miner node for the new block can be selected based on its wealth or stake in the network (referred to as a “proof-of-stake work” mining or forging). Such selection may be made in a deterministic manner. After mining the new block, the miner node disseminates the new block to other ledger nodes, which validate the new block and transactions embedded therein. If the other ledger nodes succeed in validating the new block, the other ledger nodes add the new block to the blockchain and propagates the new block to other ledger nodes, thereby committing the new block to the blockchain. Once committed to the blockchain, the transaction is immutable and cannot be deleted. It is noted that some transactions (such as a recommendation transaction) may be modified or reversed by a subsequent transaction, but it cannot be deleted.

FIG. 22B shows a schematic illustration of the distributed ledger 2107b implemented as a blockchain. In embodiments, valid blocks are added to the blockchain by a consensus of the ledger nodes 2107 in the network. The blockchain may include an ordered list of validated blocks (for example, three shown), each of which groups together multiple transactions. Each block can be labeled with a timestamp and a “fingerprint” of a respective previous block. The fingerprint may be a hash of the previous block to form the link of blocks in the blockchain. Additionally, each block can include a group of transactions. Such transactions can include one or more transactions that add or update profile data of a respective account holder. It will be noted that the aforementioned sidechain may have the structure of the blockchain described herein.

In view of the foregoing, it will be appreciated that the network 2100 described in accordance with this disclosure is decentralized and can be open to any party. By being decentralized, the network liberates data from centralized-proprietary services and silos. The distributed ledger technology makes profile data of account holders accessible across various applications and platforms. Moreover, since the data stored on the distributed ledger 2107b is immutable, and can be accessed publicly, the information stored there can be checked for its veracity and manipulation by account holders.

In embodiments, certain participants (such as account holders, storer(s) and retriever(s)) can possibly use the professional social network for free (without payment to social network). In this case, tokens can be automatically created by the professional social network to reward the ledger nodes for their computational and bookkeeping functions. In embodiments, a token reward of value can be paid to the mining node that integrates a transaction (t) into the distributed ledger. For example, the token reward of value can be determined by the type of request, a global variable set by the governance of the network, and the quality score of the storer node that made the request according to Eqn. (6) described herein.

In embodiments, incentives, such as payments or other rewards, are not provided to the protocol nodes for the functionality that they provide to the network as described herein.

In other embodiments, incentives, such as payments or other rewards, can be provided to the protocol nodes from other nodes of the network for the functionality that the protocol nodes.

In still other embodiments, network nodes can possibly receive incentives, as payments or other rewards, for interacting with other nodes, or possibly present incentives, as payments or other rewards, for interacting with other nodes.

In embodiments, the professional social network can be implemented by a combination of two distributed ledgers (e.g., blockchains), which include:

The Data Ledger (Blockchain). This distributed ledger hosts most of the user profile data, including biographical information, recommendations, and verifications, but excludes the tokens that are rewarded to the ledger nodes that store the data in the Data Ledger.

The Token Ledger (Blockchain). This distributed ledger is used to create, buy, and sell the tokens that are rewarded to the ledger nodes that store the data in the Data Ledger. A smart contract on the Token Ledger can be configured to create new tokens to reward the ledger nodes for their work in storing data on the Data Ledger. To determine the appropriate token reward, the smart contract can pull information from the Data Ledger using oracles. The Token Ledger can be managed using an existing network, such as Ethereum, thus enabling reward tokens to enjoy additional liquidity and meet common standards, such as ERC20 or similar token standard. In this scenario, the mining ledger nodes of the Data Ledger can operate to trigger the smart contract that rewards them with newly minted tokens.

In other embodiments, all or part of the functionality of a particular participant (or node-type) can be combined or integrated with all or part of the functionality of one or more other participants (or node types). For example, all or part of the wallet functionality can be combined with the all or part of the functionality of the storer node(s) and/or retriever node(s) as described herein. In another example, all or part of the functionality of the storer node(s) and/or retriever node(s) can be combined with all or part of the functionality of the protocol network node(s) as herein. In still another example, all or part of the functionality of the protocol network node(s) can be combined with all or part of the functionality of the ledger nodes as described herein.

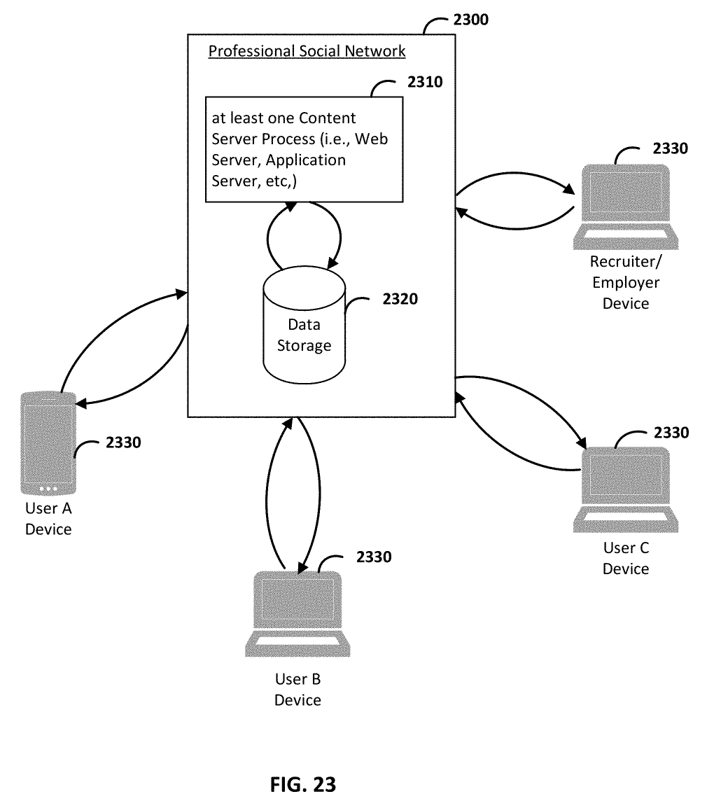

In other embodiments, all or part of the functionality of the professional social network as described herein can be integrated as part of centralized web-based service. FIG. 23 shows an example professional social network 2300 according to one example of the current disclosure. Processional social network 2300 may contain a content server process 2310. Content server process 2310 may communicate with data storage 2320 and users through a communication network. Content server process 2310 may be responsible for the retrieval, presentation, and maintenance of registered user profile data, user recommendation data, user signal data, and other data as described herein stored in data storage 1320 and interaction with the users according to the operations as described herein in detail. Content server process 2310 in one example may include or be a web server that fetches or creates internet web pages, which may include portions of, or all of, the registered user profile data at the request of users as well as the user recommendation data and the signal data as described herein. The server process 2310 can also include functionality that dynamically calculates the recommendation weights associated with user recommendations, the signal weights associated with signals, the total recommendation weights associated with users, and the characteristic signal weights associated with users as recommendations and/or signals are added or possibly deleted from the system over time. The server process 2310 can also implement the retriever (job board) functions as described above with respect to FIGS. 20A and 20B.

Users may be an individual, group, user or member, prospective user, recruiters or employers, or other users of the social network 2300. Users access the social network 2300 using a computer system 2330 through a communication network. The communication network may be any means of enabling the professional social network 2300 to communicate data with a computer remotely, such as the Internet, an extranet, a LAN, WAN, wireless, wired, or the like, or any combination. The user computer systems 2330 can be any one of a number of different types of computer systems, including PCs, workstations, notebooks, tablets, smartphones, other mobile devices, and other data communication enabled computing devices.

In other embodiments, all or part of the functionality of the professional social network as described herein can be integrated as part of a centralized or distributed computer processing system.

Certain embodiments as described herein can include logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

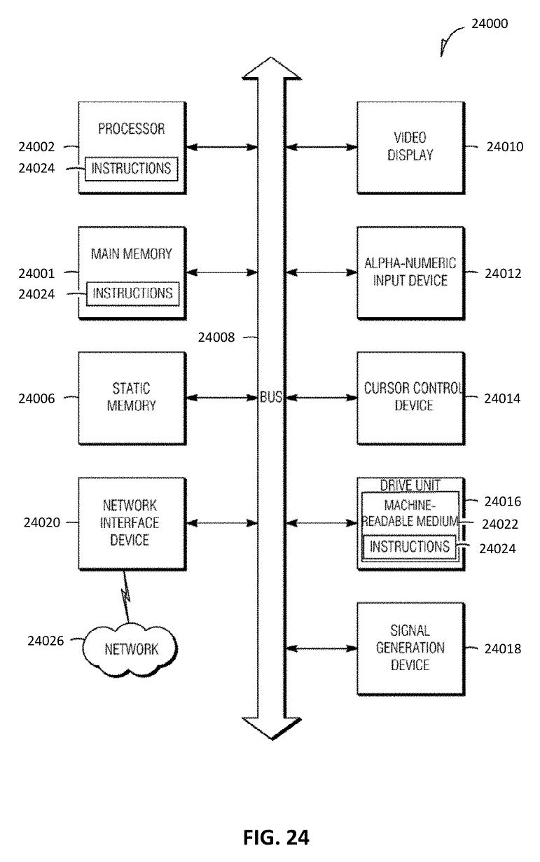

FIG. 24 shows a diagrammatic representation of a machine in the example form of a computer system 24000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Personal Digital Assistant (PDA), a cellular telephone or smartphone, a Web appliance, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 24000 includes a processor 24002 (e.g., a Central Processing Unit (CPU), a Graphics Processing Unit (GPU) or both), a main memory 24001 and a static memory 24006, which communicate with each other via a bus 24008. The computer system 24000 may further include a video display unit 24010 (e.g., a Liquid Crystal Display (LCD) or a Cathode Ray Tube (CRT)). The computer system 24000 also includes an alphanumeric input device 24012 (e.g., a keyboard), a User Interface (UI) cursor controller 24014 (e.g., a mouse), persistent storage 24016 (such as a hard disk drive or solid state drive), a signal generation device 24018 (e.g., a speaker) and a network interface device 24020 (e.g., a network transmitter/receiver).

The persistent storage 24016 includes a machine-readable medium 24022 on which is stored one or more sets of instructions 24024 and data structures (e.g., software) embodying or used by one or more of the methodologies or functions illustrated herein. The software may also reside, completely or at least partially, within the main memory 24001 and/or within the processor 24002 during execution thereof by the computer system 24000, the main memory 24001 and the processor 24002.

The instructions 24024 may further be transmitted or received over a network 24026 via the network interface device 24020 using any one of a number of well-known data communications protocols (e.g., IP, TCP, UDP, HTTP, Session Initiation Protocol (SIP), REST, SOAP, etc.).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a non-exclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A computer-implemented method involving a plurality of account holders of a professional social network service, comprising:
interacting with the plurality of account holders to generate signals, wherein each signal is made by a first account holder and directed to a second account holder, wherein the signal identifies interest of the first account holder in the second account holder;
storing data representing the signals;
calculating signal weights corresponding to the signals; and
storing data representing the signal weights corresponding to the signals.

2. A computer-implemented method according to claim 1, further comprising:
calculating characteristic signal weights for respective account holders, wherein the characteristic signal weight for a particular account holder is based on data representing at least one signal weight for the particular account holder corresponding to at least one signal directed to the particular account holder; and
storing data representing the characteristic signal weights for the respective account holders.

3. A computer-implemented method according to claim 2, wherein:
the characteristic signal weight for a particular account holder is calculated by summing signal weights for the particular account holder which correspond to signals directed to the particular account holder.

4. A computer-implemented method according to claim 2, wherein:
the characteristic signal weight for a particular account holder is calculated by averaging signal weights for the particular account holder which correspond to signals directed to the particular account holder.

5. A computer-implemented method according to claim 2, wherein:
the characteristic signal weight for a particular account holder is calculated by selecting a highest signal weight from the signal weights for the particular account holder which correspond to signals directed to the particular account holder.

6. A computer-implemented method according to claim 1, further comprising:
displaying data representing at least one signal made by a given account holder in conjunction with displaying at least part of a profile of the given account holder.

7. A computer-implemented method according to claim 1, further comprising:
displaying data representing a signal made by a given account holder along with data representing a corresponding signal weight in conjunction with displaying at least part of a profile of the given account holder.

8. A computer-implemented method according to claim 1, further comprising:
displaying data representing at least one signal directed to a given account holder in conjunction with displaying at least part of a profile of the given account holder.

9. A computer-implemented method according to claim 1, further comprising:
displaying data representing a signal directed to a given account holder along with data representing a corresponding signal weight in conjunction with displaying at least part of a profile of the given account holder.

10. A computer-implemented method according to claim 2, further comprising:
displaying data representing characteristic signal weight of a given account holder in conjunction with displaying at least part of a profile of the given account holder.

11. A computer-implemented method according to claim 1, wherein:
the signal weight for a signal made by a given account holder is based on a damping factor that reduces signal weight of successive signals made by the given account holder.

12. A computer-implemented method according to claim 1, wherein:
the signal weight for a signal made by a given account holder is based on a factor dictated by signal type.

13. A computer-implemented method according to claim 1, wherein:
the signal weight for a signal made by a given account holder is of the form
$${w}_{s} ( X 1 , Y ) = \frac{t ( X 1 ) {dF}_{X 1 , Y}}{{{Σ}_{i = 0}^{n} ( {F}_{i} )}_{X 1}} ;$$
where X1 denotes the account holder giving the signal and Y denotes the account holder to whom the signal is directed;
t(X1) is a characteristic signal weight for the account holder X1;
d is a damping factor;
F_{X1,Y} is a signal strength factor; and
the summation Σᵢ₌₀ⁿ(Fᵢ)_{X1} corresponds to a total of factors of all signals made by the account holder X1.

14. A computer-implemented method according to claim 1, wherein:
the signal weight for a given signal provides a measure of interest and relative trustworthiness the given signal.

15. A computer-implemented method according to claim 2, wherein:
the characteristic signal weight associated with a given account holder provides a measure of interest associated with the given account holder.

16. A computer-implemented method according to claim 1, further comprising:
interacting with the plurality of account holders to generate recommendations, wherein each recommendation is made by a first account holder and directed to a second account holder;
storing data representing the recommendations;
calculating recommendation weights corresponding to the recommendations; and
storing data representing the recommendation weights corresponding to the recommendations.

17. A computer-implemented method according to claim 16, further comprising:
as part of generating the recommendations, interacting with the first account holder of a given recommendation to specify a set of strengths of the second account holder that are associated with the given recommendation;
storing data representing the set of strengths of the second account holder that are associated with the given recommendation;
calculating per-strength recommendation weights for the set of strengths of the second account holder that are associated with the given recommendation; and
storing data representing the per-strength recommendation weights for the set of strengths of the second account holder that are associated with the given recommendation.

18. A computer-implemented method according to claim 2, further comprising:
identifying a plurality of account holders that match a job opening relating to a specific job, position, role or other professional opportunity; and
ranking or filtering the plurality of account holders based on characteristic signal weights of the plurality of account holders in order to refer the plurality of account holders to a party associated with the job opening.

19. A computer-implemented method according to claim 2, further comprising:
identifying a plurality of job openings relating to specific jobs, positions, roles or other professional opportunities;
ranking or filtering the plurality of job openings based on characteristic signal weights associated with the plurality of job openings in order to notify at least one account holder of one or more of the plurality of job openings.

20. A professional social networking system comprising:
at least one computer processor that includes
at least one module configured to interact with a plurality of account holders to generate signals, wherein each signal is made by a first account holder and directed to a second account holder, wherein the signal identifies interest of the first account holder in the second account holder, and
at least one module configured to calculate signal weights corresponding to the signals; and
data storage configured to store data representing the signals and data representing the signal weights corresponding to the signals.

21. A professional social networking system according to claim 20, wherein:
the at least one computer processor further includes at least one module configured to calculate characteristic signal weights for respective account holders, wherein the characteristic signal weight for a particular account holder is based on data representing at least one signal weight for the particular account holder corresponding to at least one signal directed to the particular account holder; and
the data storage is further configured to store data representing the characteristic signal weights for the respective account holders.

22. A professional social networking system according to claim 21, wherein:
the characteristic signal weight for a particular account holder is calculated by summing signal weights for the particular account holder which correspond to signals directed to the particular account holder.

23. A professional social networking system according to claim 21, wherein:
the characteristic signal weight for a particular account holder is calculated by averaging signal weights for the particular account holder which correspond to signals directed to the particular account holder.

24. A professional social networking system according to claim 21, wherein:
the characteristic signal weight for a particular account holder is calculated by selecting a highest signal weight from the signal weights for the particular account holder which correspond to signals directed to the particular account holder.

25. A professional social networking system according to claim 20, wherein:
the at least one computer processor further includes at least one module configured to display data representing at least one signal made by a given account holder in conjunction with displaying at least part of a profile of the given account holder.

26. A professional social networking system according to claim 20, wherein:
the at least one computer processor further includes at least one module configured to display data representing a signal made by a given account holder along with data representing corresponding signal weight in conjunction with displaying at least part of a profile of the given account holder.

27. A professional social networking system according to claim 20, wherein:
the at least one computer processor further includes at least one module configured to display data representing at least one signal directed to a given account holder in conjunction with displaying at least part of a profile of the given account holder.

28. A professional social networking system according to claim 20, wherein:
the at least one computer processor further includes at least one module configured to display data representing a signal directed to a given account holder along with data representing corresponding signal weight in conjunction with displaying at least part of a profile of the given account holder.

29. A professional social networking system according to claim 21, wherein:
the at least one computer processor further includes at least one module configured to display data representing characteristic signal weight of a given account holder in conjunction with displaying at least part of a profile of the given account holder.

30. A professional social networking system according to claim 20, wherein:
the signal weight for a signal made by a given account holder is based on a damping factor that reduces signal weight of successive signals made by the given account holder.

31. A professional social networking system according to claim 20, wherein:
the signal weight for a signal made by a given account holder is based on a factor dictated by signal type.

32. A professional social networking system according to claim 20, wherein:
the signal weight for a signal made by a given account holder is of the form
$${w}_{s} ( X 1 , Y ) = \frac{t ( X 1 ) {dF}_{X 1 , Y}}{{{Σ}_{i = 0}^{n} ( {F}_{i} )}_{X 1}} ;$$
where X1 denotes the account holder giving the signal and Y denotes the account holder to whom the signal is directed;
t(X1) is a characteristic signal weight for the account holder X1;
d is a damping factor;
F_{X1,Y} is a signal-strength factor; and
the summation Σᵢ₌₀ⁿ(Fᵢ)_{X1} corresponds to a total of factors of all signals made by the account holder X1.

33. A professional social networking system according to claim 20, wherein:
the signal weight for a given signal provides a measure of interest and relative trustworthiness the given signal.

34. A professional social networking system according to claim 21, wherein:
the characteristic signal weight associated with a given account holder provides a measure of interest associated with the given account holder.

35. A professional social networking system according to claim 20, wherein:
the at least one computer processor further includes at least one module configured to interact with the plurality of account holders to generate recommendations, wherein each recommendation is made by a first account holder and directed to a second account holder, and at least one module configured to calculate recommendation weights corresponding to the recommendations; and
the data storage is configured to store data representing the recommendations and data representing the recommendation weights corresponding to the recommendations.

36. A professional social networking system according to claim 21, wherein:
the at least one computer processor further includes at least one module configured to i) identify a plurality of account holders that match a job opening relating to a specific job, position, role or other professional opportunity, and ii) rank or filter the plurality of account holders based on characteristic signal weights of the plurality of account holders in order to refer the plurality of account holders to a party associated with the job opening.

37. A professional social networking system according to claim 21, wherein:
the at least one computer processor further includes at least one module configured to i) identifying a plurality of job openings relating to specific jobs, positions, roles or other professional opportunities, and ii) rank or filter the plurality of job openings based on characteristic signal weights associated with the plurality of job openings in order to notify at least one account holder of one or more of the plurality of job opening.

38. A professional social networking system according to claim 20, wherein:
the data storage comprises a distributed ledger maintained by a plurality of ledger nodes.

39. A professional social networking system according to claim 20, wherein:
the data storage is part of a centralized web-based system.
